(19) United States
(12) Patent Application Publication
(10) Pub. No.: US 2026/0195359 A1
(43) Pub. Date: Jul. 9, 2026

(54) System and Method for Attractor-Proximity Scoring and Manifold Flow Prediction in Geometric Cognitive State Spaces

(71) Applicant: AtomBeam Technologies Inc., Moraga, CA (US)

(72) Inventor: Brian Galvin, Silverdale, WA (US)

(21) Appl. No.: 19/455,828

(22) Filed: Jan. 22, 2026

Related U.S. Application Data
(63) Continuation-in-part of application No. 19/382,207, filed on Nov. 6, 2025.
Application No. 19/382,207 is a continuation of application No. 19/203,069, filed on Jun. 3, 2025, now Pat. No. 12,481,688.
Application No. 19/203,069 is a continuation-in-part of application No. 19/205,960, filed on May 12, 2025.
Application No. 19/205,960 is a continuation-in-part of application No. 19/060,794, filed on Feb. 24, 2025.
Application No. 19/060,794 is a continuation-in-part of application No. 19/044,546, filed on Feb. 3, 2025.
Application No. 19/044,546 is a continuation-in-part of application No. 19/026,276, filed on Jan. 16, 2025.
Application No. 19/026,276 is a continuation-in-part of application No. 18/928,022, filed on Oct. 26, 2024.
Application No. 18/928,022 is a continuation-in-part of application No. 18/919,417, filed on Oct. 17, 2024, now Pat. No. 12,602,586.
Application No. 18/919,417 is a continuation-in-part of application No. 18/918,077, filed on Oct. 17, 2024.
Application No. 18/918,077 is a continuation-in-part of application No. 18/737,906, filed on Jun. 7, 2024.
Application No. 18/737,906 is a continuation-in-part of application No. 18/736,498, filed on Jun. 6, 2024.
(60) Provisional application No. 63/651,359, filed on May 23, 2024.

(51) Int. Cl. G06F 16/334; G06F 11/1446; G06F 16/3329; G06F 16/353; G06F 18/2137; G06N 3/049; G06N 3/06

(52) U.S. Cl. CPC G06F 16/3347; G06F 11/1446; G06F 16/3329; G06F 16/353; G06F 18/21375; G06N 3/049; G06N 3/061

(57) ABSTRACT

A system and method for geometric cognitive processing employs attractor-based manifold flow prediction to model and predict cognitive state evolution. The system represents cognitive states as points within a geometric manifold and identifies attractors comprising stable subsets toward which states naturally evolve. For each cognitive state, the system computes proximity scores quantifying relationships to identified attractors. These proximity scores weight attractor-influenced flow components that combine to generate predicted cognitive trajectories through the manifold. The system dynamically adapts manifold geometry, attractor parameters, and basin boundaries based on observed cognitive trajectories, enabling continuous refinement of predictive accuracy. The architecture supports multiple attractor types including point, limit cycle, strange, and hierarchical attractors, and accommodates multi-manifold configurations with cross-manifold information transfer. The system provides a unified framework for understanding and predicting complex cognitive dynamics across diverse implementation platforms.

### CROSS-REFERENCE TO RELATED APPLICATIONS

Priority is claimed in the application data sheet to the following patents or patent applications, each of which is expressly incorporated herein by reference in its entirety:
Ser. No. 19/382,207
Ser. No. 19/203,069
Ser. No. 19/205,960
Ser. No. 19/060,794
Ser. No. 19/044,546
Ser. No. 19/026,276
Ser. No. 18/928,022
Ser. No. 18/919,417
Ser. No. 18/918,077
Ser. No. 18/737,906
Ser. No. 18/736,498
63/651,359

### BACKGROUND OF THE INVENTION

### Field of the Art

The present invention is in the field of machine learning and cognitive computing, and more particularly to systems and methods for identifying attractors in geometric latent state spaces, computing attractor-proximity scores, and predicting manifold flow to forecast cognitive trajectories.

### Discussion of the State of the Art

Conventional machine learning systems frequently transform high-dimensional observations into latent embeddings to enable classification, clustering, retrieval, or forecasting. These systems often rely on learned representations that are effective for downstream tasks but provide limited geometric or dynamical structure for interpreting how a state evolves over time, particularly when the underlying process exhibits nonlinearity, drift, or multi-modal behavior.

Some approaches attempt to impose structure on latent representations using manifold learning, metric learning, or dynamical modeling (e.g., recurrent models and state-space models). However, these approaches commonly treat the latent space as a generic vector space and do not provide a consistent framework for (i) identifying stable “attractor-like” regions corresponding to recurring or convergent behavioral patterns, (ii) computing quantitative proximity measures to such regions that are robust across contexts and data sources, or (iii) predicting future evolution as a flow over an inferred manifold in a manner that can be evaluated, monitored, and used to guide decisions.

What is needed is a system and method that can identify attractors in a geometric latent state space, compute attractor-proximity scores for states and trajectories, and predict manifold flow or future trajectories using the inferred geometry and attractor structure.

### SUMMARY OF THE INVENTION

Accordingly, the inventor has conceived and reduced to practice, a system and method for geometric cognitive processing employs attractor-based manifold flow prediction to model and predict cognitive state evolution. The system represents cognitive states as points within a geometric manifold and identifies attractors comprising stable subsets toward which states naturally evolve. For each cognitive state, the system computes proximity scores quantifying relationships to identified attractors. These proximity scores weight attractor-influenced flow components that combine to generate predicted cognitive trajectories through the manifold. The system dynamically adapts manifold geometry, attractor parameters, and basin boundaries based on observed cognitive trajectories, enabling continuous refinement of predictive accuracy. The architecture supports multiple attractor types including point, limit cycle, strange, and hierarchical attractors, and accommodates multi-manifold configurations with cross-manifold information transfer. The system provides a unified framework for understanding and predicting complex cognitive dynamics across diverse implementation platforms.

According to a preferred embodiment, a system for geometric cognitive processing is disclosed, the system comprising: a cognitive manifold representing a space of cognitive states; an attractor identification component configured to determine a plurality of attractors within the cognitive manifold, wherein each attractor comprises a subset of the cognitive manifold toward which cognitive states evolve; a proximity scoring component configured to compute, for a cognitive state in the cognitive manifold, a proximity score for each of the plurality of attractors, wherein each proximity score quantifies a relationship between the cognitive state and a corresponding attractor; a flow prediction component configured to generate a predicted cognitive flow based on the cognitive state and the proximity scores, wherein the predicted cognitive flow is computed as a weighted combination of attractor-influenced flow components, and wherein each attractor-influenced flow component is weighted by its corresponding proximity score; and a geometry evolution component configured to modify at least one of: a metric structure of the cognitive manifold, parameters of one or more attractors, or basin boundaries of the attractors, based on observed cognitive trajectories.

According to another preferred embodiment, a method for geometric cognitive processing is disclosed, the method comprising the steps of: mapping a cognitive state to a point within a cognitive manifold representing a space of cognitive states; identifying a plurality of attractors within the cognitive manifold, wherein each attractor comprises a subset of the cognitive manifold toward which cognitive states evolve; computing, for the cognitive state, a proximity score for each of the plurality of attractors, wherein each proximity score quantifies a relationship between the cognitive state and a corresponding attractor; generating a predicted cognitive flow based on the cognitive state and the proximity scores, wherein the predicted cognitive flow is computed as a weighted combination of attractor-influenced flow components, and wherein each attractor-influenced flow component is weighted by its corresponding proximity score; and modifying at least one of: a metric structure of the cognitive manifold, parameters of one or more attractors, or basin boundaries of the attractors, based on observed cognitive trajectories.

According to a further aspect, the method includes detecting fixed points where a state evolution operator leaves states unchanged; detecting limit cycles exhibiting periodic orbits with finite period; detecting local minima of a potential function; identifying recurrent sets with high trajectory return frequency; or identifying dominant eigenmodes of a dynamical operator.

According to a further aspect, the method includes computing the proximity scores by: applying a distance-based metric that decreases with increasing distance between the cognitive state and the attractor; applying a potential-based metric based on exponential decay of an attractor-specific potential function; computing a dynamical convergence rate measuring instantaneous approach velocity toward the attractor; or computing a probabilistic metric representing likelihood of eventual convergence to the attractor.

According to a further aspect, the method includes generating the predicted cognitive flow by: applying a linear predictor that adds a scaled flow vector to the current state; applying a geodesic extrapolator that follows curved paths on the manifold; or applying a stochastic transition kernel defining transition probabilities between states.

According to a further aspect, the method includes modifying the metric structure comprises adjusting the metric based on at least one of: trajectory density through regions of the manifold; attractor occupancy statistics; accumulated prediction errors; or curvature flow adjustments.

According to a further aspect, the method includes managing a plurality of cognitive manifolds; and transferring information between manifolds using projection operators, wherein attractor proximity scores computed in one manifold influence flow predictions generated in another manifold through the projection operators.

According to a further aspect, the method includes constructing an attractor graph where nodes represent attractors and edges represent feasible transitions between attractor basins; and determining cognitive trajectories as paths through the attractor graph based on optimization criteria.

According to a further aspect, the method includes generating the predicted cognitive flow by: combining weighted attractor-aligned flow components with a residual flow term representing influences not captured by the identified attractors.

According to a further aspect, the method includes identified attractors comprising at least two of: point attractors representing fixed cognitive states; limit cycle attractors exhibiting periodic dynamics; strange attractors possessing fractal structure and sensitive dependence on initial conditions; manifold attractors having extended dimensionality; metastable attractors characterized by temporary stability; or hierarchical attractors containing nested sub-attractor structures.

### BRIEF DESCRIPTION OF THE DRAWING FIGURES

FIG. 1 is a block diagram illustrating the architecture of a geometric cognitive system employing attractor-based manifold flow prediction.

FIG. 2 is a diagram illustrating the mathematical structure of a cognitive manifold with multiple attractors, their associated basins of attraction, and representative cognitive trajectories.

FIG. 3 is a diagram illustrating various exemplary types of attractors and configurations supported by the geometric cognitive system

FIG. 4 is a diagram illustrating the various methods for computing and visualizing attractor-proximity scores within the geometric cognitive system.

FIGS. 5A, 5B, and 5C illustrate three distinct flow prediction methods employed by the geometric cognitive system to forecast future cognitive states based on current positions within the manifold and attractor influences, according to an embodiment.

FIG. 6 is a flow diagram illustrating an exemplary attractor-weighted flow composition process that forms a mechanism for combining multiple attractor influences into a unified cognitive flow prediction, according to an embodiment.

FIG. 7 is a method flow diagram illustrating the dynamic geometry evolution process through which the cognitive manifold continuously adapts its structure based on accumulated experience and computational requirements.

FIG. 8 is a diagram illustrating a multi-manifold cognitive architecture demonstrating how multiple specialized geometric spaces interact through cross-manifold projections to implement hierarchical cognitive processing.

FIG. 9 is a method flow diagram illustrating an exemplary global reasoning loop that governs continuous cognitive processing within the geometric cognitive system, according to an embodiment.

FIG. 10 is a flow diagram illustrating an exemplary method for attractor identification and classification that enables the geometric cognitive system to discover, characterize, and catalog stable structures within the cognitive manifold.

FIG. 11 is a method flow diagram illustrating a cross-manifold information transfer and synchronization process that enables cognitive processing across multiple geometric manifolds within a multi-manifold cognitive architecture.

FIG. 12 illustrates an exemplary method for adaptive attractor discovery through experience flow using a learning-based process applied to operational data

FIG. 13 illustrates an exemplary computing environment on which an embodiment described herein may be implemented.

### DETAILED DESCRIPTION OF THE INVENTION

The inventor has conceived, and reduced to practice, a system and method for geometric cognitive processing employs attractor-based manifold flow prediction to model and predict cognitive state evolution. The system represents cognitive states as points within a geometric manifold and identifies attractors comprising stable subsets toward which states naturally evolve. For each cognitive state, the system computes proximity scores quantifying relationships to identified attractors. These proximity scores weight attractor-influenced flow components that combine to generate predicted cognitive trajectories through the manifold. The system dynamically adapts manifold geometry, attractor parameters, and basin boundaries based on observed cognitive trajectories, enabling continuous refinement of predictive accuracy. The architecture supports multiple attractor types including point, limit cycle, strange, and hierarchical attractors, and accommodates multi-manifold configurations with cross-manifold information transfer. The system provides a unified framework for understanding and predicting complex cognitive dynamics across diverse implementation platforms.

In some embodiments, the manifold M is equipped with a distance function or metric

$$d : M \times M \to {ℝ}_{\geq 0} ,$$

which characterizes a notion of proximity between points on the manifold. The distance function is not restricted to a Euclidean norm. The distance function may be induced by a Riemannian metric, a Finsler structure, a graph-based metric, an information-geometric divergence, a learned distance, or another non-Euclidean structure. In some embodiments, the distance function is derived from empirical transition statistics, similarity measures, or other data-driven criteria.

In some embodiments, the manifold M is equipped with a local chart structure that enables local differentiability where such structure is required. For example, a coordinate chart (U,φ) may be defined with U⊇M and φ: U→ [symbol] ⁿ, allowing local coordinates to be assigned to states lying in U. Multiple charts may be used to cover the manifold.

In certain embodiments, distances between points p,q∈M are defined by a path-based construction. For example, the distance may be given by

$$d ( p , q ) = {inf}_{γ} {\int }_{0}^{1} Φ ( γ ( t ) , \dot{γ} ( t ) ) d t ,$$

where the infimum is taken over admissible curves γ:[0,1]→M satisfying γ(0)=p and γ(1)=q,γ̅(t) denotes a tangent vector along γ, and Φ is a local cost or energy functional defined on tangent vectors. The functional Φ may encode local metric properties, curvature information, or transition costs.

In some embodiments, the manifold M further includes additional geometric structure, such as a metric tensor gᵢⱼ(x), a connection, or curvature tensors. These quantities may be specified analytically, derived from data, or updated over time based on observed cognitive trajectories. The presence of such structure permits the use of geometric constructs such as geodesics, curvature, and parallel transport when characterizing cognitive dynamics.

In some embodiments, the cognitive manifold M is realized as a latent space of a machine-learned model. For example, the manifold may correspond to an embedding space of a neural network, a latent space of a generative model, or a representation space obtained by dimensionality reduction. In these embodiments, the mapping x:S→M may be implemented by an encoder network or other feature-extraction mechanism, and the metric or distance function on M may be defined in terms of the latent representation.

The above structures collectively define a cognitive manifold that serves as the state space on which attractors, basins of attraction, manifold flows, and other dynamical constructs are specified in subsequent sections.

In certain embodiments, the cognitive manifold M is equipped with a state-evolution operator that defines how states on the manifold change over time. The evolution may be represented by an operator

$${F}_{t} : M \to M ,$$

where t≥0 denotes time, such that Fₜ(x) is the state reached after evolving an initial state x∈M for time t.

In some embodiments, an attractor is defined as a subset A⊇M that is invariant under the state-evolution operator. Invariance may be characterized by the condition

$${F}_{t} ( A ) = A for all t \geq 0 ,$$

where Fₜ(A)={Fₜ(x)|x∈A}. The attractor A can include fixed points, periodic orbits, limit cycles, tori, or higher-dimensional invariant sets, and the definition does not require the attractor to be a single point.

In some embodiments, the attractor A is associated with a basin of attraction B(A) comprising the set of initial states whose trajectories asymptotically approach the attractor. The basin of attraction may be defined as

$$B ( A ) = \{ x ∈ M \vert {lim}_{t \to ∞} dist ( {F}_{t} ( x ) , A ) = 0 \} ,$$

where dist(Fₜ(x),A)=inf_{y∈A}d(Fₜ(x),y), and d( [symbol] ) is a distance function on Mas described herein.

In some embodiments, local stability of an attractor A is characterized by the behavior of trajectories starting in a neighborhood of A. For example, for a neighborhood U of A, local stability may be expressed by the condition that for all x∈U, trajectories remain close to A for all future times and converge to A asymptotically. In such embodiments, the basin of attraction B(A) can be viewed as the maximal set of initial states whose trajectories converge to A.

In certain embodiments, the state-evolution operator Fₜ is generated by a vector field f on the manifold, such that trajectories x(t) satisfy

$$\dot{x} ( t ) = f ( x ( t ) ) .$$

In such embodiments, attractors may be characterized using standard dynamical systems criteria, including Lyapunov stability, asymptotic stability, and invariant set properties. The attractor definition remains valid when Fₜ is defined by other mechanisms, including discrete-time updates, rule-based transitions, probabilistic transitions, or operator-theoretic evolution.

In some embodiments, multiple attractors A₁, A₂, . . . , Aₖ are defined on the manifold, each with a corresponding basin of attraction B(Aᵢ). The basins may partition a subset of the manifold or overlap, depending on the underlying dynamics and any stochastic components. Boundaries between basins can correspond to separatrices, unstable manifolds, or other geometric structures in the state space.

In some embodiments, attractors are explicitly represented in a data structure that stores parameters describing each attractor, such as a representative point or region, stability characteristics, and identifiers for the associated basin. This representation enables downstream computations, including attractor-proximity scoring and attractor-modulated flow prediction, as described in subsequent sections.

In certain embodiments, the system associates with each attractor AλM an attractor-proximity score π_{A}(x) that quantifies a notion of closeness between a state x∈M and the attractor A. The score π_{A}(x) is defined as a function

$${π}_{A} : M \to ℝ ,$$

and may take values in a bounded interval such as [0,1] or in a non-negative range, depending on the particular formulation.

In some embodiments, the attractor-proximity score π_{A}(x) is defined in terms of a distance between the state x and the attractor set A. For example, a distance-based proximity score may be defined as

$${π}_{A} ( x ) = \frac{1}{1 + d ( x , A )} ,$$

$$where d ( x , A ) = {inf}_{y ∈ A} d ( x , y )$$

and d( [symbol] ) is a distance function on M as described herein. This form yields higher scores for states that are closer to the attractor set.

[symbol]

In some embodiments, the system defines a potential function V_{A}:M→ [symbol] _{≥0} associated with attractor A. The potential function is constructed so that V_{A}(x) attains low values in the vicinity of the attractor. An exemplary potential-based proximity score may then be defined as

$${π}_{A} ( x ) = exp ( - λ {V}_{A} ( x ) ) ,$$

where λ>0 is a scaling parameter. In this formulation, a lower potential value corresponds to a higher proximity score.

In some embodiments, the attractor-proximity score incorporates dynamical information about the evolution of states under the operator Fₜ. For example, an instantaneous convergence rate toward the attractor may be defined as

$${κ}_{A} ( x ) = - \frac{d}{dt} d ( {F}_{t} ( x ) , A ) {\vert}_{t = 0} ,$$

and a corresponding proximity score may be obtained by applying a monotone transform such as a logistic function σ:

$${π}_{A} ( x ) = σ ( {κ}_{A} ( x ) ) .$$

In these embodiments, states with higher instantaneous convergence rates toward the attractor receive higher proximity scores.

In certain embodiments involving stochastic evolution, the attractor-proximity score is defined in probabilistic terms. For example, if trajectories follow a stochastic process governed by Fₜ, the proximity score may be defined as

$${π}_{A} ( x ) = ℙ ( {lim}_{t \to ∞} {F}_{t} ( x ) ∈ A ) ,$$

which represents the probability that a trajectory initialized at x asymptotically converges to the attractor A.

In some embodiments, the system defines proximity scores based on perturbation responses. In such embodiments, small perturbations δx are applied to the state x, and the resulting trajectories are evaluated with respect to the attractor A. A perturbation-response proximity score may be defined in terms of the expected rate at which perturbed trajectories enter the basin of attraction B(A), or in terms of the distribution of return times to neighborhoods of A.

In further embodiments, attractor-proximity scores are derived from spectral or operator-theoretic quantities. For example, eigenfunctions or singular functions of an associated transfer operator, Koopman operator, or Laplacian on the manifold may be used to construct scalar fields whose values correlate with attraction toward A, and these scalar fields may be used directly as proximity scores or combined with other terms.

In some embodiments, for a collection of attractors [symbol] ={A₁, . . . , Aₖ}, the system maintains a vector of attractor-proximity scores

$$π ( x ) = ( {π}_{{A}_{1}} ( x ) , … , {π}_{{A}_{k}} ( x ) ) .$$

The vector π(x) may be normalized, for example by enforcing

$${\sum }_{i = 1}^{k} {π}_{{A}_{i}} ( x ) = 1 ,$$

or may remain unnormalized. Different components of π(x) may be computed using different proximity formulations, including distance-based, potential-based, dynamical, probabilistic, or perturbation-based definitions.

Any of the foregoing formulations may be implemented individually or in combination within a given system. The attractor-proximity scores defined in this section provide quantitative inputs to manifold-flow prediction, attractor-modulated dynamics, and decision mechanisms described in subsequent sections.

In certain embodiments, the cognitive manifold M is equipped with an evolution operator

$${F}_{t} : M \to M ,$$

where t≥0, such that Fₜ(x) denotes the state obtained by evolving an initial state x∈M for time t. The family {Fₜ}_{t≥0} may satisfy a semigroup property Fₜ₊ₛ=Fₜ·Fₛ in embodiments where the underlying dynamics are time-homogeneous.

In some embodiments, when the manifold admits a differentiable structure, the evolution operator Fₜ is generated by a vector field f on M. Trajectories x(t) then satisfy

$$\dot{x} ( t ) = f ( x ( t ) ) ,$$

with initial condition x(0)=x₀. The vector field f may encode drift, gradient flow, policy-induced motion, or other dynamical rules defined on the manifold.

In certain embodiments, a manifold-flow predictor is defined as an approximation \hat{F}_{Δt} to the evolution operator F_{Δt} for a finite time increment Δt. For a current state x, the predictor produces a predicted future state

$$\hat{x} ( t + Δ t ) = {\hat{F}}_{Δ t} ( x ( t ) ) .$$

The predictor may be deterministic or stochastic, and may be implemented analytically, numerically, or by a learned model.

In some embodiments, the predictor uses a local linear approximation of the dynamics. For example, a Jacobian or local linear operator J_{f}(x) associated with the vector field f at state x is used to define

$${\hat{F}}_{Δ t} ( x ) = x + {J}_{f} ( x ) Δ t ,$$

$$or$$

$${\hat{F}}_{Δ t} ( x ) = x + f ( x ) Δ t ,$$

in a first-order Euler-type scheme. Higher-order numerical schemes may also be employed.

In some embodiments, the predictor employs geometric extrapolation along geodesics of the manifold. For a given state x and a tangent vector v at x, the predicted future state is defined by

$$\hat{x} ( t + Δ t ) = {exp}_{x} ( Δ t \cdot v ) ,$$

where expₓ denotes a manifold exponential map. The tangent vector v may be derived from the current direction of motion, from a flow field f(x), or from a learned directional predictor.

In certain embodiments, the predictor incorporates attractor information into the drift. A potential function V:M→ [symbol] is defined so that lower values of V correspond to regions of attraction. A drift field may then be specified as

$$\hat{f} ( x ) = - ∇ V ( x ) + {\sum }_{i} {W}_{i} ( x ) {u}_{i} ( x ) ,$$

where −∇V(x) is a gradient flow component, uᵢ(x) denote additional vector fields representing exogenous influences or task-related components, and wᵢ(x) denote state-dependent weights. The predicted flow is then integrated over time to obtain \hat{F}_{Δt}.

In some embodiments, manifold flow is represented in probabilistic form. A transition kernel

$${K}_{Δ t} ( x , y )$$

is defined such that K_{Δt}(x,y) specifies a probability density or mass for transitioning from state x to state y over time interval Δt. The predicted distribution of future states is then given by

$$ℙ [ x ( t + Δ t ) ∈ B ] = {\int }_{y ∈ B} {K}_{Δ t} ( x ( t ) , y ) dy ,$$

for measurable subsets B⊇M. In such embodiments, manifold-flow prediction is expressed as propagation of probability distributions under the kernel.

In some embodiments, the system maintains multi-step predictors that approximate F_{kΔt} for integers k≥1. A multi-step predictor may be obtained by iterating a one-step predictor \hat{F}_{Δt}, or by training or specifying a separate operator \hat{F}_{kΔt} for longer horizons. Ensemble predictors may also be employed, in which multiple candidate flows are generated and combined, for example by averaging, weighted voting, or selection based on attractor-proximity scores.

The constructs defined in this section provide a formal basis for predicting future cognitive trajectories on the manifold, and for coupling such predictions to attractor structures, proximity scores, and decision mechanisms described in other sections.

In certain embodiments, the geometric and dynamical structures associated with the cognitive manifold M are time-dependent. The time dependence may arise from learning processes, accumulated experience, or changing task conditions. The manifold, its metric, its attractors, and basins of attraction are therefore treated as objects that may evolve over time.

In some embodiments, the metric structure on the manifold is represented by a metric tensor gᵢⱼ(x,t) that depends on both position x∈M and time t. The evolution of the metric tensor may be expressed by an update rule of the form

$$\frac{\partial {g}_{i j}}{\partial t} ( x , t ) = {H}_{ij} ( x , t ) ,$$

where Πᵢⱼ(x,t) is a tensor-valued function that encodes how local geometry is adjusted. The function Πᵢⱼ may depend on observed trajectories, local curvature, attractor occupancy statistics, similarity measurements, or other signals derived from operation of the cognitive system. The induced distance function dₜ( [symbol] ) on M thereby changes over time.

In some embodiments, attractors themselves are time-varying. A time-dependent attractor is denoted A(t)⊇M. The evolution of attractor parameters may be expressed by an update equation

$${θ}_{A} ( t + Δ t ) = {θ}_{A} ( t ) + Δ {θ}_{A} ( t ) ,$$

where θ_{A}(t) is a parameter vector describing the attractor at time t (for example, location, orientation, or shape parameters), and Δθ_{A}(t) is computed from data collected over a time window, such as recent trajectories or reward signals. In some embodiments, θ_{A}(t) parameterizes a potential function V_{A}(x,t), and changes in θ_{A}(t) modify the shape or position of basins of attraction.

In certain embodiments, basins of attraction are explicitly treated as time-dependent sets

$$B ( A ( t ) ) = \{ x ∈ M \vert {lim}_{s \to ∞} {F}_{t , s} ( x ) ∈ A ( t + s ) \} ,$$

where F_{t,s} denotes evolution from time t to time t+s. Boundaries of basins may be represented as level sets of scalar functions φ(x,t), such as φ(x,t)=0, or as unstable manifolds of saddle-type structures. Updates to φ(x,t) or to underlying dynamical parameters induce movement of basin boundaries and changes in which states belong to a given basin.

In some embodiments, the flow field f(x,t) on the manifold is also time-dependent and is updated according to curvature- and attractor-sensitive rules. An update rule may be expressed as

$$\frac{\partial f}{\partial t} ( x , t ) = G ( x , t ) ,$$

where G(x,t) may depend on curvature terms, such as a Ricci curvature Ric(x,t) or scalar curvature R(x,t), as well as gradients of attractor potentials. For example, an embodiment may specify

$$\frac{\partial f}{\partial t} ( x , t ) = - α Ric ( x , t ) + β {∇}_{x} V ( x , t ) ,$$

where α and β are non-negative coefficients, and V(x,t) encodes contributions from one or more attractors. This form couples geometric properties of the manifold to adjustments of the flow field.

In further embodiments, the manifold evolution is summarized by an update operator

$$U : ( {M}_{t} , {𝒜}_{t} , {f}_{t} , {Π}_{t} , {ε}_{t} ) ↦ ( {M}_{t + 1} , {𝒜}_{t + 1} , {f}_{t + 1} , {Π}_{t + 1} ) ,$$

where Mₜ denotes the manifold and its metric at time t, Aₜ denotes a collection of attractors and associated parameters, fₜ denotes flow fields, Πₜ denotes attractor-proximity scoring functions, and εₜ denotes experience data (such as trajectories or interaction logs) accumulated during an interval. The operator U produces updated structures for time t+1. This representation provides a formal mechanism for describing learning and adaptation processes acting on the manifold, attractors, and flows.

In certain embodiments, the dynamics on the cognitive manifold M are explicitly coupled to attractor structures defined on M. A flow field

$$f : M \to TM$$

assigns to each point x∈M a tangent vector f(x) that governs local state evolution. The flow field is decomposed into an attractor-driven component and one or more non-attractor components.

In some embodiments, an attractor potential function

$$V : M \to ℝ$$

is defined such that lower values of V(x) occur in regions associated with attractors or their basins. The attractor-driven component of the flow is given by a gradient term −∇V(x). The full flow field is then expressed as

$$f ( x ) = - ∇ V ( x ) + E ( x ) ,$$

where E(x) represents additional influences, such as external inputs, task-driven control fields, or noise terms. In this formulation, attractor geometry contributes directly to the direction and magnitude of state evolution.

In some embodiments, a collection of attractors [symbol] ={A₁, . . . , Aₖ} is defined on the manifold, and each attractor Aᵢ is associated with an attractor-proximity score π_{A}_{ᵢ}(x) as described herein. For each attractor Aᵢ, a local influence direction

$${v}_{{A}_{i}} ( x )$$

is defined in the tangent space at x. The influence direction may point toward the attractor, follow along its stable manifold, or align with the internal dynamics of the attractor (for example, tangential to a limit cycle).

In these embodiments, a predicted flow field f(x) is expressed as a weighted combination of attractor-aligned directions:

$$\hat{f} ( x ) = {\sum }_{i = 1}^{k} {π}_{{A}_{i}} ( x ) {v}_{{A}_{i}} ( x ) + R ( x ) ,$$

where R(x) is a residual term capturing influences not explicitly attributed to attractors. The attractor-proximity scores π_{A}_{ᵢ}(x) function as weights that determine the relative contribution of each attractor's influence to the local flow.

In certain embodiments, the vector of proximity scores

$$π ( x ) = ( {π}_{{A}_{1}} ( x ) , … , {π}_{{A}_{k}} ( x ) )$$

is normalized so that

$${\sum }_{i = 1}^{k} {π}_{{A}_{i}} ( x ) = 1 ,$$

and the residual term R(x) is omitted or treated separately. In other embodiments, the scores are not normalized, and the residual term incorporates baseline drift or control fields.

In some embodiments, attractor-proximity scores influence not only the direction but also the speed of motion on the manifold. For example, a scalar speed factor s(x) may be defined as a function of aggregated proximity scores, and the flow field may be implemented as

$$f ( x ) = s ( x ) \hat{f} ( x ) .$$

States with high proximity to one or more attractors can exhibit accelerated convergence, while states in low-proximity regions can exhibit slower or more exploratory motion.

In further embodiments, attractor-modulated flow is used to define transition kernels or stochastic dynamics. A transition kernel K_{Δt}(x,y) for a time increment Δt is constructed so that transition probabilities favor directions consistent with \hat{f}(x) and with attractor basins indicated by π_{A}_{ᵢ}(x). This coupling of attractor structure and flow fields provides a mechanism by which attractors, basins, and proximity scores shape the evolution of cognitive trajectories on the manifold.

In certain embodiments, a cognitive system employs multiple manifolds

$${M}_{1} , {M}_{2} , … , {M}_{k}$$

to represent different levels of abstraction, different modalities, or different subsystems. Each manifold Mᵢ is equipped with its own geometric and dynamical structure, including a distance function, attractors, and associated flow fields as described in earlier sections.

In some embodiments, mappings between manifolds are defined by projection or lifting operators

$${\prod }_{i \to j} : {M}_{i} \to {M}_{j} .$$

A mapping Π_{i→j} associates a state xᵢ∈Mᵢ with a corresponding state xⱼ=Π_{i→j}(xᵢ)∈Mⱼ. The mappings Π_{i→j} can be implemented analytically, for example as linear projections between vector spaces, or by learned functions such as neural networks.

In certain embodiments, attractor structures are related across manifolds. If Aᵢ⊇Mᵢ is an attractor in manifold Mᵢ, a corresponding attractor in manifold Mⱼ is defined by

$${A}_{j} = {\prod }_{i \to j} ( {A}_{i} ) = \{ {\prod }_{i \to j} ( x ) \vert x ∈ {A}_{i} \} .$$

Similarly, a state xⱼ ∈Mⱼ may be lifted back to Mᵢ by an operator Π_{j→i}, allowing attractor relationships to be evaluated in either manifold.

In some embodiments, attractor-proximity scores are transferred across manifolds. For a state xⱼ∈Mⱼ and an attractor Aᵢ ⊇Mᵢ, a cross-manifold proximity score is defined as

$${π}_{{A}_{i}}^{( j )} ( {x}_{j} ) = {π}_{{A}_{i}} ( {\prod }_{j \to i} ( {x}_{j} ) ) ,$$

where π_{A}_{ᵢ} is an attractor-proximity function on Mᵢ. This construction permits attractor influence defined on one manifold to shape dynamics or decision-making on another manifold.

In certain embodiments, flow fields are coupled across manifolds. A predicted flow \hat{f}ᵢ(xᵢ) on Mᵢ is mapped into a corresponding flow on Mⱼ via

$$\hat{{f}_{j}} ( {x}_{j} ) = D {\prod }_{i \to j} ( {x}_{i} ) \hat{{f}_{i}} ( {x}_{i} ) ,$$

where xⱼ=Π_{i→j}(xᵢ) and DΠ_{i→j}(xᵢ) denotes a differential or Jacobian of the mapping at xᵢ. In other embodiments, a direct mapping of flow vectors is specified without explicit use of differentials.

In some embodiments, evolution on one manifold constrains or drives evolution on another manifold. For example, a state trajectory xᵢ(t) on Mᵢ is propagated to a trajectory xⱼ(t)=Π_{i→j}(xᵢ(t)) on Mⱼ, and flow prediction or attractor analysis on Mⱼ is performed using xⱼ(t). Conversely, decisions or control signals derived from dynamics on Mⱼ are mapped back to Mᵢ to adjust flow fields or attractor parameters in Mᵢ.

In further embodiments, collections of manifolds {M₁, . . . , Mₖ}, mappings {Π_{i→j}}, and associated attractors and proximity scores are treated as a unified multi-manifold structure. This structure provides a formal basis for systems in which cognitive trajectories, attractor dynamics, and flow predictions are jointly defined and coordinated across multiple geometric representations.

In some embodiments, a prediction pipeline operates on a cognitive manifold M as a system-level process that integrates attractor identification, attractor-proximity scoring, and manifold-flow prediction. The pipeline is represented as an operator

$$P : M \to M ,$$

which receives a current cognitive state x∈M and produces a predicted future state P(x).

In certain embodiments, the pipeline is expressed as an attractor-weighted combination of evolution operators. Let [symbol] (M) denote a collection of attractors on M. For each attractor A∈ [symbol] (M), an attractor-proximity function Π_{A}(x) and an attractor-aligned evolution operator F_{A}(x) are defined. The prediction operator may then be written as

$$P ( x ) = \hat{F} ( x ) = {\sum }_{A ∈ 𝒜 ( M )} {\prod }_{A} ( x ) {F}_{A} ( x ) ,$$

where \tilde{F}(x) denotes a predicted evolution applied to the state x. In this formulation, attractor identification provides the relevant set [symbol] (M), proximity scoring provides the weights Π_{A}(x), and manifold-flow prediction is realized by the attractor-aligned operators F_{A}(x).

In some embodiments, the operators F_{A}(x) implement local or global flows on the manifold, such as integration of vector fields, application of transition kernels, or symbolic state updates, and the proximity functions Π_{A}(x) are derived using the attractor-proximity mechanisms described elsewhere in the specification. The prediction pipeline thus treats future-state computation as a nonlinear combination of attractor-conditioned flows defined on the cognitive manifold.

In various embodiments, the system supports multi-step trajectory prediction on a geometric latent space so as to generate both immediate next-state predictions and longer-range cognitive forecasts. A transition operator P defined on the latent manifold may be extended to a k-step predictor P^{(k)} by functional composition, such that an estimated future state \hat{x}ₜ₊ₖ is given by \hat{x}ₜ₊ₖ=P^{(k)}(xₜ), where P^{(k)} denotes the k-fold composition of the one-step transition operator applied to the current latent state xₜ. In some embodiments, the multi-step mapping is realized recursively, with \hat{x}ₜ₊ₖ obtained by applying the one-step predictor to the previously predicted state according to \hat{x}ₜ₊ₖ=P(\hat{x}ₜ₊ₖ₋₁), thereby chaining together successive local predictions to form a forecast trajectory.

In certain embodiments, when an attractor field F_{A} is represented as a continuous-time vector field f defined over the manifold, the k-step prediction is approximated by integrating the vector field over a finite prediction horizon. For example, the system may compute

$${\hat{x}}_{t + k} \approx {x}_{t} + {\int }_{0}^{k Δ t} f ( \hat{x} ( s ) ) ds ,$$

where Δt denotes a time increment and \hat{x}(s) denotes the evolving latent state along the predicted trajectory. This formulation enables the system to capture smooth geometric flows driven by attractor dynamics, rather than relying solely on discrete-time transitions.

In additional embodiments, the latent state of the system is modeled as a probability distribution pₜ(x) over the manifold, and the multi-step prediction is expressed in terms of a probabilistic transition kernel. A k-step transition kernel P^{(k)}(x, dy) induced by the underlying dynamics may be used to evolve the distribution according to

$${P}_{t + k} ( y ) = {\int }_{M} {p}_{t} ( x ) {P}^{( k )} ( x , dy ) ,$$

where M denotes the manifold. This probabilistic formulation allows the system to represent uncertainty over future trajectories and to generate long-horizon forecasts as distributions over possible future cognitive states, while remaining grounded in the geometric structure of the latent space and its associated attractor dynamics.

In various embodiments, the system implements an ensemble flow prediction mechanism in which multiple distinct predictive operators contribute to a unified forecast over the latent manifold. A current latent state x may be provided to a family of prediction operators {P₁, P₂, . . . , Pₘ}, where each prediction operator Pᵢ is configured to generate a candidate evolution Pᵢ(x) based on a corresponding modeling assumption, architecture, or attractor-aligned dynamic. An ensemble prediction module may combine these candidate evolutions to produce an integrated predicted flow \tilde{F}(x) according to

$$\hat{F} ( x ) = {\sum }_{i = 1}^{m} {w}_{i} ( x ) {P}_{i} ( x ) ,$$

where wᵢ(x) denotes a weighting factor associated with prediction operator Pᵢ at state x.

In some embodiments, the weighting factors wᵢ(x) are state-dependent and are determined based on one or more geometric or statistical properties of the manifold in the neighborhood of x. For example, the system may adapt the weights using attractor-proximity scores indicating the relative influence of different attractors at x, local curvature estimates characterizing geometric distortion, local data density or support derived from historical trajectories, and one or more uncertainty measures associated with the individual prediction operators. In certain implementations, a gating network or mixture-of-experts mechanism may compute the weights wᵢ(x) so that operators specialized for particular attractor basins, regions of the manifold, or dynamical regimes contribute more strongly when the current state lies within their domain of expertise.

In additional embodiments, the ensemble flow prediction framework accommodates heterogeneous prediction operators, including deterministic flow models, stochastic or diffusion-based predictors, symbolic or rule-based modules, and neural-network-based sequence predictors. By representing the overall forecast as a weighted combination of such heterogeneous operators, the system may generate manifold flow predictions that remain compatible with attractor-conditioned dynamics while leveraging multiple modeling paradigms concurrently.

In various embodiments, the system implements an operator-level composition framework that combines attractor identification, geometric field construction, and weighted evolution into a unified transformation acting on the latent manifold. A composite operator O may be defined on a latent state x according to

$$O ( x ) = ( W ∘ V ∘ A ) ( x ) ,$$

where an attractor operator A is configured to perform attractor identification and produce attractor-related descriptors for the state x, an intermediate operator V is configured to compute one or more vector fields, potential fields, or other geometric structures associated with the identified attractors, and an evolution operator W is configured to combine these fields using attractor-proximity scores or other weighting mechanisms so as to generate a weighted evolution or predicted flow for the state x.

In some embodiments, the system defines families of attractor-aligned evolution operators that explicitly couple flow fields with proximity scores. For example, an attractor-aligned operator may be represented as

$${F}_{A} ( x ) = Ω ( {v}_{A} ( x ) , {Π}_{A} ( x ) ) ,$$

where v_{A}(x) denotes a flow vector, drift component, or policy associated with attractor A at state x, Π_{A}(x) denotes an attractor-proximity score at state x, and Ω(⋅) denotes a combination operator (e.g., scaling, gating, or modulation) that produces an attractor-conditioned evolution contribution. In certain implementations, a global prediction operator P is defined as

$$P ( x ) = {W}_{x} ( \{ {F}_{A} ( x ) \text{?} ) ,$$

where Wₓ(⋅) denotes a weighting operator parameterized by the current state x that aggregates the family of attractor-aligned operators {F_{A}(x)} into a single predicted update or flow. This operator-level formalization enables the system to express a broad class of geometric cognition mechanisms that combine attractor mechanisms, scoring functions, and prediction operators within a common operator calculus.

In various embodiments, the system represents cognitive state evolution on the manifold by a flow operator F that combines attractor-conditioned dynamics with a residual correction term. A global update for a latent state x may be expressed as

$$F ( x ) = \text{?} {Π}_{A} ( x ) {F}_{A} ( x ) + R ( x ) ,$$

where Π_{A}(x) denotes an attractor-proximity score for attractor A, F_{A}(x) denotes an attractor-aligned evolution operator associated with attractor A, and R(x) denotes a residual flow component that is not directly captured by the attractor-weighted terms.

In some embodiments, residual flow R(x) encodes one or more of: external influences on the cognitive system (such as exogenous control inputs or environmental perturbations), exploration dynamics that intentionally deviate from attractor-aligned behavior, stochastic or measurement noise, symbolic or rule-based inference overrides that adjust or replace geometric predictions in specific contexts, and task-specific adjustment factors that bias the flow for particular objectives or operational modes. The residual flow may be realized as a deterministic function, a stochastic process, a rule-based update, or a combination thereof, and may be updated over time based on observed prediction errors or changing task requirements.

In additional embodiments, the inclusion of residual flow does not alter the fundamental attractor-modulated character of the cognitive dynamics. Systems in which the effective flow is decomposed into attractor-weighted components plus a residual term are treated as embodiments of the attractor-centric manifold-flow architecture, including cases where R(x) is identically zero, state-dependent, time-varying, learned from data, or specified by symbolic rules. The presence of residual, corrective, or unmodeled dynamics implemented through R(x) is expressly encompassed within the scope of the invention, so that implementations employing residual connections, correction layers, or auxiliary update channels remain covered by the attractor-weighted flow formulation.

In various embodiments, the system models cognitive state evolution on the latent manifold using a hybrid deterministic-stochastic formulation. A latent state x, may evolve according to

$$d {x}_{t} = f ( {x}_{t} ) d t + Σ ( {x}_{t} ) d {W}_{t} + \text{?} {Π}_{A} ( {x}_{t} ) {ξ}_{A} ( t ) ,$$

where f(xₜ) denotes a deterministic flow field on the manifold, Σ(xₜ) dWₜ denotes a stochastic diffusion term with Σ(xₜ) representing a state-dependent diffusion matrix and Wₜ representing a driving Wiener process or other stochastic process, and Π_{A}(xₜ)ξ_{A}(t) denotes an attractor-specific influence associated with attractor A, weighted by an attractor-proximity score Π_{A}(xₜ).

In some embodiments, the attractor-specific influence terms ξ_{A}(t) encode one or more of: stochastic perturbations localized to the basin of attractor A, symbolic or rule-based updates that modify the latent state when particular attractor-related conditions are satisfied, control actions or policies conditioned on attractor neighborhoods, or exogenous signals that are routed through attractor-aligned channels. The weighting factors Π_{A}(xₜ) may vary over the manifold so that attractor-specific influences become more prominent when the latent state approaches the corresponding attractor and diminish when the latent state moves away from the associated basin of attraction.

In additional embodiments, the hybrid formulation encompasses systems whose dynamics combine geometric drift, state-dependent diffusion, and attractor-modulated stochastic or symbolic components in any proportion. Implementations in which one or more terms vanish, are approximated in discrete time, or are realized through neural, algorithmic, or symbolic mechanisms are treated as special cases of the same hybrid deterministic-stochastic attractor-based evolution model on the cognitive manifold.

In various embodiments, the system implements adaptive, context-dependent attractor weighting so that attractor-proximity scores evolve over time in response to changing geometry and task conditions. For a given attractor A, a dynamic weighting function Π_{A}(x,t) may be defined as

$${Π}_{A} ( x , t ) = {h}_{A} ( d ( x , A ) , {κ}_{A} ( x ) , {λ}_{A} ( x , t ) , θ ( t ) , … ) ,$$

where d(x,A) denotes a distance or dissimilarity measure between latent state x and attractor A, κ_{A}(x) denotes a convergence-rate metric associated with attractor A in a neighborhood of x, λ_{A}(x,t) denotes a time-varying stability index that characterizes the robustness or persistence of attractor A at state x and time t, and θ(t) denotes one or more external context or task-state variables at time t. The function h_{A}(⋅) may be implemented as an analytic function, a learned neural mapping, a rule-based evaluator, or any combination thereof configured to map geometric, dynamical, and contextual features into a scalar or vector weight.

In certain embodiments, the convergence-rate metric κ_{A}(x) quantifies how rapidly trajectories initialized near state x approach attractor A, while the stability index λ_{A}(x,t) reflects local sensitivity of trajectories to perturbations or parameter changes over time. The context variables θ(t) may encode one or more of: current task objectives, cognitive mode indicators (e.g., exploration versus exploitation emphasis), user-provided priorities, environmental conditions, or operational constraints. By incorporating these quantities into the dynamic weighting function, the system allows attractor influence to vary not only with geometric proximity, but also with how quickly and stably the system is expected to converge toward a given attractor under the prevailing context.

In additional embodiments, the specification of Π_{A}(x,t) as a time- and context-dependent function makes explicit that attractor proximity is not treated as a static attribute of the manifold. Instead, attractor-proximity scores are updated to reflect evolving manifold geometry, changing stability properties, and shifting external or task-conditioned context. Any implementation in which attractor weights, proximity scores, or influence coefficients are adapted based on one or more of geometric distances, convergence-rate metrics, stability indices, or external context variables is treated as an embodiment of the adaptive weighting and context-dependent prediction framework disclosed herein.

In various embodiments, the system supports recurrent and feedback-based prediction architectures over the latent manifold. A recurrent cognitive flow may be implemented by iteratively applying a prediction operator P to the current latent state x, so as to generate a sequence of future states according to xₜ₊₁=P(xₜ), xₜ₊₂=P(xₜ₊₁), and so on. This recurrent structure enables the system to roll out multi-step cognitive trajectories by repeatedly composing the same local transition operator while remaining anchored in the geometric structure of the manifold and the associated attractor configuration.

In certain embodiments, the system further implements a feedback-conditioned predictor that adjusts the nominal prediction based on discrepancies between predicted and realized flow. A feedback-conditioned prediction operator P_{fb} may be defined by

$${P}_{f b} ( {x}_{t} ) = P ( {x}_{t} ) + Γ ( {x}_{t} , P ( {x}_{t} ) ) ,$$

where Γ(⋅) denotes a correction operator configured to incorporate one or more feedback signals, such as deviations between anticipated and observed latent state evolution, task-specific performance signals, or external supervisory guidance. Feedback may be applied internally as a self-correction mechanism within a single manifold, across coupled manifolds that share attractors or transition structure, through task-conditioning signals that modulate predictions based on current objectives, and via externally supplied signals that encode user input, environmental measurements, or higher-level control directives.

In additional embodiments, attractor-conditioned prediction is interpreted within a control-theoretic framework as a closed-loop system stabilizing latent trajectories near attractor configurations. For a given attractor A with an associated equilibrium or reference state

$${x}_{A}^{*} ,$$

the system may consider a deviation variable

$$y = x - {x}_{A}^{*}$$

and approximate the local dynamics by a linear or locally linearized model of the form \dot{y}≈Jₐy, where J_{A} denotes a Jacobian or effective system matrix in a neighborhood of the attractor. Stable eigenvalues λᵢ of J_{A} with negative real parts correspond to directions in which trajectories converge toward the attractor, while eigenvalues with positive real parts or weak stability characterize directions associated with basin boundaries, separatrices, or sensitivity to perturbations. The resulting stable and unstable eigenspaces define multi-dimensional manifolds of stability and boundary surfaces that structure the attractor basin.

In some embodiments, the system derives attractor-proximity scores from this control-theoretic local model. For example, in a coordinate system aligned with the eigenvectors of J_{A}, the deviation vector y may be expressed in components yᵢ, and proximity to attractor A may be approximated by a weighting function of the form

$${Π}_{A} ( x ) = exp ( - {\sum }_{i} ( - {λ}_{i} ) {y}_{i}^{2} ) ,$$

where λᵢ are eigenvalues associated with the local linearization and the factor −λᵢ encodes the strength of attraction along each eigendirection. In this way, stronger attracting directions (more negative λᵢ) contribute more sharply to the proximity measure. Any implementation in which attractor neighborhoods are characterized via local linear or linearized control models, eigenstructure analysis, and associated exponential or quadratic forms for defining attractor-proximity scores is treated as an embodiment of the disclosed control-theoretic formulation of geometric cognition.

In various embodiments, the system formalizes attractor-centric cognition using operator-theoretic representations, including Koopman operators and transfer (Perron-Frobenius) operators defined over the latent manifold. A dynamical evolution on the manifold may be represented by a map F:M→M, and observables g:M→ [symbol] may be propagated forward in time using a Koopman operator K defined by

$$( K g ) ( x ) = g ( F ( x ) ) .$$

Under this formulation, multi-step prediction of observables along a cognitive trajectory {xₜ} is expressed as

$$g ( {x}_{t + k} ) = {K}^{k} g ( {x}_{t} ) ,$$

where K^{k} denotes the k-fold composition of the Koopman operator.

In some embodiments, attractors on the manifold are associated with dominant invariant subspaces or spectral components of the Koopman operator, and attractor-proximity information is used to construct attractor-conditioned operators. For example, the system may define attractor-conditioned Koopman operators K_{A} for attractors A∈ [symbol] (M), and an attractor-modulated operator

$${K}_{a t t} = \text{?} {Π}_{A} ( x ) {K}_{A} ,$$

where Π_{A}(x) denotes an attractor-proximity score at state x. In certain implementations, Kₐₜₜ is applied to observables so that the contribution of each attractor-conditioned operator is weighted according to the local influence of the corresponding attractor.

In additional embodiments, the system employs a transfer-operator (Perron-Frobenius) formalization of probability flows on the manifold. A transfer operator P acting on a probability density ρ over M may be defined by

$$( P ρ ) ( y ) = {\int }_{M} ρ ( x ) δ ( y - F ( x ) ) d x ,$$

where δ(⋅) denotes a Dirac delta distribution. Attractor-driven modulation of probability flow may be represented using attractor-conditioned transfer operators P_{A} and an attractor-modulated operator

$${P}_{a t t} = \text{?} {Π}_{A} ( x ) {P}_{A} ,$$

so that the evolution of densities reflects both the underlying dynamics and the state-dependent influence of attractor structures. These Koopman-operator and transfer-operator embodiments provide operator-theoretic realizations of geometric cognition and attractor-proximity-based prediction on the latent manifold.

In various embodiments, the system provides an information-geometric formulation of attractor structures and attractor-proximity scoring on the latent manifold. The latent manifold may be realized as a statistical manifold whose points x parameterize probability distributions p(ω|x) over observations, internal features, or cognitive outcomes. An information-geometric metric may be defined on this manifold using the Fisher information metric

$${g}_{ij} ( x ) = 𝔼 [ \frac{\partial }{\partial {x}_{i}} log p ( ω \vert x ) \frac{\partial }{\partial {x}_{j}} log p ( ω \vert x ) ] ,$$

so that distances and geodesics on the manifold reflect differences between the associated probability distributions rather than only Euclidean distances in coordinate space.

In some embodiments, attractors are characterized as low-divergence regions in this information-geometric sense. For an attractor A associated with a reference distribution p(⋅|A), the system may describe the attractor as a minimizer of a divergence functional, for example

$$A = arg {min}_{x} {D}_{KL} ( p ( \cdot \vert x ) ‖ p ( \cdot \vert A ) ) ,$$

where D_{KL} denotes the Kullback-Leibler divergence. Attractor-proximity scoring may be defined using an information-geometric proximity function such as

$${\prod }_{A} ( x ) = exp ( - λ {D}_{KL} ( p ( \cdot \vert x ) ‖ p ( \cdot \vert A ) ) ) ,$$

where λ>0 is a scaling parameter that controls the sharpness of the proximity response. This formulation enables the system to treat attractor neighborhoods and cognitive trajectories as structures on a statistical or variational manifold, and to compute attractor-proximity scores based on divergence between distributions associated with latent states and attractor-aligned reference distributions.

In various embodiments, the cognitive manifold M is endowed with a Morse-theoretic structure that provides a topological characterization of attractors, saddles, and basin boundaries. The system may define a Morse function V:M→ [symbol] with isolated critical points satisfying ∇V(x)=0, where each critical point is associated with a Morse index indicating the number of unstable directions at that point. In some implementations, critical points of index 0 correspond to attractors or locally stable configurations of the cognitive dynamics, while critical points of higher index correspond to saddle-type structures that mediate transitions between basins of attraction or define separatrices within the manifold.

In certain embodiments, the Morse structure is used to segment the manifold into stable (descending) and unstable (ascending) manifolds associated with each attractor or critical point. For an attractor A with a corresponding critical point of index 0, the stable manifold W^{s}(A) may be defined as

$${W}^{s} ( A ) = \{ x ∈ M : {lim}_{t \to ∞} {F}_{t} ( x ) = A \} ,$$

where Fₜ denotes the flow induced by the cognitive dynamics. Similarly, for a critical point A, the unstable manifold W^{u}(A) may be defined as

$${W}^{u} ( A ) = \{ x ∈ M : {lim}_{t \to - ∞} {F}_{t} ( x ) = A \} ,$$

representing the set of trajectories that emanate from the critical point under backward-time evolution. In some implementations, the basins of attraction for index-0 attractors are described as stable manifolds, and basin boundaries are characterized by unions of unstable manifolds associated with saddle-type critical points. This topological segmentation provides a robust, coordinate-free description of attractor basins and their interfaces.

In additional embodiments, the system leverages these Morse-theoretic constructions to define and compute topological summaries of the cognitive manifold, such as Morse decompositions, graph-based representations of flow between critical sets, Reeb graphs derived from level sets of the Morse function, or discrete Morse-theoretic approximations constructed on sampled data or discretized complexes. These topological structures may be used to organize attractor configurations, encode connectivity between basins, and support attractor-proximity scoring and manifold-flow prediction using purely topological or combinatorial representations. Any implementation in which attractor basins, basin boundaries, and cognitive flow structures are modeled using Morse functions, stable and unstable manifolds, or derived topological summaries is treated as an embodiment of the topological and Morse-theoretic framework disclosed herein.

In various embodiments, the cognitive manifold M is endowed with a Hamiltonian or symplectic structure so that at least a portion of the cognitive dynamics is modeled as conservative, energy-preserving flow. The system may represent the manifold as a symplectic space (M, ω, H), where ω denotes a symplectic form and H:M→ [symbol] denotes a Hamiltonian function. A Hamiltonian vector field X_{H} may be defined on the manifold and the latent state x may evolve according to

$$\dot{x} = {X}_{H} ( x ) ,$$

so that trajectories follow Hamiltonian flow lines that preserve the symplectic structure and Hamiltonian level sets, providing a model of oscillatory, reversible, or energy-conserving cognitive dynamics.

In certain embodiments, the system augments the Hamiltonian flow with dissipative components that give rise to attractors and basin structures on the manifold. A dissipative term may be introduced via a potential function V:M→ [symbol] , yielding hybrid dynamics of the form

$$\dot{x} = {X}_{H} ( x ) - ∇ V ( x ) ,$$

where ∇V(x) denotes a gradient-like vector field with respect to a chosen Riemannian or information-geometric metric on M. Attractors may arise as local minima of V or of a collection of attractor-specific potential functions {V_{A} [symbol] . In some embodiments, the dissipative component is explicitly modulated by attractor-proximity scores so that the evolution of the latent state is given by

$$\dot{x} = {X}_{H} ( x ) - {\sum }_{A ∈ 𝒜 ( M )} {\prod }_{A} ( x ) ∇ {V}_{A} ( x ) ,$$

where Π_{A}(x) denotes an attractor-proximity score associated with attractor A at state x. This formulation enables attraction strength and direction to depend on both geometric position and attractor-proximity scoring.

In additional embodiments, manifold-flow prediction in the Hamiltonian-dissipative setting is expressed in terms of the flow operator associated with the combined vector field. For a given initial state xₜ and a time increment Δt, a predicted future state \hat{x}_{t+Δt} may be computed as

$${\hat{x}}_{t + Δ t} = {Flow}_{{X}_{H} - {Σ}_{A} {Π}_{A} ∇ {V}_{A}} ( {x}_{t} , Δ t ) ,$$

where Flowₓ_{_{H}}_{-Σ}_{_{A}}_{Π}_{_{A}}_{∇v}_{_{A}} (ω,Δt) denotes the time-Δt flow map generated by the hybrid Hamiltonian-dissipative vector field. Any implementation in which cognitive trajectories are modeled using Hamiltonian or symplectic components combined with attractor-modulated dissipative terms, and where attractor-proximity scores modulate the strength or direction of dissipation, is treated as an embodiment of the Hamiltonian and hybrid dissipative dynamics framework disclosed herein.

In various embodiments, the system characterizes attractor structures on the cognitive manifold using spectral and eigenstructure analysis. The manifold may be equipped with one or more operators whose eigenfunctions encode geometric and dynamical structure, including a Laplace-Beltrami operator Δ, a Fokker-Planck operator associated with stochastic dynamics, and one or more Koopman operators associated with observable evolution. For example, the Laplace-Beltrami operator may satisfy an eigenvalue problem of the form

$$Δ {ϕ}_{k} ( x ) = {λ}_{k} {ϕ}_{k} ( x ) ,$$

where φₖ denotes an eigenfunction and λₖ denotes the corresponding eigenvalue. In some implementations, attractor basins are associated with eigenfunctions exhibiting small eigenvalues and localization properties that concentrate probability mass or geometric structure in neighborhoods of attractors.

In certain embodiments, attractors are identified or characterized by dominant eigenvectors or eigenfunctions of at least one of: the Laplace-Beltrami operator, a Fokker-Planck operator governing probability flow, or a Koopman operator governing the evolution of observables. Spectral clustering, diffusion maps, or related manifold-learning techniques may be employed to group states according to their coordinates in the space of leading eigenfunctions, thereby revealing attractor-aligned regions and basin boundaries. Attractor-proximity scoring may then be defined in terms of these spectral coordinates. For an attractor A, the system may specify an index set I(A) identifying eigenfunctions associated with that attractor, and define an attractor-proximity function of the form

$${\prod }_{A} ( x ) = {\sum }_{k ∈ I ( A )} {w}_{k} {ϕ}_{k} ( x ) ,$$

where wₖ denotes a weighting coefficient associated with eigenfunction φₖ. The weights wₖ may be chosen analytically, estimated from data, or learned by a model so that Π_{A}(x) increases for states within or near the basin of attractor A.

In additional embodiments, spectral and eigenstructure-based attractor characterizations are employed in combination with other geometric, probabilistic, or topological mechanisms disclosed herein. Implementations that derive attractor neighborhoods, basin structures, or attractor-proximity scores from eigenfunctions or eigenvectors of Laplace-Beltrami, Fokker-Planck, Koopman, or related operators on the latent manifold are treated as embodiments of the spectral and eigenstructure characterization framework for geometric cognition.

In various embodiments, the system characterizes attractors on the cognitive manifold using Lyapunov functions that serve as scalar stability certificates. For an attractor A, a Lyapunov function L_{A}:M → [symbol] _{≥0} may be defined such that L_{A}(x)=0 on the attractor set associated with A and L_{A}(x) >0 away from that attractor. The Lyapunov function may satisfy a decrease condition of the form

$$\frac{d}{d t} {L}_{A} ( {F}_{c} ( x ) ) < 0 for x ∉ A ,$$

where Fₜ denotes the flow induced by the cognitive dynamics. Under this formulation, trajectories initialized away from the attractor move along directions in which the corresponding Lyapunov function decreases, thereby providing a constructive mechanism for identifying and certifying attractor regions on the manifold.

In some embodiments, the system derives attractor-proximity scores from the values of the Lyapunov functions. For a given attractor A, an attractor-proximity score Π_{A}(x) may be defined as

$${\prod }_{A} ( x ) = \frac{1}{1 + {L}_{A} ( x )} ,$$

or more generally as a monotone decreasing function of L_{A}(x), so that states with smaller Lyapunov values (closer to the attractor) receive higher proximity scores and states with larger Lyapunov values receive lower proximity scores. The Lyapunov-based proximity definition may be used alone or in combination with other geometric, probabilistic, or spectral proximity measures disclosed herein.

In additional embodiments, manifold-flow prediction is formulated in a Lyapunov-consistent manner by explicitly incorporating gradients of the Lyapunov functions into the evolution rule. For a latent state x(t) and time increment Δt, a predicted future state \hat{x}(t+Δt) may be computed according to

$$\hat{x} ( t + Δ t ) = x ( t ) - Δ t {\sum }_{A ∈ 𝒜 ( M )} {\prod }_{A} ( x ( t ) ) ∇ {L}_{A} ( x ( t ) ) ,$$

where ∇L_{A}(x) denotes a gradient of the Lyapunov function associated with attractor A with respect to a chosen metric on the manifold. In this formulation, attractor-proximity scores modulate the influence of each Lyapunov gradient, and the resulting update drives the state in directions that are consistent with Lyapunov-decreasing flow. Any implementation in which Lyapunov functions are used to identify attractors, compute attractor-proximity scores, and define or constrain manifold-flow predictions based on Lyapunov-consistent evolution is treated as an embodiment of the Lyapunov-based attractor discovery and prediction framework described herein.

In various embodiments, the system models local behavior near an attractor using normal-form and local linearization frameworks on the cognitive manifold. For an attractor A associated with a reference state

$${x}_{A}^{*} ,$$

a local deviation coordinate y may be defined according to

$$y = x - {x}_{A}^{*} .$$

In a neighborhood of the attractor, the cognitive dynamics may be approximated by a linear or locally linearized system of the form

$$\dot{y} = {J}_{A} y + O ( {‖ y ‖}^{2} ) ,$$

where J_{A} denotes a Jacobian or effective system matrix evaluated at the attractor and O(∥y∥²) denotes higher-order terms. In some implementations, the spectrum of J_{A} is decomposed into stable eigenvalues λᵢ with negative real parts, which characterize directions of convergence toward the attractor, and unstable or weakly stable eigenvalues, which characterize directions relevant to basin boundaries, separatrices, or local sensitivity to perturbations.

In certain embodiments, the stable and unstable eigenspaces associated with J_{A} are used to define multi-dimensional manifolds of stability and boundary structures in the vicinity of the attractor. For example, eigenvectors corresponding to stable eigenvalues span a local stable manifold that describes directions along which trajectories contract toward the attractor, while eigenvectors corresponding to unstable eigenvalues span directions that lead away from the attractor or toward neighboring basins. This eigenspace decomposition provides a coordinate system in which local behavior near the attractor can be analyzed and used for prediction, control, or basin characterization.

In additional embodiments, attractor-proximity scoring is defined in terms of the local linearized model. In a coordinate system aligned with the eigenvectors of J_{A}, the deviation vector y may be expressed in components yᵢ, and an attractor-proximity function near attractor A may be approximated by

$${\prod }_{A} ( x ) = exp ( - {\sum }_{i} ( - {λ}_{i} ) {y}_{i}^{2} ) ,$$

where λᵢ denotes the eigenvalue associated with the i-th eigendirection. In this formulation, more strongly attracting directions (more negative λᵢ) contribute more sharply to the proximity measure. Any implementation in which local normal forms, Jacobian-based linearizations, eigenvalue-eigenvector decompositions, and associated quadratic or exponential forms are used to characterize attractor neighborhoods, stability properties, or attractor-proximity scores is treated as an embodiment of the normal-form and local linearization frameworks disclosed herein.

In various embodiments, the system implements manifold partitioning and region-of-influence models that decompose the cognitive manifold into regions associated with respective attractors. The manifold M may be partitioned into a collection of regions {R(A) [symbol] according to

$$M = {⋃}_{A ∈ 𝒜 ( M )} R ( A ) ,$$

where each region R (A) represents a domain of influence associated with attractor A. In some implementations, the regions R(A) are defined in terms of attractor-proximity scores Π_{A}(x) by specifying

$$R ( A ) = \{ x ∈ M : {\prod }_{A} ( x ) \geq {\prod }_{B} ( x ) ∀ B ∈ 𝒜 ( M ) \} ,$$

so that each state on the manifold is assigned to the attractor whose proximity score is maximal at that state.

In certain embodiments, the regions-of-influence are instantiated using specific geometric or data-driven partitioning schemes. Examples include Voronoi partitions constructed with respect to attractor representatives embedded in the manifold, geodesic Voronoi diagrams defined using geodesic distances under a chosen Riemannian or information-geometric metric, potential-field decompositions induced by attractor-aligned potential functions, and spectral clustering partitions derived from eigenstructure of Laplace-Beltrami, diffusion, or related operators. These constructions provide alternative realizations of regions R(A) while preserving the association between each region and a corresponding attractor or attractor family.

In additional embodiments, manifold-flow prediction is conditioned on the region-of-influence associated with the current state. For a state x∈R(A), a region-specific predictor or flow field f_{A} may be applied so that the predicted evolution satisfies

$$\hat{f} ( x ) = {f}_{A} ( x ) for x ∈ R ( A ) ,$$

or, in a soft-assignment variant, the system may employ a weighted combination of attractor-aligned predictors as described in other embodiments. Any implementation in which the cognitive manifold is decomposed into attractor-aligned regions-of-influence and prediction or control laws are selected or modulated based on region membership or attractor-proximity scores is treated as an embodiment of the manifold partitioning and region-of-influence framework described herein.

In various embodiments, the system provides a unifying framework that relates heterogeneous attractor representations and manifold-flow formalisms disclosed herein. A family of representation mappings { [symbol] _{α→β}} may be defined, where each mapping [symbol] _{α→β} is configured to transform attractor-related information from a source representation a to a target representation β. Examples of such representations include, without limitation: operator-theoretic descriptions (e.g., Koopman or transfer operators), information-geometric descriptions (e.g., Fisher metrics and divergence-based proximity), topological descriptions (e.g., Morse functions, stable and unstable manifolds), Hamiltonian and hybrid dissipative vector fields, spectral and eigenstructure descriptors, Lyapunov functions, local linearizations and normal forms, and region-of-influence or partition-based models. The mappings [symbol] _{α→β} may be implemented analytically, numerically, or via learned models so as to allow attractor descriptors, proximity scores, and flow predictions obtained in one formalism to be translated into another.

In some embodiments, the system defines a common intermediate descriptor space in which attractors are represented by tuples of canonical quantities, such as one or more of: representative latent points or sets, potential or energy levels, stability indices, spectral signatures, Lyapunov values, local Jacobian summaries, and region-of-influence identifiers. Representation mappings [symbol] _{α→β} may be factored through this intermediate space so that, for example, spectral eigenfunctions and eigenvalues are first converted into basin indicators and stability scores, which are then used to synthesize Lyapunov functions, Morse potentials, or region labels. In certain implementations, attractor-proximity scores Π_{A}(x) defined in one representation are propagated through these mappings to produce compatible proximity functions in other representations, enabling a PCM or other cognitive system to maintain consistent attractor-proximity semantics while switching between geometric, probabilistic, topological, or operator-theoretic views of the same manifold.

In additional embodiments, the unifying framework is employed to coordinate manifold-flow prediction across multiple modeling paradigms. A prediction controller may select, blend, or cross-validate forecasts obtained from different formalisms by using the representation mappings to express them in a shared comparison space. For instance, a Lyapunov-consistent gradient flow, a Koopman-based observable prediction, and a Hamiltonian-dissipative vector field update may each be projected into a common tangent-space description or common observable basis, after which discrepancies between predictions are measured and used to adjust attractor weights, residual flow components, or model selection policies. Any implementation in which heterogeneous attractor and manifold-flow representations are related through explicit transformation operators, intermediate descriptor spaces, or shared comparison coordinates, and in which attractor-proximity scores and flow predictions are propagated or reconciled across these representations, is treated as an embodiment of the unifying heterogeneous-representation framework disclosed herein.

In various embodiments, a cognitive manifold M is represented within a cognitive system as an internal computational object rather than solely as an abstract mathematical construct. The manifold may be realized using one or more data structures, encodings, or latent geometries that permit cognitive states, attractors, and trajectories to be stored, queried, and updated during operation. The representations described herein are non-limiting examples, and the invention is not restricted to any particular embedding scheme, coordinate chart, or explicit geometric parameterization.

In some embodiments, manifold M is represented by one or more coordinate charts. A collection of subsets {U_{α}} may cover at least a portion of M, with each subset U_{α} associated with a chart mapping φ_{α}:U_{α} → [symbol] ^{d}^{_{α}}. Latent states x∈U_{α} are thereby represented by coordinate vectors φ_{α}(x), and transitions on the manifold are implemented as transformations in coordinate space. Coordinate-based implementations may include, without limitation, learned embedding spaces, hand-designed feature spaces, or hybrid constructions that combine learned and analytic coordinates.

In additional embodiments, the manifold is represented implicitly through transition statistics defined on a state space. For example, an empirically derived transition kernel K(x,y) may encode the probability, density, or frequency of transitions from a state x to a state y. The manifold M may be characterized as the support, dominant subspace, or intrinsic geometry induced by this transition kernel, so that geometric structure is recovered from observed or simulated transitions rather than predefined coordinate charts.

In further embodiments, the manifold is approximated by a discrete graph G=(V,E) whose vertices V correspond to representative latent states or state clusters and whose edges E encode adjacency, similarity, or feasible transitions. Geodesics or shortest-path distances on the manifold may be approximated by shortest paths in the graph, and attractors may be represented as recurrent, highly connected, or strongly absorbing subgraphs. This graph-based approximation enables manifold operations to be implemented using standard graph algorithms.

In some embodiments, the manifold is represented through one or more potential functions {Vⱼ} defined on a state space. Level sets and gradient structure of these potential functions encode geometric features, such as basins of attraction, ridges, and barriers. Attractors may be realized as local minima of one or more potential functions, and manifold structure may be inferred from the geometry of the associated potential landscape without maintaining explicit coordinates or graphs.

In yet other embodiments, the manifold is represented as a symbolic or logical space, in which elements of M correspond to symbolic states, propositions, or structured terms, and relations between symbols encode adjacency, continuity, or topological neighborhood. Local topology may be captured by syntactic constraints, rewrite rules, or logical entailment relations, and geometric reasoning may be implemented as symbolic inference over this representation.

The specification expressly contemplates that any of these representations, as well as combinations and extensions thereof, may be employed to realize the manifold M. Implementations in which the system internally converts between coordinate-based, transition-based, graph-based, potential-field, symbolic, or other representational formats as needed for computation, storage, or inference are treated as embodiments of the abstract manifold representation framework disclosed herein.

In various embodiments, a cognitive system defines an abstract manifold interaction layer that specifies a set of functional interfaces through which components interact with a cognitive manifold M. These interfaces are described in terms of logical operations that may be realized by a variety of underlying implementations, including but not limited to coordinate-based embeddings, graph-based approximations, transition-kernel models, or symbolic representations as described in other embodiments. The abstract interaction layer enables the system to decouple internal geometric representations from higher-level cognitive operations, so that different manifold realizations remain interoperable with a common set of cognitive functions.

In some embodiments, the abstract interaction layer comprises a state-to-manifold mapping interface configured to map an external or internal state s to a corresponding latent state x∈M. This interface may be implemented as a function, module, or pipeline that performs one or more of: feature extraction, embedding, encoding, normalization, or coordinate transformation operations so as to represent heterogeneous cognitive states, observations, or contexts as points on the manifold. An attractor identification interface may be configured to analyze the manifold representation M and produce a collection of attractors {Aᵢ}, where each attractor may be represented by a set of latent points, a parametric description, a potential minimum, a recurrent graph region, or any other attractor descriptor consistent with the manifold representation.

In additional embodiments, a proximity scoring interface is configured to compute an attractor-proximity score Π_{A}_{ᵢ}(x) for a given latent state x and attractor Aᵢ. The proximity scoring interface may utilize any of the geometric, probabilistic, spectral, topological, or control-theoretic measures disclosed herein, including distance metrics, divergence measures, Lyapunov values, eigenfunction coordinates, or region-of-influence assignments. A flow prediction interface is configured to receive a latent state x and produce one or more predicted future states \hat{x} or predicted flow descriptors based on attractor-conditioned dynamics, residual components, or hybrid deterministic-stochastic evolution models. A geometry update interface is configured to update the manifold representation M in response to new experience, data, or cognitive activity, thereby producing an updated manifold M′ that reflects learned structure, updated attractor configurations, or revised transition statistics. Implementations in which a cognitive system exposes any subset or superset of these interfaces, or functionally equivalent interfaces, for state embedding, attractor identification, proximity scoring, flow prediction, and geometry updating are treated as embodiments of a unified manifold interaction framework for cognitive systems.

In various embodiments, the manifold-based cognition mechanisms disclosed herein are implemented within a persistent cognitive machine (PCM) architecture or other cognitive substrates using the abstract manifold interaction layer described in other embodiments. A PCM may comprise one or more components configured to host or interact with a cognitive manifold M, including an embedding subsystem, a reasoning or dynamics subsystem, and one or more storage and retrieval subsystems. The manifold M, its attractor configurations, and associated flow prediction operators may be instantiated as internal data structures, models, or services that are accessible to the PCM executive core through the manifold interaction interfaces. In some embodiments, the PCM executive core invokes the state-to-manifold mapping interface to embed thought representations, user inputs, or task contexts as latent states on M, invokes the attractor identification and proximity scoring interfaces to obtain attractor descriptors and attractor-proximity scores for those states, and invokes the flow prediction interface to compute predicted cognitive trajectories or future manifold states used for planning, anticipation, or thought synthesis.

In additional embodiments, the same manifold interaction layer is bound to other cognitive substrates, including but not limited to neural network-based models, spiking or neuromorphic systems, probabilistic graphical models, or symbolic reasoning engines. A neural or neuromorphic substrate may provide the underlying latent geometry and transition dynamics that realize manifold M, while the abstract interfaces expose those capabilities to higher-level modules in a substrate-agnostic manner. Conversely, a symbolic or rule-based cognitive system may define a symbolic manifold representation and implement attractor and flow operations using rule evaluation and search procedures, while still conforming to the same manifold interaction interfaces. The specification expressly encompasses implementations in which a PCM, a neural network system, a hybrid neuro-symbolic architecture, or other cognitive platform instantiates the manifold, attractor, and flow structures using substrate-specific mechanisms behind a common abstract interface. Any implementation in which manifold-based attractor discovery, attractor-proximity scoring, and manifold-flow prediction are provided as services to a PCM or other cognitive system via such an interaction layer is treated as an embodiment of the integration framework disclosed herein.

In various embodiments, the system supports multiple internal representations for attractor-proximity information and manifold flow fields, and is not limited to any particular encoding or data type. Attractor-proximity scores Π_{A} (x) associated with an attractor A and latent state x and flow fields f(x) describing cognitive state evolution on a manifold M may be realized using scalar, vector, tensor, or higher-order field structures, depending on the requirements of a given implementation.

In some embodiments, proximity information is represented as one or more scalar fields on the manifold. For each attractor A, a scalar proximity field Π_{A}:M→ [symbol] may be defined such that Π_{A}(x) encodes a proximity score, influence weight, or membership value for state x with respect to attractor A. These scalar fields may be stored as coordinate-based arrays, graph-based node labels, function approximators, or any other representation compatible with the underlying manifold realization.

In additional embodiments, flow information is represented as one or more vector fields on the manifold. A flow field f:M→TM may assign to each state x∈M a tangent vector f(x) indicating a preferred direction and magnitude of motion, drift, policy, or cognitive evolution. The same framework may be extended to tensor-valued fields in cases where curvature, anisotropy, or directional structure is encoded. For example, a tensor field T(x)∈ [symbol] ^{d×d} (or an equivalent representation in the tangent and cotangent bundles) may be maintained to describe local metric structure, diffusion anisotropy, or direction-dependent stability. Any implementation in which attractor-proximity scores and manifold flow information are represented using scalar, vector, tensor, or higher-order fields, alone or in combination, is treated as an embodiment of the proximity and flow field representation framework disclosed herein.

In various embodiments, a geometric cognition engine is characterized by explicit execution semantics that describe how manifold-based predictions are evaluated over time. In some embodiments, the engine operates in a synchronous, discrete-time mode in which a latent state xₜ is updated at evaluation steps according to a transition operator P, such that the next state satisfies

$${x}_{t + 1} = P ( {x}_{t} ) .$$

This synchronous evaluation model may be used in systems that process cognitive updates on fixed cycles, clock ticks, or scheduled decision stages.

In certain embodiments, the engine operates in an asynchronous or continuous-time mode in which the latent state evolves according to a differential relation

$$\frac{d x}{d t} = f ( x ) + {\sum }_{A} {\prod }_{A} ( x ) {f}_{A} ( x ) ,$$

where f(x) denotes a baseline flow field on the manifold and f_{A}(x) denotes an attractor-aligned flow component associated with attractor A, weighted by an attractor-proximity score Π_{A}(x). In this formulation, the engine realizes a continuous cognitive flow whose instantaneous velocity depends on both global dynamics and attractor-conditioned contributions.

In additional embodiments, the engine employs event-driven execution semantics in which flow prediction and state updates occur only when one or more triggering conditions are satisfied. For example, the latent state at a future time t+Δt may be defined by

$${x}_{t + Δ t} = \{ \begin{matrix}P ( {x}_{t} ) , & if an event triggers evaluation , \\ {x}_{t} , & otherwise ,\end{matrix}$$

so that the manifold state remains unchanged between events and is updated only on recognized cognitive, environmental, or system-level triggers. In further embodiments, hybrid execution models are employed that combine synchronous, continuous-time, and event-driven behaviors in any proportion, including systems in which continuous evolution is punctuated by discrete jumps or event-conditioned corrections. Implementations in which the geometric cognition engine operates in synchronous, asynchronous/continuous, event-driven, or hybrid execution modes, or any functionally equivalent execution semantics, are expressly encompassed within the scope of the systems and methods described herein.

In various embodiments, a geometric cognition engine is characterized by explicit execution semantics that describe how manifold-based predictions are evaluated over time. In some embodiments, the engine operates in a synchronous, discrete-time mode in which a latent state x, is updated at evaluation steps according to a transition operator P, such that the next state satisfies

$${x}_{t + 1} = P ( {x}_{t} ) .$$

This synchronous evaluation model may be used in systems that process cognitive updates on fixed cycles, clock ticks, or scheduled decision stages.

In certain embodiments, the engine operates in an asynchronous or continuous-time mode in which the latent state evolves according to a differential relation

$$\frac{d x}{d t} = f ( x ) + {\sum }_{A} {\prod }_{A} ( x ) {f}_{A} ( x ) ,$$

where f(x) denotes a baseline flow field on the manifold and f_{A}(x) denotes an attractor-aligned flow component associated with attractor A, weighted by an attractor-proximity score Π_{A}(x). In this formulation, the engine realizes a continuous cognitive flow whose instantaneous velocity depends on both global dynamics and attractor-conditioned contributions.

In additional embodiments, the engine employs event-driven execution semantics in which flow prediction and state updates occur only when one or more triggering conditions are satisfied. For example, the latent state at a future time t+Δt may be defined by

$${x}_{t + Δ t} = \{ \begin{matrix}P ( {x}_{t} ) , & if an event triggers evaluation , \\ {x}_{t} , & otherwise ,\end{matrix}$$

so that the manifold state remains unchanged between events and is updated only on recognized cognitive, environmental, or system-level triggers. In further embodiments, hybrid execution models are employed that combine synchronous, continuous-time, and event-driven behaviors in any proportion, including systems in which continuous evolution is punctuated by discrete jumps or event-conditioned corrections. Implementations in which the geometric cognition engine operates in synchronous, asynchronous/continuous, event-driven, or hybrid execution modes, or any functionally equivalent execution semantics, are expressly encompassed within the scope of the systems and methods described herein.

In various embodiments, a cognitive system is implemented as a dataflow architecture in which manifold-based cognition proceeds through an ordered sequence of functional modules. A conceptual dataflow graph may be defined to describe the interplay among an embedding module configured to map external or internal states into latent manifold states (EmbedState), an attractor identification module configured to detect or retrieve attractors on the manifold (FindAttractors), a proximity scoring module configured to compute attractor-proximity scores for a given latent state (ProximityScores), a flow prediction module configured to generate predicted manifold flow or future latent states based on attractor-conditioned dynamics (PredictFlow), and an optional geometry update module configured to update manifold structure, attractor configurations, or transition statistics in response to new experience or data (UpdateGeometry). In some implementations, the primary processing path follows the sequence EmbedState →FindAttractors →ProximityScores →PredictFlow →(optional) UpdateGeometry.

In certain embodiments, the dataflow graph admits feedback, branching, merging, and shortcut paths so that computation proceeds through configurable routes. Feedback arcs may be provided from the geometry update module back to the attractor identification or proximity scoring modules so that manifold updates influence subsequent attractor discovery and scoring. Branching may be employed to route a common embedded state or proximity profile into multiple flow prediction modules, for example to support alternative predictive models or task-specific forecasting strategies. Merging operations may combine outputs from multiple predictors into ensemble predictions, aggregated flow estimates, or consensus trajectories. In some embodiments, the graph supports skipping paths in which flow prediction is performed directly from an embedded state without explicit recomputation of attractors or proximity scores, for example when cached attractor information is available. Any implementation in which manifold-based cognition is realized as a configurable dataflow graph connecting embedding, attractor identification, proximity scoring, flow prediction, and optional geometry update modules is treated as an embodiment of the high-level dataflow architecture.

In various embodiments, the geometric cognition framework is extended to coupled or multi-agent systems in which multiple cognitive entities interact through their respective manifolds. A collection of agents indexed by j∈ [symbol] may each maintain a latent manifold state

$${x}_{t}^{( j )}$$

at time t, where

$${x}_{t}^{( j )} ∈ {M}^{( j )}$$

denotes the internal cognitive state of agent j. The evolution of each agent's state may be governed by a coupling-aware prediction operator P^{(j)} such that

$${x}_{t + 1}^{( j )} = {P}^{( j )} ( {x}_{t}^{( j )} , {\{ {x}_{t}^{( i )} \}}_{i \neq j} ) ,$$

so that the future state of agent j depends on its own manifold state and, optionally, on the manifold states of one or more other agents.

In some embodiments, each agent maintains its own attractor set [symbol] ^{(j)} and corresponding attractor-proximity scores

$${Π}_{A}^{( j )}$$

(x^{(j)}), while coupling terms allow attractor structure or proximity information to propagate across agents. For example, the proximity score for attractor A in agent j may be expressed as

$${Π}_{A}^{( j )} ( {x}^{( j )} , {\{ {x}^{( i )} \}}_{i \neq j} ) ,$$

so that neighboring agents' states modulate which attractors are active, how strongly they influence flow, or how basins of attraction deform under interaction. The coupling may be symmetric or asymmetric, may be restricted to local neighborhoods in a communication or interaction graph, and may be implemented using any combination of geometric, probabilistic, or rule-based mechanisms.

In additional embodiments, the coupled manifold formulation is applied to distributed geometric cognition systems including, without limitation, robot teams, swarm-intelligence platforms, sensor networks, and multi-agent reasoning systems. Each agent may host its own manifold representation, attractor configuration, and flow operators, while the coupling structure implements coordination, consensus, division of labor, or information sharing via attractor-modulated influences. Implementations in which multiple manifolds or manifold-valued agents interact through coupling terms in their update laws, share or exchange attractor information, or jointly shape manifold-flow predictions through cross-agent dependencies are treated as embodiments of the multi-agent and coupled-manifold geometric cognition framework described herein.

In various embodiments, the system implements memory-augmented geometric cognition in which the manifold state is coupled to an explicit memory variable. A cognitive state at time t may be represented as a pair (xₜ,mₜ), where xₜ∈M denotes a latent manifold state and mₜ denotes a memory state maintained by the cognitive system. The evolution of the combined state may be defined by a joint transition operator T according to

$$( {x}_{t} , {m}_{t} ) ↦ ( {x}_{t + 1} , {m}_{t + 1} ) ,$$

so that both the manifold coordinates and the memory variable are updated together at each evaluation step. In some embodiments, the memory state mₜ encodes one or more of: summaries of past latent states, sufficient statistics over previous trajectories, task or context tags, or persistent cognitive machine state variables.

In certain embodiments, the memory variable directly influences attractor-proximity scoring. For an attractor A, an attractor-proximity function Π_{A}(x,m) may be defined as

$${Π}_{A} ( x , m ) = {h}_{A} ( d ( x , A ) , m ) ,$$

where d(x,A) denotes a distance or dissimilarity measure between latent state x and attractor A, and h_{A}(⋅) denotes a function configured to combine geometric proximity information with the memory state m. Under this formulation, attractor influence depends not only on the current geometric position on the manifold but also on memory-dependent factors such as prior visits, recency or frequency of activation, task context, or user-specified priorities encoded in m.

In additional embodiments, the memory variable also modulates manifold-flow prediction. A prediction operator P may be defined so that a predicted next latent state is given by

$${\hat{x}}_{t + 1} = P ( {x}_{t} , {m}_{t} ) ,$$

where the operator takes as input both the current manifold state and the current memory state. The corresponding memory update mₜ₊₁ may be produced by the same operator or by a separate memory-update operator, and may depend on (xₜ, mₜ), \hat{x}ₜ₊₁, or observed outcomes. This memory-augmented formulation provides a bridge between geometric cognition on latent manifolds and persistent cognitive architectures, including PCMs, while remaining compatible with a variety of underlying substrates and implementation technologies.

In various embodiments, the invention is implemented using dynamical geometric systems whose internal states evolve according to operator-defined flows on one or more manifolds. A cognitive state is represented as a point x on a manifold M, and state evolution is governed by vector fields and flow operators defined on M. These dynamical embodiments may be realized as continuous-time systems, discrete-time systems, hybrid symbolic-dynamical systems, physics-inspired systems, or combinations thereof.

In some embodiments, the cognitive dynamics are expressed in continuous time. A state trajectory x(t) on manifold M may satisfy

$$\frac{d x}{d t} = f ( x ) + \text{?} {Π}_{A} ( x ) {f}_{A} ( x ) ,$$

where f(x) denotes a baseline flow field on the manifold [symbol] (M) denotes a set of attractors, f_{A}(x) denotes an attractor-aligned flow contribution associated with attractor A, and Π_{A}(x) denotes an attractor-proximity score or influence weight for attractor A at state x. Under this formulation, the instantaneous velocity of the cognitive state is determined by both global geometric dynamics and attractor-conditioned contributions.

In additional embodiments, the cognitive dynamics are expressed in discrete time. A sequence of latent states {xₜ} on manifold M may be generated by a transition operator F according to

$${x}_{t + 1} = F ( {x}_{t} ) ,$$

where F is configured to implement a one-step update derived from the underlying flow fields and attractor-weighted influences. The discrete-time operator F may correspond to a numerical integration of the continuous-time dynamics over a fixed or variable step, or may be specified directly as an operator on the manifold state space.

In certain embodiments, these dynamical-manifold implementations are explicitly non-neural and are distinguished from neural network architectures. The state update rules are implemented by operator-defined flows, symbolic or algorithmic evolution rules, or physics-inspired dynamical equations, rather than by neuron-like units, layered network topologies, or gradient-based weight updates. Systems in which persistent cognitive behavior is realized by non-neural dynamical manifolds with attractor-weighted flow, whether in continuous time, discrete time, or hybrid symbolic-dynamical form, are treated as embodiments of the dynamical-manifold implementation family disclosed herein.

In various embodiments, the invention is implemented using dynamical geometric systems whose internal states evolve according to operator-defined flows on one or more manifolds. A cognitive state is represented as a point x on a manifold M, and state evolution is governed by vector fields and flow operators defined on M. These dynamical embodiments may be realized as continuous-time systems, discrete-time systems, hybrid symbolic-dynamical systems, physics-inspired systems, or combinations thereof.

In some embodiments, the cognitive dynamics are expressed in continuous time. A state trajectory x(t) on manifold M may satisfy

$$\frac{d}{d t} = f ( x ) + \text{?} {Π}_{A} ( x ) {f}_{A} ( x ) ,$$

where f(x) denotes a baseline flow field on the manifold, [symbol] (M) denotes a set of attractors, f_{A}(x) denotes an attractor-aligned flow contribution associated with attractor A, and Π_{A}(x) denotes an attractor-proximity score or influence weight for attractor A at state x. Under this formulation, the instantaneous velocity of the cognitive state is determined by both global geometric dynamics and attractor-conditioned contributions.

In additional embodiments, the cognitive dynamics are expressed in discrete time. A sequence of latent states {xₜ} on manifold M may be generated by a transition operator F according to

$${x}_{t + 1} = F ( {x}_{t} ) ,$$

where F is configured to implement a one-step update derived from the underlying flow fields and attractor-weighted influences. The discrete-time operator F may correspond to a numerical integration of the continuous-time dynamics over a fixed or variable step, or may be specified directly as an operator on the manifold state space.

In certain embodiments, these dynamical-manifold implementations are explicitly non-neural and are distinguished from neural network architectures. The state update rules are implemented by operator-defined flows, symbolic or algorithmic evolution rules, or physics-inspired dynamical equations, rather than by neuron-like units, layered network topologies, or gradient-based weight updates. Systems in which persistent cognitive behavior is realized by non-neural dynamical manifolds with attractor-weighted flow, whether in continuous time, discrete time, or hybrid symbolic-dynamical form, are treated as embodiments of the dynamical-manifold implementation family disclosed herein.

In various embodiments, a persistent cognitive machine (PCM) or other cognitive system is implemented using operator-theoretic dynamical models defined over a latent manifold. A state trajectory {xₜ} on a manifold M with underlying dynamics F:M→M may be represented indirectly through observables g:M → [symbol] and a Koopman operator K acting on those observables. The Koopman operator may be defined by

$$( K g ) ( x ) = g ( F ( x ) ) ,$$

so that forward prediction of observables along a cognitive trajectory is expressed as

$$g ( {x}_{t + k} ) = {K}^{k} g ( {x}_{t} ) ,$$

where K^{k} denotes the k-fold composition (or power) of the Koopman operator. In such implementations, the core PCM computation may be expressed in terms of applying K and its powers to a selected basis of observables, rather than updating state coordinates directly.

In some embodiments, attractors and basins of attraction are identified or characterized through spectral properties of the Koopman operator or a related transfer (Perron-Frobenius) operator. For example, invariant sets, almost-invariant sets, or recurrent regions associated with attractors may correspond to eigenspaces, spectral subspaces, or collections of eigenfunctions with eigenvalues of modulus near one. The system may maintain an explicit representation of one or more eigenfunctions, modes, or spectral components associated with attractor regions, and may define attractor-proximity scores in terms of coordinates of the current state in a Koopman-eigenfunction basis or in terms of invariant densities propagated by a Perron-Frobenius operator acting on probability distributions over M.

In additional embodiments, operator-theoretic models serve as the primary substrate for cognition rather than as auxiliary analysis tools. A PCM may store operator parameterizations, eigenfunctions, and mode amplitudes as part of its persistent cognitive state, and may realize prediction by iterating the Koopman operator, propagating densities under a transfer operator, or combining both. These implementations are explicitly distinguished from neuron-based network architectures: cognitive evolution is governed by operator iteration and spectral structure, not by layered units and weight matrices. Any implementation in which PCM-style persistent cognition is realized using Koopman, Perron-Frobenius, or related operators as the fundamental state-evolution mechanism, with attractors modeled as invariant or almost-invariant spectral structures and predictions obtained via operator iteration, is treated as an embodiment of the operator-theoretic implementation framework disclosed herein.

In various embodiments, a persistent cognitive machine implements hybrid dynamical-symbolic manifold embodiments in which discrete symbolic reasoning steps are coupled to geometric evolution on a latent manifold. A cognitive state may be represented as a composite tuple

$$x = ( {x}_{g eom} , {x}_{l o g i c} ) ,$$

where x_{geom} denotes a geometric latent representation on a manifold M and x_{logic} denotes a symbolic or logical representation. The manifold geometry encodes semantic or relational structure between cognitive states, while the symbolic component encodes propositions, rules, plans, or other discrete reasoning objects.

In some embodiments, a hybrid update is performed in two stages. A symbolic update operator R is applied to the logical component to produce an updated logical state

$${x}_{logic}^{′} = R ( {x}_{l o g i c} ) ,$$

where R may implement rule application, inference, plan refinement, or constraint propagation. A geometric update operator G is then applied to the geometric component, conditioned on the updated logical state and one or more attractor-modulated contributions, to produce an updated geometric state

$${x}_{g e o m}^{′} = G ( {x}_{geom} , {x}_{logic}^{′} ) + \text{?} {Π}_{A} ( x ) {Λ}_{A} ( x ) ,$$

where Π_{A}(x) denotes an attractor-proximity score for attractor A at composite state x, and Λ_{A}(x) denotes an attractor-aligned adjustment, drift, or control term. Under this formulation, symbolic reasoning steps determine discrete transitions in x_{logic}, while the manifold state x_{geom} evolves according to both symbolic context and attractor-conditioned geometric flow.

In additional embodiments, the hybrid dynamical-symbolic manifold architecture is iterated over time to generate a sequence of composite states {(x_{geom,t}, x_{logic,t})}, with each step comprising a symbolic update followed by an attractor-modulated geometric update. This framework implements persistent cognition using explicit symbolic transitions embedded in, and coupled to, a geometric attractor manifold, without requiring neuron-based network architectures. Any implementation in which discrete symbolic updates and continuous or quasi-continuous manifold evolution are combined in this manner, with attractor-proximity scores modulating the geometric component of the update, is treated as an embodiment of the hybrid dynamical-symbolic manifold implementation family disclosed herein.

In various embodiments, the geometric cognition and attractor-based manifold flow mechanisms are implemented using mechanical, analog, or other continuous-time physical systems that are compatible with a persistent cognitive machine (PCM) architecture but need not rely on digital computation. A cognitive state may be represented as a physical configuration x of a mechanical system, an analog electrical network, an optical field, or another physical medium, and state evolution may be governed by continuous-time dynamics realized directly in hardware.

In some embodiments, the system comprises an analog dynamical system defined by one or more potential functions V(x) whose local minima correspond to attractors. The physical state x(t) evolves according to a potential-driven flow of the form

$$\dot{x} ( t ) = - ∇ V ( x ( t ) ) + \text{?} {Π}_{A} ( x ( t ) ) {u}_{A} ( x ( t ) ) ,$$

where −∇V(x) denotes a gradient or gradient-like term driving the state toward minima of the potential landscape, [symbol] denotes a collection of attractors, Π_{A}(x) denotes an attractor-proximity score or influence weight for attractor A at state x, and u_{A}(x) denotes a control, drift, or forcing term associated with attractor A. In a purely mechanical realization, x may encode positions or orientations of masses, linkages, or other mechanical elements, and the potential function V may be realized by springs, gravity, elastic elements, or other energy-storing components that create stable equilibria corresponding to attractors.

In additional embodiments, the manifold and attractor dynamics are realized using analog electrical, optical, or other continuous media. For example, x may represent node voltages or currents in an analog circuit whose passive and active elements implement a potential landscape and attractor structure; or x may represent intensities, phases, or modal amplitudes in an optical system whose resonant modes and coupling structure define attractors and flow directions. In these embodiments, operator flows such as gradient descent, diffusion-like propagation, or attractor-modulated drift are implemented directly by physical laws governing the medium, while attractor-proximity-dependent inputs u_{A}(x) are realized by controllable sources, modulators, or feedback paths.

Implementations in which cognitive manifold states, attractors, and attractor-weighted continuous-time flows are embodied in mechanical, analog electrical, optical, or other non-digital physical systems, and in which the evolution equation includes a potential-driven term −∇V(x) combined with attractor-weighted contributions Σ_{A} Π_{A} (x)u_{A}(x), are treated as embodiments of the mechanical, analog, and continuous-time PCM-compatible implementation family disclosed herein.

One or more different aspects may be described in the present application. Further, for one or more of the aspects described herein, numerous alternative arrangements may be described; it should be appreciated that these are presented for illustrative purposes only and are not limiting of the aspects contained herein or the claims presented herein in any way. One or more of the arrangements may be widely applicable to numerous aspects, as may be readily apparent from the disclosure. In general, arrangements are described in sufficient detail to enable those skilled in the art to practice one or more of the aspects, and it should be appreciated that other arrangements may be utilized and that structural, logical, software, electrical and other changes may be made without departing from the scope of the particular aspects. Particular features of one or more of the aspects described herein may be described with reference to one or more particular aspects or figures that form a part of the present disclosure, and in which are shown, by way of illustration, specific arrangements of one or more of the aspects. It should be appreciated, however, that such features are not limited to usage in the one or more particular aspects or figures with reference to which they are described. The present disclosure is neither a literal description of all arrangements of one or more of the aspects nor a listing of features of one or more of the aspects that must be present in all arrangements.

Headings of sections provided in this patent application and the title of this patent application are for convenience only, and are not to be taken as limiting the disclosure in any way.

Devices that are in communication with each other need not be in continuous communication with each other, unless expressly specified otherwise. In addition, devices that are in communication with each other may communicate directly or indirectly through one or more communication means or intermediaries, logical or physical.

A description of an aspect with several components in communication with each other does not imply that all such components are required. To the contrary, a variety of optional components may be described to illustrate a wide variety of possible aspects and in order to more fully illustrate one or more aspects. Similarly, although process steps, method steps, algorithms or the like may be described in a sequential order, such processes, methods and algorithms may generally be configured to work in alternate orders, unless specifically stated to the contrary. In other words, any sequence or order of steps that may be described in this patent application does not, in and of itself, indicate a requirement that the steps be performed in that order. The steps of described processes may be performed in any order practical. Further, some steps may be performed simultaneously despite being described or implied as occurring non-simultaneously (e.g., because one step is described after the other step). Moreover, the illustration of a process by its depiction in a drawing does not imply that the illustrated process is exclusive of other variations and modifications thereto, does not imply that the illustrated process or any of its steps are necessary to one or more of the aspects, and does not imply that the illustrated process is preferred. Also, steps are generally described once per aspect, but this does not mean they must occur once, or that they may only occur once each time a process, method, or algorithm is carried out or executed. Some steps may be omitted in some aspects or some occurrences, or some steps may be executed more than once in a given aspect or occurrence.

When a single device or article is described herein, it will be readily apparent that more than one device or article may be used in place of a single device or article. Similarly, where more than one device or article is described herein, it will be readily apparent that a single device or article may be used in place of the more than one device or article.

The functionality or the features of a device may be alternatively embodied by one or more other devices that are not explicitly described as having such functionality or features. Thus, other aspects need not include the device itself.

Techniques and mechanisms described or referenced herein will sometimes be described in singular form for clarity. However, it should be appreciated that particular aspects may include multiple iterations of a technique or multiple instantiations of a mechanism unless noted otherwise. Process descriptions or blocks in figures should be understood as representing modules, segments, or portions of code which include one or more executable instructions for implementing specific logical functions or steps in the process. Alternate implementations are included within the scope of various aspects in which, for example, functions may be executed out of order from that shown or discussed, including substantially concurrently or in reverse order, depending on the functionality involved, as would be understood by those having ordinary skill in the art.

### Definitions

As used herein, “Persistent Cognitive Machine” or “PCM” refers to a computing system that maintains persistent cognitive processes regardless of external interaction, can remember previous experiences, learn from these experiences, create new thought experiences independently, and initiate interactions without waiting for external prompts. Unlike traditional AI systems that operate within a prompt-response paradigm, a PCM operates with persistent awareness even when not actively engaged with users or external systems.

As used herein, “sleep state” refers to a mode of operation in which the persistent cognitive machine temporarily reduces responsiveness to external stimuli to focus on internal cognitive maintenance processes, including but not limited to memory consolidation, thought generalization, insight generation, and memory reorganization.

As used herein, “thought” refers to a discrete unit of cognition within the persistent cognitive machine, representing information, concepts, observations, inferences, questions, or other cognitive elements that the system processes and stores. Thoughts may be derived from external inputs, generated through internal reasoning processes, or created through recombination of existing thoughts.

As used herein, “thought cache” refers to the component of the persistent cognitive machine that stores, organizes, and provides access to thoughts. The thought cache may include both short-term and long-term storage capabilities, with mechanisms for transferring information between them and organizing thoughts based on semantic relationships.

### Conceptual Architecture

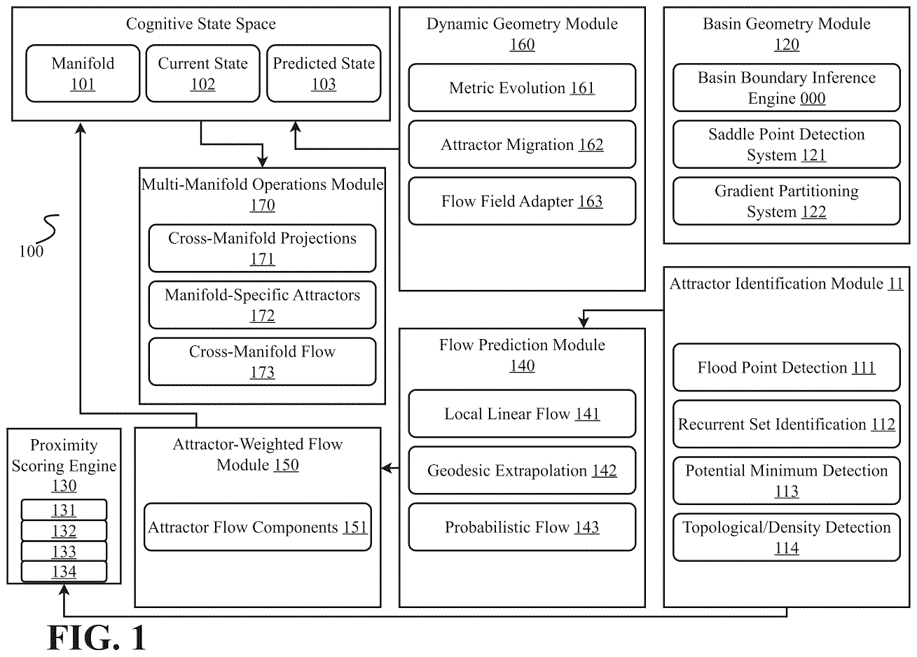

FIG. 1 is a block diagram illustrating the architecture of a geometric cognitive system employing attractor-based manifold flow prediction. The system 100 implements persistent cognitive capabilities through the identification and utilization of attractors within geometric manifolds to predict and guide cognitive state evolution. Unlike traditional artificial intelligence systems that operate through statistical pattern matching or neural activation patterns, system 100 represents cognitive processes as trajectories through a geometric space governed by dynamical attractors and their associated basins of attraction.

At the foundation of system 100 is a manifold 101 representing the geometric cognitive state space M. Manifold 101 is endowed with a metric or pseudo-metric structure that may take various forms including Riemannian, Finsler, Alexandrov, graph-induced, or dynamically computed metrics. The metric structure of manifold 101 may be defined implicitly by potential functions or learned empirically via transition statistics. In the most general form, the metric d(p,q) between points p and q in manifold 101 may be expressed as the infimum of a path integral over all curves γ connecting the points, where the integrand Φ(γ(t), γ(t)) encodes the local cost structure. A current cognitive state 102 exists as a point x(t) within manifold 101, representing the system's instantaneous cognitive configuration at time t.

An attractor identification module 110 operates on manifold 101 to discover and characterize stable cognitive regimes. Module 110 implements an attractor identification operator Δ:M →2\hat{ }M that maps the manifold to a set of detected attractors {A₁, A₂, . . . , Aₙ}. The attractor identification module 110 employs multiple complementary strategies for detecting these stable structures. A fixed-point detector 111 identifies attractors as solutions to the equation Fₜ(x*)=x* for all t ≥0, where F₁ represents the system's state evolution operator, with stability confirmed by analyzing the spectral properties of the derivative DFₜ(x*). A recurrent-set identifier 112 detects attractors through recurrence metrics, computing a recurrence score R(x) that measures the frequency with which trajectories return to neighborhoods of x over long time horizons. Points with high recurrence scores, and clusters thereof, are identified as proto-attractors that define stable cognitive regimes. A potential-minimum detector 113 operates when the system dynamics can be expressed through a potential function V:M →R≥0, identifying attractors as sets of local minima where ∇V(x)=0 and the Hessian ∇²V(x) is positive definite. A topological detector 114 employs density-based methods, Morse-Smale decompositions, clustering of trajectory endpoints, or local flow convergence analysis to identify attractor structures that may not be apparent through other detection mechanisms.

Working in conjunction with attractor identification module 110, a basin geometry module 120 determines the regions of influence associated with each identified attractor. For an attractor A, module 120 defines the basin B(A) as the set of all points x∈M such that the limit of the system trajectory starting from x converges to A as time approaches infinity. The basin boundary OB(A) is computed as the topological closure of B(A) minus its interior. Basin geometry module 120 incorporates a saddle-point detector 121 that identifies basin boundaries as unstable manifolds of saddle points satisfying Fₜ(xₛ)=xₛ with eigenvalues of DFₜ(xₛ) having mixed signs. Additionally, a Lyapunov gradient partitioner 122 constructs basin boundaries by identifying level sets where Lyapunov functions associated with different attractors intersect, providing a complementary mechanism for basin delineation when explicit saddle points are difficult to locate.

Central to the operation of system 100 is an attractor-proximity scoring engine 130 that quantifies the relationship between the current cognitive state 102 and each identified attractor. Scoring engine 130 implements a formal operator Π:M×A(M) →R^{k} that maps a point in the manifold and the set of attractors to a vector of proximity scores. The engine 130 incorporates multiple scoring mechanisms to capture different aspects of attractor influence. A norm-based proximity calculator 131 computes scores as Π_{A}(x)=(1+∥x −x*A∥g)⁻¹, where the norm is induced by the manifold's metric tensor g. A flow-based proximity calculator 132 evaluates the instantaneous convergence rate toward each attractor, computing Π_A(x) as the negative time derivative of the distance d(Fₜ(x), A) evaluated at t=0. This flow-based score captures the dynamic tendency of the current state to move toward or away from each attractor. A potential-based proximity calculator 133 leverages attractor-specific potential functions V_{A} to compute scores as Π_{A}(x)=exp(−λV_{A}(x)), where λ is a scaling parameter. A multi-attractor compositor 134 normalizes the individual proximity scores into a probability-like distribution over attractors, ensuring that the total influence across all attractors remains bounded and interpretable.

A flow prediction module 140 generates predictions of future cognitive states based on the current position within the manifold and the computed attractor proximities. Module 140 treats cognitive evolution as a flow f. M→TM that maps points in the manifold to directions in the tangent bundle. The flow prediction module 140 can be configured to implement multiple prediction strategies to accommodate different types of cognitive dynamics. A local linear flow predictor 141 computes future states through the first-order approximation \hat{x}(t+Δt)=x(t)+f(x(t))Δt, suitable for short-time predictions or regions of approximately linear dynamics. A geodesic extrapolator 142 employs the exponential map of the manifold to compute \hat{x}(t+Δt)=expₓ(t)(Δt·f(x(t))), respecting the manifold's intrinsic geometry and providing more accurate predictions for longer time horizons or highly curved regions. A probabilistic flow predictor 143 models cognitive evolution through a transition kernel K(x(t), y), expressing the probability P[x(t+Δt)=y] of transitioning to state y, accommodating stochastic or uncertain cognitive dynamics.

In some embodiments, flow prediction module 140 may be configured as or referred to as an ensemble predictor which utilizes a plurality of distinct predictive mechanisms that each contribute to a unified forecast. In such configurations, module 140 can use a defined (or in some aspects dynamic) set of prediction operators {P₁, P₂, . . . , Pₘ} with weights determined by attractor proximity, manifold curvature, local data density, uncertainty measures, or any adaptive criterion.

The predictions from flow prediction module 140 may be modulated by an attractor-weighted flow compositor 150 configured for combining individual attractor influences. Compositor 150 computes a composite flow operator \hat{f}(x)=Σ_{A} Π_{A}(x) f_{A}(x), where Π_{A}(x) are the attractor proximity scores and f_{A}(x) are attractor-specific flow components 151. Each flow component f_{A} may be realized as a gradient flow −∇V_{A}(x), a learned regression flow, a symbolic update rule, or any other direction field associated with attractor A. This weighted composition ensures that the predicted cognitive evolution reflects the combined influence of all nearby attractors, with stronger influence from attractors to which the current state is more proximal according to the scoring metrics.

A dynamic geometry module 160 enables the manifold structure itself to evolve in response to cognitive experience and environmental changes. Module 160 implements several adaptation mechanisms that modify the geometric substrate on which cognition occurs. A metric evolution component 161 updates the metric tensor according to ∂gᵢⱼ/∂t=Sᵢⱼ(x,t), where Sᵢⱼ may encode curvature responses to frequently traversed paths, changes in transition density, attractor migration patterns, or computational resource allocation. An attractor migration component 162 allows attractors to shift position within the manifold through parameter updates θ_{A}(t+Δt)=θ_{A}(t)+η_{A}(x,t), where η_{A} represents the migration velocity influenced by factors such as prediction errors, stability margins, or external guidance signals. A flow field adapter 163 modifies the base flow fields according to f(x,t+Δt)=f(x,t)+Δf(x,t), where the adjustment Δf depends on observed discrepancies between predicted and actual trajectories, enabling the system to refine its dynamics based on experience.

To support cognitive architectures operating across multiple representational spaces, system 100 includes a multi-manifold operations module 170. This module enables cognition to occur simultaneously across multiple manifolds M₁, M₂, . . . , Mₖ, each potentially representing different aspects or levels of cognitive processing. A cross-manifold projector 171 implements mappings Π_{i→j}:Mᵢ→Mⱼ that transfer information between manifolds, preserving relevant structure while adapting to the target manifold's geometry. A manifold-specific attractor manager 172 maintains separate attractor sets Aᵢ for each manifold Mᵢ, allowing different representational spaces to have their own stable regimes while coordinating through the projection operators. A cross-manifold flow coordinator 173 enables flow in one manifold to influence dynamics in others through relations such as fⱼ(xⱼ)=Π_{i→j}(fᵢ(xᵢ)), creating a coupled multi-scale cognitive architecture.

The output of system 100 is a predicted future cognitive state 103 computed through the integration of the various component influences. This predicted state \hat{x}(t+Δt) incorporates the current position within the manifold, the proximity-weighted influences of all detected attractors, the geometric properties of the manifold itself, and any cross-manifold couplings. The prediction may be deterministic, representing the most likely future state, or probabilistic, encoding a distribution over possible future states. As the system evolves, the predicted state 103 becomes the new current state 102 in subsequent iterations, creating a continuous cognitive trajectory through the manifold that is guided by, but not rigidly determined by, the attractor landscape.

In some embodiments, the cognitive state space or cognitive manifold is generated or instantiated by an underlying computational substrate. The substrate may comprise a persistent cognitive machine (PCM) that maintains and updates internal cognitive state representations over time, a neural network or other machine-learned model that produces latent representations from input data, or another processing system configured to generate structured state representations. In certain embodiments, the cognitive manifold corresponds to a latent space of a transformer model, a recurrent neural network, a diffusion model, a graph neural network, or a mixture of such models. In other embodiments, the cognitive state space is derived from symbolic state configurations, hybrid symbolic-subsymbolic systems, or dynamical systems implemented in software, hardware, or analog circuitry. The definitions and constructions described herein apply irrespective of the particular substrate used to generate or maintain the cognitive state space.

In various embodiments of system 100, the integration of attractor identification, proximity scoring, and manifold flow prediction components creates a unified prediction pipeline that extends beyond single-step state evolution to encompass multi-step trajectory forecasting, ensemble predictions, and sophisticated reasoning capabilities. The prediction pipeline architecture implements a parameterized map P:M →M that may be decomposed as P(x)=\hat{F}(x)=Σ_{A∈A(M)} Π_{A}(x) F_{A}(x), where F_{A} are attractor-aligned evolution operators. This decomposition represents the core computational principle of system 100: prediction equals the nonlinear combination of attractor-conditioned flows, fundamentally distinguishing it from statistical or connectionist approaches that rely on pattern matching or activation propagation.

Flow prediction module 140 extends its capabilities to support multi-step trajectory prediction through a k-step predictor 144 that computes \hat{x}ₜ₊ₖ=P^{k}(xₜ), where P^{k} represents the k-fold composition of the prediction operator P. The multi-step predictor 144 implements several complementary approaches to long-horizon forecasting. In recursive prediction mode, the system computes \hat{x}ₜ₊ₖ=P(\hat{x}ₜ₊ₖ₋₁, iteratively applying the single-step predictor to generate extended trajectories. For systems where the attractor-conditioned flows f_{A} can be modeled as vector fields, the predictor employs closed-form flow integration, approximating \hat{x}ₜ₊ₖ through the integral of f(\hat{x}(s)) over the interval [0, kΔt]. When cognitive dynamics exhibit stochastic behavior, the probabilistic multi-step transition computes pₜ₊ₖ(y) as the integral over the manifold of pₜ(x) multiplied by the k-step transition kernel P\hat{ }{(k)}(x, dy), providing a full probability distribution over future cognitive states rather than point predictions.

The flow prediction module 140 further incorporates an ensemble flow predictor 145 that combines multiple distinct predictive mechanisms to produce robust and adaptive forecasts. The ensemble predictor defines a family of prediction operators {P₁, P₂, . . . , Pₘ} and computes the integrated prediction as \hat{F}(x)=Σᵢ₌₁wᵢ(x)Pᵢ(x), where the weights wᵢ(x) are determined dynamically based on factors including, but not limited to, attractor proximity scores, local manifold curvature, data density in the neighborhood of x, uncertainty measures, or other adaptive criteria. This ensemble approach ensures that system 100 can leverage different predictive strategies in different regions of the manifold, automatically selecting or blending approaches based on local geometric and dynamical properties.

The attractor-weighted flow compositor 150 implements sophisticated operator-level composition of attractor mechanisms through an operator composition framework 152. This framework expresses the complete prediction process as O(x)=(W∘V∘A)(x), where A performs attractor identification, V computes vector fields or potential structures based on the identified attractors, and W computes the weighted evolution incorporating proximity scores. The compositor supports highly general operator families, such as F_A(x)=Ω(v_{A}(x),Π_{A}(x)) or P(x)=Wₓ({F_{A}(x)}_{A∈A}), where Wₓ is a state-dependent weighting operator. This operator-theoretic formulation ensures that system 100 encompasses any future architecture that combines attractors and flow predictions through mathematical composition, regardless of the specific computational substrate or implementation details.

A residual dynamics compensator 153 within the attractor-weighted flow compositor 150 accounts for dynamics not fully captured by the identified attractors. The system decomposes the total flow as F(x)=Σ_{A}Π_{A}(x)F_{A}(x)+R(x), where R(x) represents residual flow components arising from external influences, exploration dynamics, noise, symbolic inference overrides, or task-specific adjustment factors. The inclusion of residual dynamics ensures that system 100 remains applicable even when attractor-based predictions must be modified by additional factors, maintaining the generality of the geometric cognition framework while accommodating real-world complexities.

The flow prediction module 140 incorporates a hybrid prediction engine 146 that seamlessly integrates deterministic and stochastic elements. The hybrid engine models cognitive evolution through the stochastic differential equation dxₜ=f(xₜ)dt+Σ(xₜ)dWₜ+Σ_{A}Π_{A}(xₜ)ξ_{A}(t), where f(x) represents deterministic drift, Σ(xₜ)dWₜ captures stochastic diffusion, and ξ_{A}(t) are attractor-specific stochastic or symbolic influences. This formulation enables system 100 to handle cognitive processes that combine predictable attractor-driven dynamics with unpredictable exploratory behavior or external perturbations.

An adaptive weighting module 154 within the attractor-weighted flow compositor 150 implements dynamic, context-dependent proximity scoring. Rather than using static proximity measures, the module computes Π_{A}(x,t)=h_{A}(d(x,A), κ_{A}(x), λ_{A}(x,t), θ(t), . . . ), where κ_{A}(x) is a convergence-rate metric measuring how quickly trajectories approach attractor A, λ_{A}(x,t) is a time-varying stability index reflecting the current reliability of the attractor, and θ(t) represents external context or task-state variables that may modulate attractor influence. This adaptive weighting ensures that attractor proximity reflects not only geometric distance but also dynamic factors such as attractor stability, recent trajectory history, and task-relevant context.

The prediction pipeline implements comprehensive feedback and recurrent structures through a feedback controller 147 within flow prediction module 140. The feedback controller supports both internal self-correction mechanisms and external feedback integration. In recurrent cognitive flow mode, the system iteratively applies xₜ₊₁=P(xₜ), xₜ₊₂=P(xₜ₊₁), creating extended trajectories through repeated application of the prediction operator. The feedback-conditioned predictor P_{fb}(xₜ)=P(xₜ)+Γ(xₜ, P(xₜ)) incorporates a correction operator F that adjusts predictions based on discrepancies between predicted and observed trajectories. Feedback may occur internally through self-monitoring of prediction accuracy, across manifolds through cross-space error propagation, through task-specific performance metrics, or via external signals from the environment or other systems.

System 100 incorporates a control-theoretic interpretation layer 155 that frames attractor-conditioned prediction as a closed-loop control system. In this interpretation, cognitive evolution follows xₜ₊₁=F(xₜ, uₜ), where the control input uₜ=Σ_{A} Π_{A}(xₜ) u_{A}(xₜ) represents the weighted combination of attractor-specific control policies u_{A}. This control-theoretic view enables system 100 to encompass applications in robotics, autonomous systems, and decision-making architectures that use geometric principles to guide behavior, even when not explicitly framed as cognitive systems.

The multi-manifold operations module 170 extends the prediction pipeline concept across multiple interacting manifolds through a distributed prediction coordinator 174. When cognitive processing occurs across manifolds M₁, M₂, . . . , Mₖ, the coordinator implements x^{j}ₜ₊₁=Pⱼ(xⱼ)t, {Π{i→j}(xⁱt)}{i≠j}), where each manifold's prediction incorporates projected information from other manifolds. This distributed architecture supports federated cognitive systems, multi-agent reasoning, and hierarchical cognitive architectures where different manifolds represent different levels of abstraction or domains of expertise.

A trajectory sampling engine 148 within flow prediction module 140 enables system 100 to generate and evaluate multiple possible cognitive trajectories rather than single deterministic paths. The engine implements Monte Carlo trajectory sampling. This sampling capability supports uncertainty quantification, robust decision-making under cognitive uncertainty, and exploration of alternative reasoning paths in complex cognitive landscapes.

The complete prediction pipeline of system 100 operates through a high-level dataflow that begins with state embedding into the manifold, proceeds through attractor identification and proximity scoring, generates flow predictions modulated by attractor influences, optionally updates geometric structures based on experience, and produces predicted future states that may themselves become inputs for subsequent prediction cycles. This dataflow may include feedback arcs where geometry updates influence subsequent attractor detection, branching paths for parallel prediction strategies, merging operations for ensemble predictions, or bypassed stages when certain computations can be cached or are temporarily unnecessary. The flexibility of this dataflow architecture ensures that system 100 can adapt its computational strategy to the specific requirements of different cognitive tasks while maintaining the fundamental principle of attractor-modulated geometric cognition.

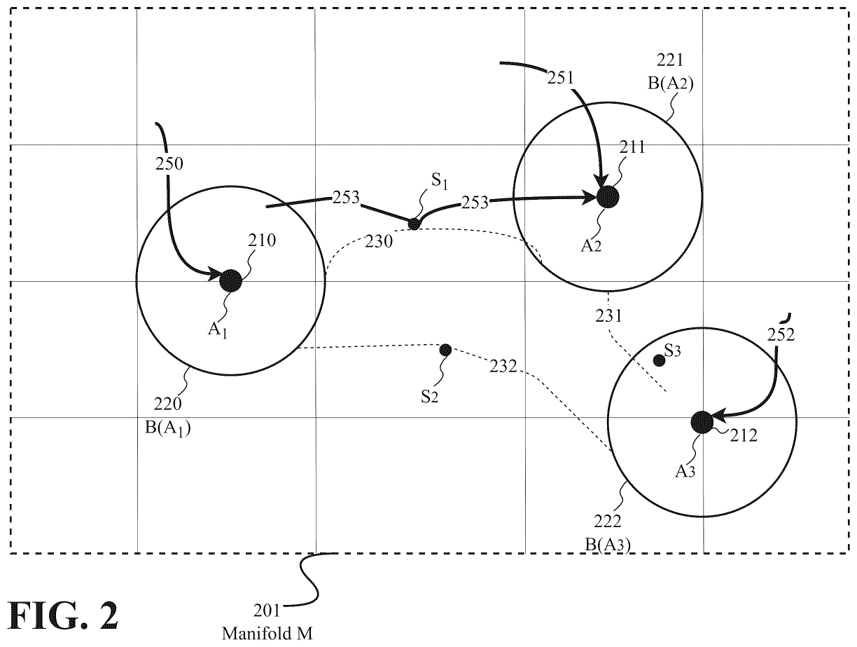

FIG. 2 is a diagram illustrating the mathematical structure of a cognitive manifold with multiple attractors, their associated basins of attraction, and representative cognitive trajectories.

The diagram 200 depicts the fundamental geometric constructs that govern cognitive state evolution within the attractor-based manifold flow prediction system. The cognitive manifold M 201 is represented as a bounded two-dimensional region delineated by a dashed curve, illustrating a continuous geometric space endowed with metric structure. While shown in two dimensions for visual clarity, manifold 201 may in practice possess arbitrary dimensionality and topology. The manifold boundary shown is illustrative only, as the actual cognitive manifold may be unbounded, multiply-connected, or possess more complex topological features. A grid pattern 202 overlaid on the manifold with reduced opacity represents the underlying metric tensor gᵢⱼ, which determines distances and angles within the cognitive space. This metric structure may be Riemannian, pseudo-Riemannian, or follow more general geometric frameworks as specified by the distance functional d(p,q)=inf∫Φ(γ(t), γ(t)) dt, where the infimum is taken over all curves γ connecting points p and q.

Three attractors are depicted within the manifold: attractor A₁ 210, attractor A₂ 211, and attractor A₃ 212. Each attractor represents a stable fixed point of the cognitive dynamics, satisfying the condition Fₜ(A)=A for all t ≥0, where Fₜ is the system's evolution operator. The attractors 210, 211, and 212 serve as organizing centers for cognitive dynamics, drawing nearby states toward themselves through the geometry of the manifold and the structure of the flow field.

Surrounding each attractor is its basin of attraction. Basin B(A₁) 220 is depicted as a blue elliptical region centered on attractor 210 with a radial gradient indicating the strength of attraction, which increases toward the attractor center. Similarly, basin B(A₂) 221 appears as a green elliptical region around attractor 211, and basin B(A₃) 222 as a red elliptical region around attractor 212. Each basin B(A) is formally defined as the set {x∈M: lim_{t-∞}Fₜ(x)=A}, comprising all points in the manifold whose forward evolution under the system dynamics converges to the corresponding attractor. The gradient shading within each basin provides a visual representation of the attractor's influence strength, analogous to a potential field where darker shading indicates stronger attractive force.

The boundaries between basins are marked by dashed curves. Basin boundary ∂B(A₁,A₂) 230 separates basins 220 and 221, while additional boundaries 231 and 232 delineate the interfaces between other basin pairs. These boundaries are mathematically defined as ∂B(A)=\tilde{B}(A)\int(B(A)), where \tilde{B}(A) denotes the closure of the basin and int(B(A)) its interior. The basin boundaries represent regions of maximum uncertainty in the system's long-term behavior, where infinitesimal perturbations can lead to convergence to different attractors.

Three saddle points are positioned along the basin boundaries: saddle point S₁ at the boundary between basins 220 and 221, saddle point S₂ at the intersection of multiple basin boundaries, and saddle point S₃ along the boundary between basins 221 and 222. These saddle points represent unstable fixed points of the dynamics where Fₜ(S)=S, but the linearized dynamics DFₜ(S) possess eigenvalues with mixed signs, indicating attraction along some directions and repulsion along others. The stable manifolds of these saddle points form the basin boundaries, while their unstable manifolds determine the directions along which trajectories diverge from the boundaries.

Four representative cognitive trajectories (drawn as thick, dark lines) illustrate different modes of state evolution within the manifold. Trajectory 250 demonstrates convergence to attractor A₁ 210 from an initial state outside the immediate vicinity of the attractor, following a curved path that respects the manifold's geometry. Trajectory 251 shows convergence to attractor A₂ 211, while trajectory 252 converges to attractor A₃ 212. These trajectories illustrate the fundamental property that states within a basin will evolve toward the corresponding attractor, with the specific paths determined by the interaction between the manifold's metric structure and the governing flow field.

A particularly significant trajectory 253 demonstrates basin boundary crossing. This trajectory originates in a region near basin B(A₁) 220 but passes near saddle point Si, where it is redirected by the flow dynamics to ultimately converge to attractor A₂ 211 in basin 221. This boundary-crossing behavior illustrates how cognitive states can transition between different stable regimes when they approach saddle points or other unstable structures in the manifold.

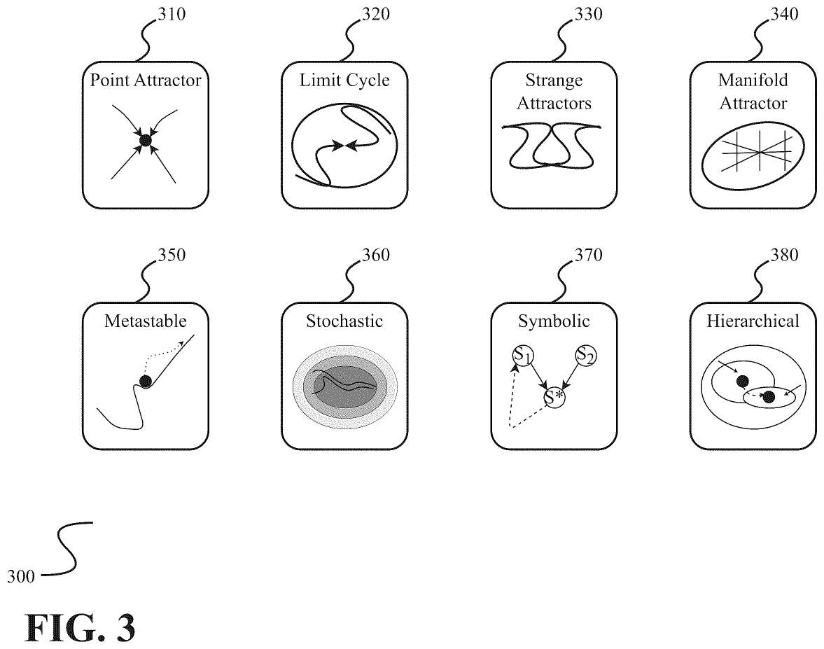

FIG. 3 is a diagram illustrating various exemplary types of attractors and configurations supported by the geometric cognitive system. The diagram 300 presents eight distinct attractor categories, each with its own characteristic dynamics, mathematical properties, and convergence behaviors, demonstrating the broad applicability of the attractor-based cognitive framework beyond simple fixed-point dynamics.

A point attractor representation 310 occupies the upper left region of the diagram, enclosed within a light blue bordered rectangle. The point attractor is depicted as satisfying the fixed-point condition F(x*)=x* where F represents the system's evolution operator. Four converging trajectories approach the point attractor from different directions, illustrated by curved paths with directional arrows, demonstrating the fundamental property that all trajectories within the basin of attraction converge to this single point. The mathematical characterization specifies that all eigenvalues λᵢ of the linearized dynamics around the fixed point satisfy λᵢ<0, ensuring asymptotic stability. Point attractors 310 represent the simplest form of stable cognitive states, where the system settles into a unique, unchanging configuration.

A limit cycle attractor 320 is shown in an adjacent panel. The primary feature is an elliptical closed curve representing a periodic orbit in the cognitive state space. Unlike the point attractor, trajectories spiral toward this closed curve rather than a single point, with one trajectory approaching from inside the cycle and another from outside, both converging to the periodic orbit. A directional arrow on the cycle indicates the direction of motion along the periodic trajectory. The mathematical notation specifies that the cycle has a period T >0 and satisfies F_{T}(x)=x for all points x on the cycle Γ, where Γ_{T} represents the time-T flow map. Limit cycle attractors enable the representation of periodic cognitive behaviors, oscillatory processes, or rhythmic patterns that maintain stable repetition over time.

The strange attractor panel 330 features a complex, butterfly-shaped structure reminiscent of the Lorenz attractor. The intertwining loops and figure-eight pattern illustrate the characteristic property of strange attractors: bounded yet non-repeating trajectories that exhibit sensitive dependence on initial conditions. A sample trajectory weaves through the attractor structure, never exactly repeating its path. The mathematical characterization notes that strange attractors possess fractal dimension and have at least one positive Lyapunov exponent (λₘₐₓ>0) while remaining bounded in state space. Strange attractors 330 enable the modeling of complex cognitive dynamics that are deterministic yet exhibit rich, apparently random behavior within bounded regions of the state space.

A manifold attractor 340 is illustrated as an extended two-dimensional surface rather than a point or curve. The attractor surface is depicted as a rotated elliptical region with a grid pattern overlaid to emphasize its extended nature and internal structure. Converging trajectories approach the manifold from above and below, demonstrating that states converge to the surface but may move freely within it once reached. The mathematical notation indicates that the attractor has dimension greater than or equal to one (dim(A)≥1) and forms a stable submanifold within the larger cognitive space. Manifold attractors represent cognitive states with internal degrees of freedom, where the system stabilizes to a family of related states rather than a unique configuration.

The metastable attractor representation 350 illustrates a qualitatively different type of stability. A potential well diagram shows a local minimum where the system can temporarily reside, but with a finite barrier that can be overcome. An escape trajectory depicted as a dashed curve shows how the system can transition out of this locally stable state given sufficient perturbation. Noise perturbations are small fluctuations near the local minimum, representing the stochastic forces that can eventually drive the system over the potential barrier. The mathematical characterization specifies a finite escape time σ_{escape}<∞, distinguishing metastable attractors from truly stable attractors. These structures model cognitive states that persist for extended but finite durations before transitioning to other regimes.

A stochastic attractor 360 is shown as a probability distribution rather than a deterministic structure. Concentric elliptical regions with varying opacity represent probability density contours, with darker shading indicating higher probability of finding the system in that region. Multiple sample paths weave through the probability cloud, illustrating the random yet statistically constrained nature of stochastic dynamics. The mathematical notation indicates that the probability distribution P(x,t) converges to an invariant measure π(x) as time approaches infinity. Stochastic attractors enable the representation of cognitive states characterized by persistent variability or uncertainty, where the system maintains statistical rather than deterministic stability.

The symbolic attractor panel 370 presents a discrete state representation fundamentally different from the continuous dynamics of other attractor types. Three discrete states are shown: two preliminary states S₁ and S₂ depicted as smaller brown circles, and a final attractor state S* shown as a larger, darker circle. Directed transitions connect the preliminary states to the attractor state, while a dashed feedback loop indicates the self-sustaining nature of the symbolic attractor. The mathematical characterization specifies that the attractor satisfies R(S*)=S*, where R represents a rule-based or logical update operator rather than a continuous dynamical flow. Symbolic attractors accommodate discrete cognitive processes, logical reasoning patterns, or rule-based systems within the geometric framework.

A hierarchical attractor configuration 380 illustrates multi-scale organization within cognitive dynamics. A large outer ellipse contains the entire hierarchical structure, within which two smaller elliptical regions represent sub-attractors, each containing their own point attractors. Trajectories show convergence at multiple scales: trajectories first converge to the outer region, then to one of the sub-regions, and finally to specific point attractors within those regions. A dashed transition between sub-attractors indicates possible movement between different organizational levels. The mathematical notation expresses this hierarchical containment as A⊃{A₁, A₂, . . . }, emphasizing the multi-scale nature of the structure. Hierarchical attractors enable modeling of cognitive processes with multiple levels of organization, from broad cognitive modes to specific detailed states.

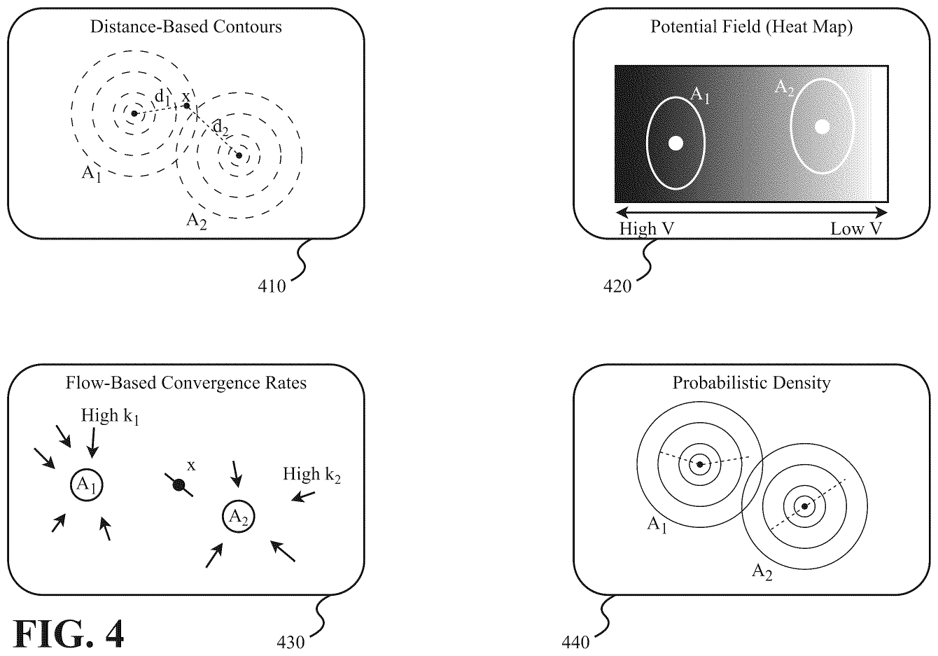

FIG. 4 is a diagram illustrating the various methods for computing and visualizing attractor-proximity scores within the geometric cognitive system. The diagram 400 presents four exemplary, but non-limiting distinct proximity scoring approaches, each capturing different aspects of the relationship between cognitive states and attractors, along with a unified multi-attractor composition framework demonstrating how individual scores combine into normalized distributions.

The distance-based contours panel 410 in the upper left demonstrates the most intuitive proximity scoring approach based on geometric distance within the manifold. Two attractors are depicted: attractor A₁ shown at coordinates (−50, 50) and attractor A₂ 412 shown at coordinates (50, 70). Surrounding each attractor are concentric circular contours rendered with decreasing opacity at increasing distances, creating a visual gradient that represents the decay of attractor influence with distance. The contours are shown as dashed circles at radii of 20, 40, and 60 units for attractor A₁, and at radii of 30 and 50 units for attractor λ₂, with the opacity and color intensity strongest near each attractor center. A sample point x is positioned at coordinates (0, 40), with dashed lines indicating the distances d₁ and d₂ to each attractor. A mathematical formula (e.g., π_A(x)=1/(1+d(x,A))) specifies how these distances transform into proximity scores, with the reciprocal relationship ensuring that proximity decreases smoothly as distance increases, approaching zero at large distances while equaling one when the state coincides with the attractor.

The potential field visualization panel 420 in the upper right presents proximity scoring through an energy landscape representation. A grid background establishes the spatial reference frame over which the potential field is visualized. The heat map may use color intensity to represent potential energy values, with a gradient transitioning from light (low potential) through yellow and orange to deep red (high potential). Within this field, two potential wells appear as elliptical regions: well centered at (−60, 70) surrounded by concentric white contours indicating the potential gradient, and well at (60, 50) with similar gradient indicators. The attractors A₁ and A₂ are positioned at the minima of these wells, shown as white points where the potential reaches its lowest values. A gradient scale bar at the bottom provides a color reference for interpreting potential values from low V to high V. The mathematical expression π_A(x)=e\hat{ }(−λV_A(x)) shows how potential values convert to proximity scores through an exponential transformation, where X is a temperature-like parameter controlling the sharpness of the proximity decay away from potential minima.

The flow-based convergence rates panel 430 in the lower left illustrates proximity scoring based on dynamical properties rather than static geometric or potential relationships. Two attractors A₁ and A₂ are shown as colored points within a vector field. Multiple flow vectors emanate from various positions in the space, with arrow direction indicating the flow direction and arrow length representing flow magnitude. Vectors near attractor A₁ are colored blue and point strongly toward it, while vectors near attractor A₂ are colored green with similar convergent behavior. In the intermediate region, smaller gray vectors indicate weaker flow with less clear directional preference. A sample point x is positioned in this neutral zone where competing influences balance. Annotations label regions of high convergence rate κ₁ near attractor A₁ and high κ₂ near attractor A₂, with low κ in the intermediate zone. A mathematical formulation defines the proximity score as π_A(x)=σ(x_A(x)), where κ_A(x)=−d/dt[d(F_t(x),A)]|_{t=0} represents the instantaneous rate of approach toward attractor A, and σ is a monotonic function such as the sigmoid that maps convergence rates to proximity scores.

The probabilistic density panel 440 in the lower right depicts proximity scoring through stochastic convergence probabilities. Two probability clouds are visualized: a cloud centered on attractor A₁ shown in blue with multiple concentric ellipses of increasing opacity toward the center, and cloud centered on attractor A₂ in pink with similar structure. The opacity gradients represent probability density contours, with darker regions indicating higher probability of finding the system in that state under stochastic dynamics. Sample stochastic trajectories shown as dashed curves illustrate possible paths the system might take, wandering within each probability cloud before converging to the attractor. The attractors A₁ and A₂ appear as solid colored points at the centers of their respective probability distributions. Probability labels P(→λ₁) and P(→A₂) indicate the overall probability of converging to each attractor from various starting positions. A mathematical expression such as π_{A}(x)=P[lim_{t-∞}Fₜ(x)∈A] formally defines the proximity score as the probability that the stochastic evolution starting from state x will eventually converge to attractor A.

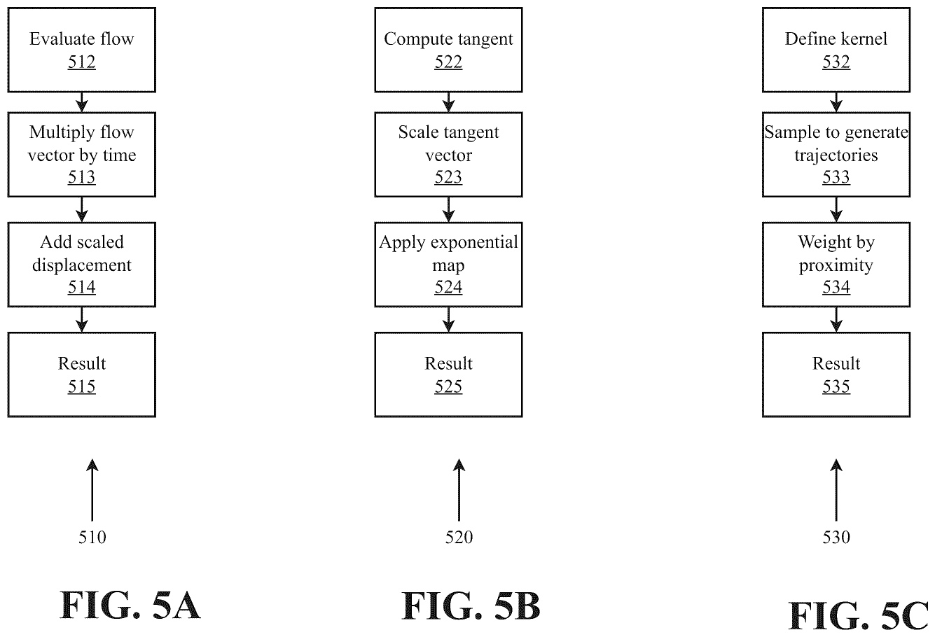

FIGS. 5A, 5B, and 5C illustrate three distinct flow prediction methods employed by the geometric cognitive system to forecast future cognitive states based on current positions within the manifold and attractor influences, according to an embodiment. The diagram presents local linear flow prediction, geodesic extrapolation, and probabilistic flow prediction as complementary approaches, each optimized for different manifold characteristics and prediction requirements.

Referring now to FIG. 5A, the local linear flow prediction method 510 represents the simplest and most computationally efficient approach to cognitive state forecasting. This method treats the manifold as locally flat in the neighborhood of the current state, enabling first-order approximation of the flow dynamics. The prediction formula \hat{x}(t+Δt)=x(t)+f(x(t))Δt expresses the future state as the current state plus a linear displacement determined by the flow vector f(x(t)) scaled by the time step Δt. The workflow for this method consists of three sequential operations. First, the flow evaluation step 512 computes the instantaneous flow vector f(x(t)) at the current cognitive state by combining attractor-weighted contributions. Second, the scaling step 513 multiplies this flow vector by the time increment Δt to determine the predicted displacement. Third, the addition step 514 adds this scaled displacement to the current state to produce the predicted future state 515 \hat{x}(t+Δt). This method achieves O(n) computational complexity where n is the manifold dimension, making it suitable for real-time applications requiring rapid prediction updates. The linear approximation remains accurate when the time step Δt is sufficiently small that nonlinear effects and manifold curvature can be neglected within the prediction horizon.

Referring now to FIG. 5B, the geodesic extrapolation method 520 accounts for the intrinsic geometry of the cognitive manifold by following geodesic curves rather than straight-line paths. This method recognizes that the shortest or most natural path between two points on a curved manifold may itself be curved, requiring predictions that respect the manifold's geometric structure. A prediction formula \hat{x}(t+Δt)=expₓ(Δt·f(x(t))) employs the exponential map, a fundamental geometric operation that maps tangent vectors to points on the manifold along geodesics. The workflow begins with a tangent vector computation step 522 that determines the initial direction v=f(x(t)) in the tangent space Tₓ M at the current state. The scaling step 523 multiplies this tangent vector by the time increment Δt to determine the geodesic distance to traverse. The exponential map application 524 then follows the geodesic emanating from x(t) in the direction v for a distance ∥Δt·v∥, arriving at the predicted state 525. This method requires O(n²) computational complexity due to the geometric calculations involved in geodesic computation, including potential numerical integration of the geodesic equations or computation of Christoffel symbols. The geodesic approach provides superior accuracy for longer prediction horizons or regions of significant manifold curvature where linear approximation would accumulate substantial errors.

Referring now to FIG. 5C, the probabilistic flow prediction method 530 addresses cognitive dynamics with inherent uncertainty, stochastic perturbations, or multiple possible evolution paths. Rather than producing a single deterministic prediction, this method generates a probability distribution over possible future states. A prediction formula P[x(t+Δt)=y]=K(x(t), y) expresses the probability of transitioning from the current state x(t) to any future state y through a transition kernel K. The workflow begins with a kernel definition step 532 that specifies the transition probability structure, which may incorporate diffusion processes, jump processes, or hybrid stochastic dynamics. The kernel typically takes the form K(x,y)=η(y) exp(−S(x,y)/σ²), where S(x,y) represents a cost or action functional and a controls the stochasticity level. The sampling step 533 generates multiple trajectory realizations by drawing samples from the conditional distribution K(x(t),⋅), producing an ensemble of possible future states. The proximity weighting step 534 modulates these samples or their probabilities according to attractor influences, potentially biasing the distribution toward regions of stronger attractor proximity. The result 535 is a probability distribution P(y|x) over the manifold rather than a single predicted point. This method requires O(n·k) computational complexity where k is the number of samples or discretization points used to represent the distribution. The probabilistic approach naturally handles multi-modal predictions where the system might evolve toward different attractors with varying probabilities.

Each prediction method incorporates attractor proximity scores as fundamental modulating factors. In the linear method, proximity scores directly weight the contributions of different attractor-aligned flow components. In the geodesic method, proximity scores may influence the computed tangent direction or modify the metric tensor used for geodesic calculation. In the probabilistic method, proximity scores shape the transition kernel, biasing probability mass toward regions of high attractor influence. This consistent integration of attractor proximity across all three methods ensures that predictions reflect the organizing influence of attractors regardless of the specific computational approach employed.

The methods exhibit complementary strengths suited to different prediction scenarios. The linear method excels in computational efficiency and is optimal for high-frequency prediction updates with small time steps, such as real-time cognitive tracking or rapid trajectory adjustments. The geodesic method provides superior accuracy for strategic planning, long-horizon forecasting, or navigation through strongly curved manifold regions where geometric effects dominate. The probabilistic method handles uncertainty quantification, risk assessment, multi-modal outcomes, and scenarios where deterministic prediction would be misleading due to inherent stochasticity or incomplete information.

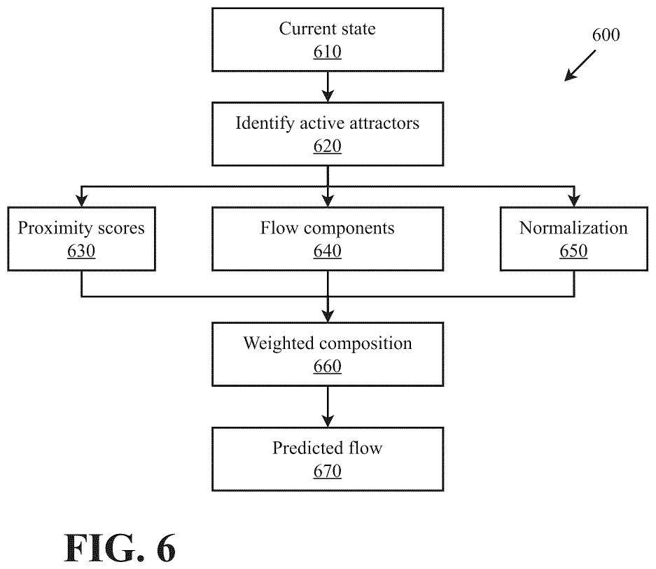

FIG. 6 is a flow diagram illustrating an exemplary attractor-weighted flow composition process that forms a mechanism for combining multiple attractor influences into a unified cognitive flow prediction, according to an embodiment. The method 600 presents a systematic workflow that transforms a current cognitive state through parallel proximity and flow computations into a composite flow vector that guides future state evolution.

According to the embodiment, the process begins with the current state input at step 610, denoted as x(t), representing a point within the cognitive manifold at time t. This state serves as the reference point from which all subsequent computations derive, containing the complete information about the system's current position within the geometric cognitive space. The current state 610 may be expressed in any coordinate system appropriate to the manifold representation, whether explicit coordinates, implicit representations, or abstract encodings.

The attractor identification stage 620 receives the current state and determines the set of active attractors {A₁, A₂, . . . , Aₙ} that may influence cognitive evolution from this position. This identification process invokes the attractor detection mechanisms described in the system architecture, potentially employing fixed-point detection, recurrent set identification, potential minimum analysis, or topological methods. The set of active attractors need not include all attractors in the manifold but rather those whose basins of attraction or regions of influence encompass or neighbor the current state. The identification stage 620 outputs a list of relevant attractors that will contribute to the flow computation.

Following attractor identification, the workflow branches into three parallel computational pathways that process different aspects of attractor influence. The proximity scoring pathway 630 computes individual proximity scores π_Aᵢ(x) for each identified attractor Aᵢ using the formula π_{A}(x)=Π(x, Aᵢ). The specific proximity function H may implement distance-based scoring using manifold metrics, potential-based scoring using attractor potential fields, flow-based scoring using convergence rates, or probabilistic scoring based on convergence likelihood. The proximity scoring module 630 generates a vector of scalar values (π_{A}_{₁}(x), π_{A}_{₂}(x), . . . , π_{A}_{ₐ}(x)) quantifying the relative influence of each attractor at the current state.

The flow components pathway 640 operates in parallel to compute directional flow vectors f_{A}_{₁}(x) associated with each attractor. For each attractor Aᵢ, this module determines the local flow direction that would guide the state toward or around that attractor. The flow components may be computed through various mechanisms: gradient flows f_{Ai}(x)=−∇V_{Ai}(x) derived from attractor potential functions, learned flow fields f_{A}_{ᵢ}(x)=N_{Ai}(x) produced by trained models, symbolic directions f_{Ai}(x)=Rule_{Ai}(x) determined by logical or procedural rules, or hybrid approaches combining multiple flow generation methods. The flow components module 640 outputs a collection of vectors in the tangent space TₓM, each representing the directional influence of one attractor.

The normalization pathway 650 computes the sum Z=Σᵢ π_{Ai}(x) of all proximity scores and optionally normalizes them to create a probability distribution \tilde{π}ᵢ=πᵢ/Z. This normalization step ensures that the total influence across all attractors remains bounded and can be interpreted as relative weights. The normalization step may be configured as optional because some implementations may use unnormalized weights, particularly when the proximity scores are already bounded or when absolute rather than relative influences are desired. The normalization module 650 outputs either the normalization constant Z or the normalized weight vector (\tilde{π}₁, \tilde{π}₂, . . . , \tilde{π}ₙ).

The three parallel pathways converge at the weighted composition stage 660, which implements the core mathematical operation \hat{f}(x)=Σᵢ π_{A}_{ᵢ}(x)·f_{A}_{ᵢ}(x). This formula represents the fundamental principle of attractor-weighted flow composition: each attractor's flow component f_{Ai}(x) is scaled by its proximity score π_Aᵢ(x) and all scaled components are summed to produce a composite flow vector \tilde{f}(x). The weighted composition 660 performs element-wise multiplication of each proximity score with its corresponding flow vector, followed by vector addition across all weighted components. The result is a single composite flow vector that incorporates the influences of all relevant attractors, with stronger influence from attractors with higher proximity scores.

The composite flow vector feeds into the predicted flow output stage 670, which prepares the final prediction \tilde{x}(t+Δt)=P(x, \hat{f}) where P represents the chosen prediction operator. The prediction operator P may implement linear extrapolation \hat{x}(t+Δt)=x(t)+\hat{f}(x)Δt for simple first-order prediction, geodesic extrapolation \hat{x}(t+Δt)=expₓ(Δt·\hat{f}(x)) for curved manifold navigation, or stochastic evolution \hat{x}(t+Δt) ~K(x, \hat{f}) for probabilistic prediction with kernel K. The output stage 670 provides flexibility in how the composite flow vector translates into concrete predictions, allowing the system to adapt to different manifold geometries and uncertainty levels.

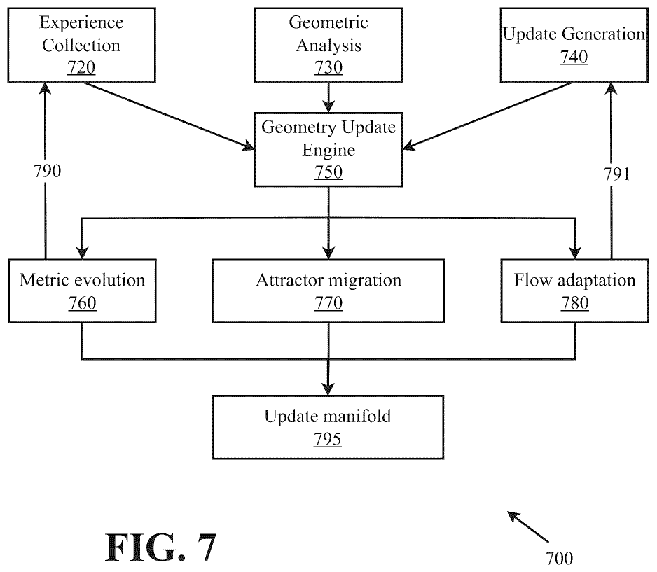

FIG. 7 is a method flow diagram illustrating the dynamic geometry evolution process through which the cognitive manifold continuously adapts its structure based on accumulated experience and computational requirements. The diagram 700 depicts an exemplary workflow that transforms manifold geometry over time, enabling the system to optimize its representational structure for improved cognitive performance.

Geometry evolution is a continuous process occurring throughout the system's operation, not a discrete optimization step. The gradient visualization reinforces that manifold adaptation happens smoothly over time rather than through abrupt reconfigurations.

The experience collection module 720 initiates the evolution process by gathering operational data from the cognitive system. This module aggregates three primary types of experiential information: cognitive trajectories 7(t) representing the paths taken through the manifold during reasoning or state evolution, state occupancy measures (x) quantifying how frequently different regions of the manifold are visited, and prediction errors P measuring discrepancies between predicted and actual state evolution. The experience collection process operates continuously, building a statistical profile of how the manifold is actually used during cognitive operations. This empirical data provides the foundation for informed geometry adaptation rather than relying on predetermined optimization criteria.

Operating in parallel, the geometric analysis module 730 examines the current manifold structure to identify patterns and characteristics that may benefit from adaptation. The analysis components may comprise flow statistics C(x)=E[f(γ(t))f(γ(t))^{T}|γ(t)=x] computing the covariance of flow directions at each manifold point, curvature pattern extraction identifying regions of high or anomalous curvature that may impede efficient navigation, and attractor stability metrics X quantifying the strength and reliability of existing attractors through eigenvalue analysis or Lyapunov exponents. The geometric analysis provides a structural assessment complementing the empirical usage data from experience collection.

The update generation module 740 processes insights from experience and analysis to formulate specific geometric modifications. The update components specify various categories of updates: metric updates ∂g/∂t defining how the manifold's distance structure should evolve, attractor parameter updates θ(t+Δt) determining new positions or characteristics for attractors, and flow field adaptations Δf(x,t) modifying the local dynamics at each point. These updates are generated through optimization procedures, learning algorithms, or analytical derivations based on identified improvement opportunities.

The three input streams converge at the geometry update engine 750, which serves as the central processing unit for manifold evolution. This engine implements the core update equations, including the metric evolution formula which represents the metric adjustment tensor, and the attractor adaptation function that modifies attractor configurations based on accumulated experience. The geometry update engine 750 orchestrates the application of all updates while maintaining mathematical consistency and stability constraints. It ensures that metric updates preserve positive definiteness, attractor modifications maintain basin integrity, and flow adaptations respect conservation principles or other system invariants.

The update engine outputs three parallel evolution pathways. The metric evolution pathway 760 implements changes to the manifold's metric tensor according to ∂gᵢⱼ/∂t. The specific forms of Sᵢⱼ may include curvature flow adaptations that smooth regions of extreme curvature, path density adjustments that expand metric distances in rarely visited regions to encourage exploration, or performance-driven modifications that optimize geodesic distances for frequent cognitive routes. The metric evolution directly affects how distances and angles are measured within the manifold, fundamentally altering its geometric properties.

The attractor migration pathway 770 updates attractor parameters according to θ_{A}(t+Δt)=θ_{A}(t)+η_{A} where η_{A} represents the migration velocity. This pathway encompasses both position shifts where attractors move to new locations within the manifold, and basin reshaping where the regions of attraction expand, contract, or deform based on usage patterns. Attractor migration may be driven by empirical centroids of converged states, stability optimization criteria, or task-specific requirements. The migration process must carefully manage transitions to avoid disrupting ongoing cognitive processes that rely on attractor locations.

The flow adaptation pathway 780 modifies local dynamics through f(x,t+Δt)=f(x,t)+Δf where Δf represents flow corrections. The adaptations include error correction terms that reduce systematic prediction errors, and pattern learning adjustments that encode frequently observed transitions into the flow field. Flow adaptation may employ gradient descent on prediction error, reinforcement learning from successful trajectories, or Hebbian-like strengthening of frequently used paths. This pathway ensures that the manifold's dynamics evolve to better match observed cognitive patterns.

Two feedback loops 790 and 791 create closed-loop adaptation systems. The experience feedback loop 790 channels information from the evolved metric back to experience collection, as changes in geometry affect which trajectories are taken and thus what new experience is gathered. The update feedback loop 791 connects flow adaptations to update generation, as modified dynamics influence what further updates are needed. These feedback mechanisms ensure that geometry evolution is self-regulating and responsive to its own effects.

The three evolution pathways reconverge to produce the updated manifold 795 denoted M(t+Δt), representing the complete evolved geometric and dynamical structure. This updated manifold incorporates all metric changes, attractor migrations, and flow adaptations in a coherent mathematical structure. The evolved manifold maintains the same topological properties as the original while exhibiting modified geometric characteristics better suited to the observed usage patterns and performance requirements.

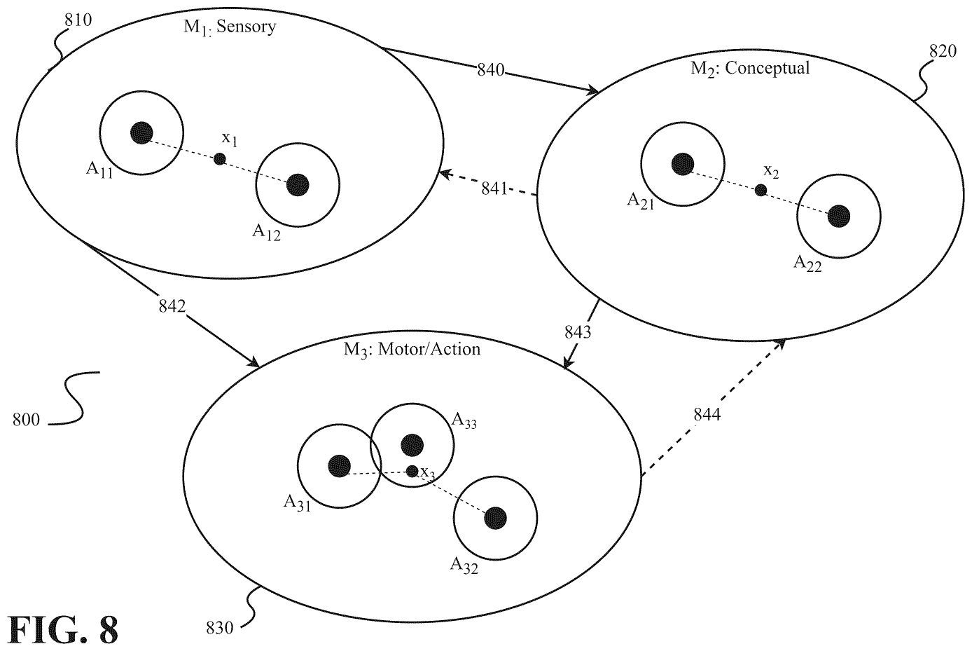

FIG. 8 is a diagram illustrating a multi-manifold cognitive architecture demonstrating how multiple specialized geometric spaces interact through cross-manifold projections to implement hierarchical cognitive processing. The diagram 800 presents three interconnected manifolds, each representing a different level or domain of cognitive processing, with bidirectional information flow enabling both bottom-up and top-down influences on cognitive dynamics.

The first manifold M₁ 810, labeled as the sensory manifold, occupies the upper left region of the diagram. Rendered as an elliptical region this manifold represents the geometric space in which sensory and perceptual information is processed. Within M₁, two attractors are depicted: attractor A₁₁ positioned at coordinates (−50, −20) with a surrounding basin of attraction shown as a light blue circular region of radius 25, and attractor A₁₂ at coordinates (40, 20) with a basin radius of 30. These attractors represent stable sensory processing states, such as recognized perceptual patterns or sensory categories. A dashed trajectory traces a path through the sensory manifold, illustrating how sensory states evolve over time under the influence of the attractor landscape. A current state point x₁ indicates the system's instantaneous position within the sensory space.

The second manifold M₂ 820, designated as the conceptual manifold, is positioned in the upper right region. This manifold represents abstract conceptual processing at a higher level of cognitive hierarchy. Two attractors populate this space: attractor A₂₁ at (−60, 10) with a basin radius of 35, representing one stable conceptual category, and attractor A₂₂ at (50, −10) with a basin radius of 28, representing another conceptual attractor. These might correspond to abstract concepts, categories, or high-level representations that emerge from sensory processing. A trajectory shows conceptual state evolution, while the current state x₂ at (−20, 0) marks the system's position in conceptual space.

The third manifold M₃ 830, identified as the motor/action manifold, is centered in the lower portion of the diagram. This manifold represents the space of motor commands, action plans, or behavioral outputs. Three attractors are present in this manifold: λ₃₁ at (−40, −10) with basin radius 30, λ₃₂ at (60, 20) with basin radius 25, and λ₃₃ at (0, −30) with basin radius 20. The presence of three attractors in the motor manifold, compared to two in each other manifold, suggests a richer repertoire of stable action patterns. The trajectory demonstrates how motor states evolve, potentially representing action sequences or motor program execution. The current state x₃ at (0, −20) indicates the system's instantaneous motor configuration.

Connecting these manifolds are several cross-manifold projection operators. The projection Π_{1→2} 840 is depicted as an arrow curving from M₁ to M₂, representing “perception →concept” to indicate the transformation of sensory information into conceptual representations.

This projection enables bottom-up processing where sensory patterns activate corresponding conceptual attractors. The reverse projection Π_{2→1} 841, shown as a dashed arrow, enables top-down influence where conceptual states modulate sensory processing, implementing phenomena such as attention, expectation, or conceptual priming of perception.

The projection Π_{1→3} 842 connects the sensory manifold directly to the motor manifold, representing “sensory →motor” to indicate sensorimotor coupling that bypasses conceptual processing. This projection enables reflexive or learned sensorimotor mappings where sensory states directly influence motor outputs. Similarly, Π_{2→3} 843 projects from conceptual to motor space, representing “concept →action,” implementing goal-directed behavior where abstract concepts guide motor planning. The reverse projection Π_{3→2} 844, shown as dashed, enables motor states to influence conceptual processing, potentially implementing embodied cognition where action possibilities shape conceptual understanding.

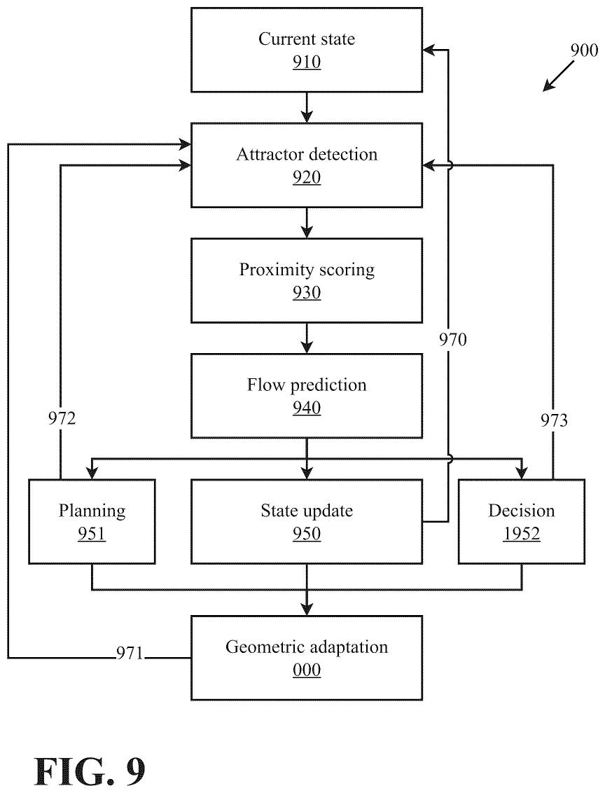

FIG. 9 is a method flow diagram illustrating an exemplary global reasoning loop that governs continuous cognitive processing within the geometric cognitive system, according to an embodiment. The diagram 900 presents a cyclic workflow that transforms cognitive states through multiple processing stages while incorporating feedback mechanisms for adaptation and multi-step reasoning capabilities.

According to an embodiment, the reasoning loop begins with the current state module 910 positioned at the top of the diagram. This module represents the system's instantaneous cognitive state x(t) within the manifold M, serving as the input to all subsequent processing stages. The current state encapsulates the complete information about the system's position in the geometric cognitive space at time t, providing the reference point from which all reasoning operations proceed. The state is rendered in a purple-bordered box to indicate its role as the primary input and eventual output of the cyclic process.

The attractor detection step 920 receives the current state and identifies the set of relevant attractors that may influence cognitive evolution. This step implements various detection strategies including fixed-point identification for static attractors and limit cycle detection for periodic attractors. The detection process produces a set of attractors A₁ through Aₙ that are active or relevant given the current state's position within the manifold. This stage determines which stable cognitive regimes should be considered in subsequent processing, effectively identifying the “cognitive landmarks” that will guide reasoning.

Following attractor detection, the proximity scoring step 930 calculates numerical proximity values for each identified attractor. This step computes proximity scores using multiple possible methods including distance-based metrics that decrease with separation from attractors, and potential-based scoring that reflects the depth of attractor basins. The output is a vector of proximity scores π_{A}(x) that quantify how strongly each attractor influences the current state. These scores serve as weights that modulate the contribution of different attractors to the predicted cognitive flow.

The flow prediction step 940 combines attractor influences to generate a composite flow direction. This step implements the weighted summation of individual attractor flows, where each attractor's contribution is scaled by its proximity score. The module indicates support for both linear prediction methods suitable for short-term forecasting and geodesic methods that account for manifold curvature. The output is a predicted flow vector that represents the expected direction of cognitive evolution given the current attractor landscape.

At this point, the reasoning flow branches into three parallel pathways. The central pathway leads to the state update step 950 which applies the prediction operator P to compute the next state. This module transforms the current state and predicted flow into a new state position, implementing the core state evolution that drives cognitive progression.

The left branch leads to the planning step 951 which enables multi-step reasoning beyond immediate state updates. This module constructs sequences of attractor transitions, represented as paths from A₁ to A₂ through to Aₖ, enabling the system to reason about extended cognitive trajectories. Planning operations may evaluate multiple possible paths through the attractor landscape to identify optimal reasoning sequences for achieving specific cognitive goals.

The right branch connects to the decision step 952 which implements action selection based on the current cognitive state. This module evaluates possible actions according to a cost function J(a) and selects the optimal action a*. The decision process leverages the attractor landscape to guide action selection, ensuring that chosen actions align with stable cognitive regimes and efficient state transitions.

The three branches reconverge at the geometry adaptation step 960. This module implements continuous improvement of the manifold structure based on accumulated experience. The adaptation process considers trajectory history to identify frequently traveled paths and adjust the geometry accordingly, and performance metrics to optimize the manifold for efficient cognitive processing. Geometry adaptation represents a meta-cognitive capability that allows the system to refine its representational substrate over time.

Multiple feedback paths create the cyclic nature of the reasoning process. The main loop feedback 970 connects the state update output back to the current state input, creating the primary reasoning cycle. This path curves around the right side of the diagram, emphasizing the continuous nature of cognitive processing where each computed state becomes the input for the next iteration.

The geometry update feedback 971 flows from the geometry adaptation module back to the attractor detection stage. This feedback path ensures that changes to the manifold structure are immediately reflected in how attractors are identified and characterized. As the geometry evolves, the location and nature of attractors may change, requiring updated detection processes.

The planning feedback 972 connects the planning module back to the attractor detection stage. This pathway enables multi-step plans to influence which attractors are considered relevant, implementing goal-directed attention where future objectives affect current processing.

The decision feedback 973 links action selection back to the detection process. This feedback allows chosen actions to modulate attractor detection, implementing action-oriented perception where behavioral intentions influence cognitive processing.

A plurality of measurable aspects of the reasoning process may be monitored and collected, including convergence rate that quantifies how quickly states approach attractors, and prediction accuracy that measures the fidelity of flow forecasts. These metrics provide objective measures for evaluating and optimizing the reasoning loop's effectiveness.

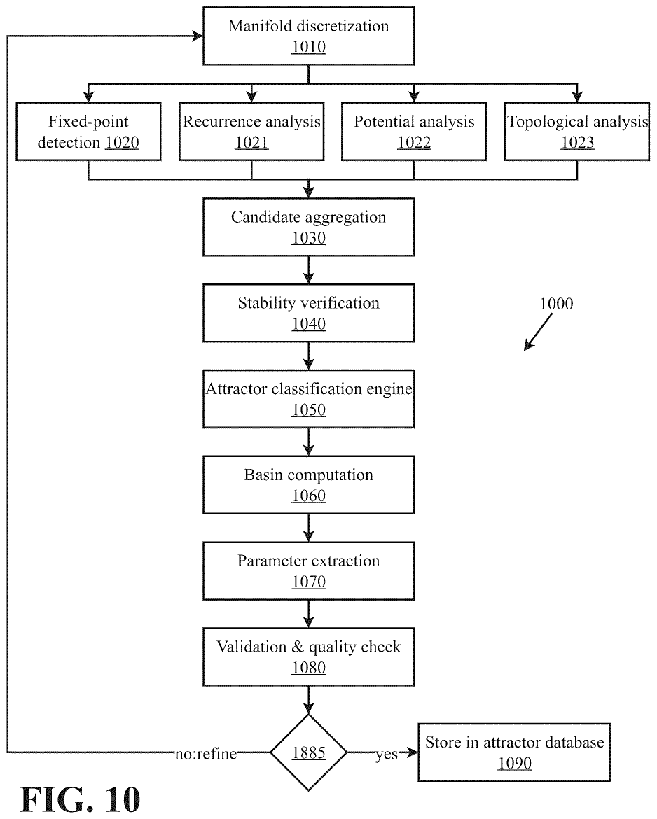

FIG. 10 is a flow diagram illustrating an exemplary method for attractor identification and classification 1000 that enables the geometric cognitive system to discover, characterize, and catalog stable structures within the cognitive manifold. The process 1000 presents a systematic workflow that transforms a continuous manifold representation into a discrete set of validated attractors with associated parameters, classifications, and basin structures suitable for use in proximity scoring and flow prediction operations.

According to the embodiment, the attractor identification process begins with the cognitive manifold M as input, representing the complete geometric state space in which cognitive dynamics occur. This manifold may be realized through any of the representations described herein, including but not limited to coordinate-based embeddings, graph structures, potential fields, or implicit transition kernels. The manifold serves as the substrate from which all attractor structures will be extracted through systematic analysis.

The manifold discretization module 1010 initiates the computational process by generating a finite sampling of the continuous manifold. This module produces a set of sample points {xᵢ, x₂, . . . , xₙ}∈M distributed throughout the manifold according to a specified grid resolution P. The discretization strategy may employ uniform grid sampling where points are arranged in regular lattices, adaptive sampling that concentrates points in regions of high curvature or dynamical activity, random or quasi-random sampling using methods such as Latin hypercube or Sobol sequences, or trajectory-based sampling that places points along observed or simulated cognitive paths. The grid resolution parameter F controls the trade-off between computational efficiency and detection sensitivity, with smaller values enabling detection of finer-scale attractors at increased computational cost.

Following discretization, the workflow branches into four parallel detection pathways 1020-1023, each implementing a complementary approach to attractor identification. This parallel architecture ensures comprehensive detection coverage, as different attractor types may be more readily identified through different analytical methods.

The fixed-point detection step 1020 searches for states x* that satisfy the fixed-point condition F(x*)=x*, where F represents the system's evolution operator. The module iterates through sampled points, evaluating the condition ∥F(x) −x∥<δ for a specified tolerance δ. When a potential fixed point is identified, the module computes the Jacobian matrix J=DF(x*) and verifies stability by confirming that all eigenvalues λᵢ satisfy Re(λᵢ)<0. Fixed points with positive eigenvalues are classified as unstable and may be retained for saddle point analysis but are excluded from the attractor set. The module may employ Newton-Raphson iteration, gradient descent, or other numerical methods to refine approximate fixed points to machine precision.

Operating in parallel, the recurrence analysis module 1021 identifies attractors through examination of trajectory return patterns. For each sample point, the module computes a recurrence score R(x) quantifying the frequency with which trajectories return to neighborhoods of x over extended time periods. The module constructs Poincare sections to detect periodic orbits, analyzing intersection patterns to determine periodicity. Period detection algorithms identify the minimal period T for which F\hat{ }T(x) ≈x within tolerance, distinguishing between fixed points (T=1), periodic orbits (T>1), and quasi-periodic or chaotic attractors (no finite T). The recurrence analysis is particularly effective for detecting limit cycles and strange attractors that may not be identified through fixed-point analysis alone.

The potential analysis step 1022 operates under the assumption that attractors correspond to local minima of an associated potential function V:M → [symbol] . The module evaluates the gradient condition ∇V(x)=0 to identify critical points, then applies the second-derivative test ∇²V(x) >0 to confirm that critical points are indeed minima rather than maxima or saddle points. The module computes well depths to quantify the stability and attraction strength of each potential minimum. In implementations where an explicit potential function is not available, the module may reconstruct an effective potential from observed dynamics using methods such as force integration, Helmholtz decomposition, or machine learning approaches.

The topological analysis step 1023 employs methods from computational topology to identify attractor structures that may not be apparent through local analysis. The module may implement Morse decomposition to partition the manifold into gradient-like regions associated with different attractors, compute homology groups to identify topological features such as cycles, voids, or higher-dimensional structures, and apply persistence analysis to distinguish between significant topological features and artifacts arising from discretization or noise. The topological approach is particularly valuable for identifying complex attractors such as strange attractors with fractal structure or higher-dimensional manifold attractors.

The four parallel detection pathways converge at the candidate aggregation step 1030, which consolidates the detection results into a unified candidate set C={c₁, c₂, . . . , cₖ}. The aggregation process includes duplicate removal, where candidates cᵢ and cⱼ satisfying d(cᵢ, cⱼ)<ε are merged into a single candidate, and consensus validation, where candidates detected by multiple methods receive higher confidence scores. The module may employ clustering algorithms to group related detections and identify extended attractor structures. The output is a refined set of candidate attractors ready for stability verification.

The stability verification step 1040 subjects each candidate attractor to rigorous dynamical analysis to confirm its stability properties. For each candidate c, the module computes the Jacobian matrix J=DF(c) encoding the linearized dynamics in the neighborhood of the candidate. Eigenvalue decomposition yields the spectrum {λ₁, λ₂, . . . , λₙ}, from which stability properties are determined. The module computes Lyapunov exponents through long-time integration to characterize divergence rates for different directions in phase space. Additional stability metrics may include basin volume estimates, escape rates for metastable attractors, and robustness measures quantifying sensitivity to parameter perturbations.

The attractor classification engine 1050 receives verified candidates and assigns each to one of the defined attractor categories based on its dynamical and geometric properties. The classification logic employs a hierarchical decision process. Point attractors are identified by zero dimensionality (dim(A)=0) and all negative eigenvalues (λᵢ<0 for all i). Limit cycles exhibit periodicity with finite period T >0 and form closed curves in the state space. Strange attractors display fractal dimensionality, at least one positive Lyapunov exponent (λₘₐₓ>0), and bounded trajectories that never exactly repeat. Manifold attractors have dimension greater than or equal to one (dim(A) ≥1) and represent extended stable subspaces. Metastable attractors are characterized by finite escape times (τ_{escape}<∞), indicating temporary rather than permanent stability. Stochastic attractors are identified through convergence of probability distributions P(x,t)→π(x) to invariant measures. Hierarchical attractors exhibit nested structure where A⊃{A₁, A₂, . . . }, containing multiple sub-attractors within a larger organizing structure.

Following classification, the basin computation step 1060 determines the region of influence B(A) for each attractor A. The basin is formally defined as B(A)={x∈M:lim_{t→∞}Fₜ(x)=A}, comprising all initial states whose trajectories converge to the attractor. The module may employ backward integration from the attractor to trace the stable manifold, Voronoi approximation to partition the manifold based on nearest attractors, Monte Carlo sampling to estimate basin boundaries through trajectory simulation, or level set methods to track the evolution of basin boundaries. The computed basins enable determination of relative attractor strengths and prediction of long-term system behavior from arbitrary initial conditions.

The parameter extraction step 1070 computes and records essential characteristics for each validated attractor. Extracted parameters include the attractor position x*_{A} ∈M, providing a representative point or centroid for extended attractors. Stability parameters comprising eigenvalues {λ₁, λ₂, . . . , λₙ} or Lyapunov exponents characterize local dynamics. The basin volume Vol(B(A)) quantifies the attractor's relative influence within the manifold. A characteristic scale r_{A} indicates the effective size or extent of the attractor structure. Additional parameters may include convergence rates, periodicity measures, fractal dimensions, or task-specific metrics relevant to the cognitive domain.

The validation and quality check step 1080 performs final verification before accepting attractors into the system database. Validation criteria include trajectory convergence testing, where sample trajectories are initialized near the attractor and verified to converge within expected tolerances. Statistical significance testing ensures p<0.05 or other specified confidence levels, confirming that detected structures are not artifacts of finite sampling or noise. Robustness analysis applies small perturbations to attractor parameters and confirms that stability properties are maintained. Cross-validation using held-out trajectory data verifies that attractors generalize beyond the specific samples used for detection.

A decision point 1085 directs the flow based on validation results. Candidates failing validation return to the discretization stage 1010 with refined parameters, enabling iterative improvement of detection accuracy. The feedback path may trigger increased sampling resolution near problematic candidates, adjusted detection thresholds, or alternative analytical methods for challenging cases.

Successfully validated attractors proceed to the attractor database storage module 1090, which maintains the comprehensive attractor catalog used throughout the cognitive system. The database schema stores tuples A={(type, x*, params, B(A))} containing the attractor classification type from the defined categories, the representative position x* within the manifold, the complete parameter set params including stability measures and characteristic scales, and the basin structure B(A) encoded as a geometric region or membership function. The module implements indexing structures for efficient spatial queries by position and categorical queries by attractor type. Upon storage, the module triggers updates to proximity scoring functions, ensuring that newly discovered attractors are immediately incorporated into the system's cognitive dynamics.

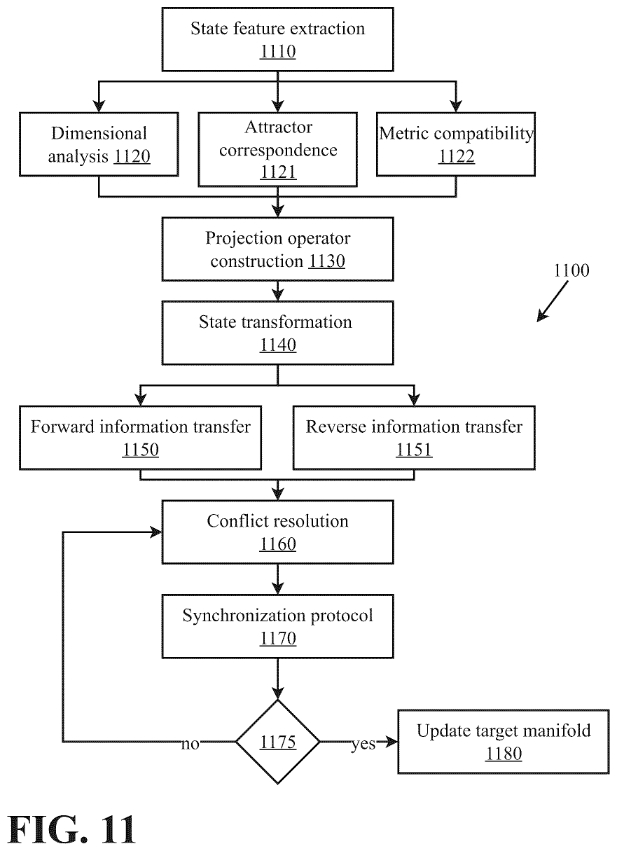

FIG. 11 is a method flow diagram illustrating a cross-manifold information transfer and synchronization process 1100 that enables cognitive processing across multiple geometric manifolds within a multi-manifold cognitive architecture. The process 1100 provides systematic mechanisms for transferring state information, attractor influences, and flow predictions between different manifolds while maintaining geometric consistency and cognitive coherence.

The process initiates with a source manifold Mᵢ containing a current cognitive state xᵢ(t) having dimension di. In multi-manifold cognitive architectures, the system may employ multiple manifolds to represent different levels of abstraction, different modalities, or different subsystems, each equipped with its own geometric and dynamical structure. For example, one manifold might represent sensory processing while another represents conceptual reasoning, or one might encode low-level motor control while another handles strategic planning.

The state feature extraction step 1110 extracts essential geometric and dynamical information from the source manifold state. This extraction process computes local coordinates that map the manifold point to a coordinate representation in di-dimensional space. The module extracts tangent vectors representing the current direction of cognitive flow at the state, capturing not just where the system is but where it is heading. Additionally, the module extracts the local metric tensor characterizing the geometric structure at the current state, which determines how distances and angles are measured in the local neighborhood. These extracted features provide the complete local geometric context necessary for accurate cross-manifold transfer.

Following feature extraction, the process branches into three parallel analysis pathways that examine different aspects of the manifold relationship.

The dimensional analysis step 1120 compares the dimensions dᵢ and dⱼ of the source and target manifolds to determine the appropriate transformation strategy. When the source dimension exceeds the target dimension, the module identifies that dimensionality reduction is required, necessitating projection onto a lower-dimensional subspace while preserving essential information. When the source dimension is less than the target dimension, the module recognizes that embedding into a higher-dimensional space is needed, potentially requiring the construction of additional coordinates or the use of manifold embedding techniques. When dimensions match, the module can employ direct mapping strategies that may still require geometric transformation but avoid dimensional mismatch issues. This analysis ensures that the subsequent projection operator construction accounts for dimensional relationships appropriately.

Operating in parallel, the attractor correspondence step 1121 establishes relationships between attractors in the source and target manifolds. Attractors in different manifolds may represent related cognitive phenomena at different levels of abstraction or in different representational formats. The module matches attractors based on geometric criteria such as relative position or basin overlap, dynamical criteria such as similar convergence rates or stability properties, or semantic criteria based on the cognitive role each attractor plays. For each matched pair, the module evaluates the attractor proximity at the current state and analyzes basin overlap to determine the strength of correspondence. This correspondence mapping ensures that attractor influences transfer appropriately between manifolds, maintaining the organizing structure of cognitive dynamics.

The metric compatibility check module 1122 analyzes the geometric relationship between the source and target manifold metrics. The module examines curvature mapping to determine how local curvature in the source manifold relates to curvature in the target manifold, which affects how cognitive trajectories will behave after transformation. The module evaluates distance preservation properties to assess whether the transformation maintains relative distances between states, important for preserving neighborhood relationships. Additionally, it checks angle preservation to determine if the mapping is conformal or requires metric distortion, which impacts how flow directions transform. This compatibility analysis informs the construction of projection operators that respect the geometric properties of both manifolds.

The three analysis streams converge at the projection operator construction step 1130, which builds the mathematical transformation between manifolds based on the combined analysis results. The module may implement various transformation approaches depending on the manifold characteristics and requirements. Linear projection approaches use matrix operations and techniques like singular value decomposition for dimensionality reduction when the manifolds have approximately linear structure in the relevant regions. For manifolds with complex nonlinear geometry, the module may employ neural encoder-decoder architectures that learn appropriate transformations from data, kernel methods that implicitly map through high-dimensional feature spaces, or manifold learning techniques that preserve local geometric structure. When preserving intrinsic geometric structure is critical, the module implements geometric mappings using differential geometric constructs such as exponential maps that follow geodesics or parallel transport that moves vectors along curves while preserving their essential properties. The constructed operator satisfies the requirements identified by the dimensional, attractor, and metric analyses while minimizing information loss.

The state transformation step 1140 applies the projection operator to transform the source state and associated geometric information. The primary transformation maps the source state to its representation in the target manifold, creating a corresponding point that preserves relevant cognitive information. The flow vector transformation uses the differential of the projection operator to map tangent vectors, ensuring that flow directions transfer appropriately and cognitive dynamics remain consistent. The module computes a reconstruction error by applying the reverse projection and measuring the deviation from the original state, providing a quantitative measure of information preservation that can be used for quality assessment and adaptive refinement.

The process then bifurcates into bidirectional information transfer pathways that enable both bottom-up and top-down communication between manifolds.

The forward information transfer step 1150 implements the primary state-to-state mapping from source to target manifold. Beyond simple state transfer, the module ensures that attractor proximity information transfers appropriately, so that if a state is near an attractor in the source manifold, its image in the target manifold reflects this relationship with corresponding attractors. Flow fields transfer such that predicted evolution in the source manifold maps to consistent predicted evolution in the target manifold, maintaining temporal coherence across representations. Future state predictions made in the source manifold map to corresponding predictions in the target manifold, ensuring that planning and anticipation remain consistent across levels of abstraction.

The reverse information transfer step 1151 enables feedback from the target manifold to influence the source manifold, implementing top-down processing essential for hierarchical cognition. State information flows backward through inverse or pseudo-inverse transformations, allowing higher-level representations to guide lower-level processing. Error signals detected in the target manifold, such as prediction mismatches or constraint violations, propagate back to adjust processing in the source manifold. Control inputs computed at higher levels of abstraction in the target manifold transform to actionable signals in the source manifold. Constraints identified in the target manifold, such as feasibility limits or goal conditions, map to corresponding constraints in the source space, ensuring that limitations are respected throughout the hierarchy.

The conflict resolution step 1160 addresses potential inconsistencies arising from bidirectional information flow. When forward and reverse transfers produce conflicting information, the module employs various strategies to achieve coherent resolution. Consensus strategies use weighted averaging of conflicting signals based on confidence measures, uncertainty estimates, or information quality metrics. Priority-based resolution leverages hierarchical relationships between manifolds, where certain levels may take precedence based on the cognitive task or system design. Context-dependent selection chooses between conflicting information based on current task requirements, environmental conditions, or cognitive goals. Temporal precedence gives priority to more recent information when resolving conflicts between past and current transfers, maintaining responsiveness to changing conditions.

The synchronization protocol module 1170 ensures that the manifolds maintain appropriate phase relationships and coherent dynamics. Phase locking requires that phase differences between corresponding oscillatory components in different manifolds remain below a threshold, preventing the manifolds from drifting out of alignment over time. Frequency matching ensures that dynamical timescales in different manifolds remain compatible, enabling stable information exchange without temporal aliasing or loss of synchronization. The module computes an overall coherence measure that quantifies the quality of synchronization, combining phase, frequency, and amplitude relationships into a single metric that guides the synchronization process.

A decision point 1175 evaluates whether synchronization criteria are met. The decision considers whether phase differences are within acceptable bounds, frequency mismatches are sufficiently small, and the overall coherence measure exceeds the required threshold. If synchronization has not been achieved, the process returns to conflict resolution 1160 for iterative refinement of the transformation and synchronization parameters. This feedback loop may adjust projection operators, modify weighting schemes, or alter synchronization parameters until acceptable alignment is achieved.

Upon successful synchronization, the update target manifold module 1180 finalizes the information transfer by updating the target manifold state. The updated state incorporates the transferred information while maintaining consistency with the target manifold's geometric structure. The flow field in the target manifold reflects the influence of information from the source manifold, potentially altering predicted cognitive trajectories. The module caches the projection operators for both forward and reverse transformations, enabling efficient reuse in subsequent transfers when the manifold relationship remains stable. This caching significantly reduces computational overhead for systems with frequent cross-manifold communication.

The complete cross-manifold information transfer and synchronization process 1100 enables sophisticated multi-scale cognitive architectures where different representational spaces cooperate to implement complex reasoning, perception-to-action pathways, and hierarchical cognitive processing. By maintaining geometric consistency while allowing flexible information flow, the process supports rich cognitive behaviors while respecting the mathematical foundations of each individual manifold. The process accommodates various types of cognitive hierarchies, including sensory-to-conceptual processing where low-level perceptual features map to high-level concepts, conceptual-to-motor pathways where abstract goals translate to concrete actions, and multi-resolution representations where the same cognitive content exists at different levels of detail.

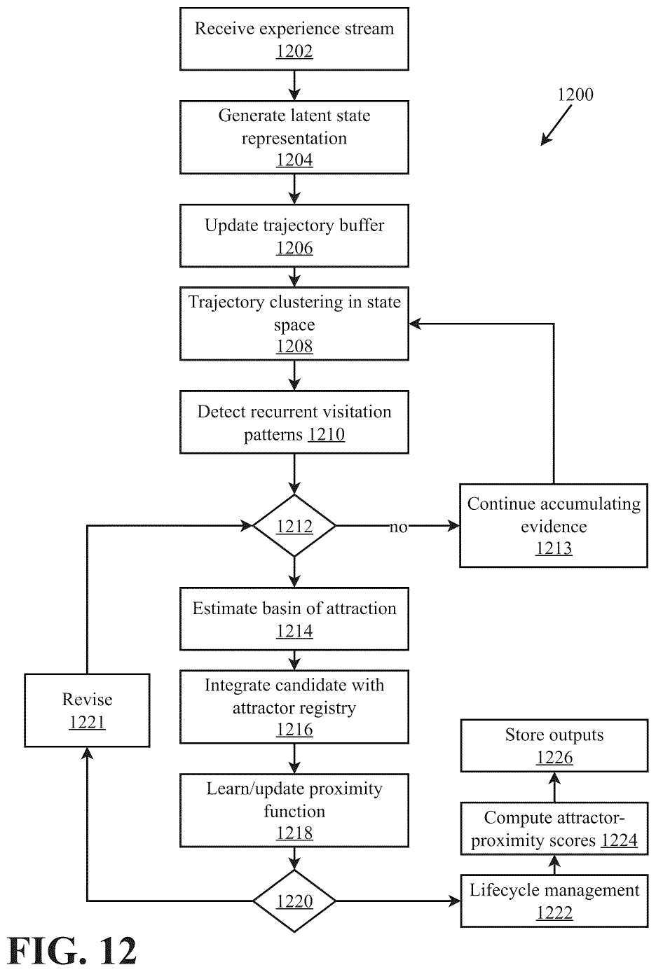

FIG. 12 illustrates an exemplary method 1200 for adaptive attractor discovery through experience flow using a learning-based process applied to operational data. In step 1202, one or more computing systems receive an experience stream comprising operational data, including time-ordered observations, events, or state updates generated during operation of one or more cognitive, machine learning, or other state-generating systems. In step 1204, the computing systems generate a latent state representation for at least a portion of the experience stream, wherein the latent state representation comprises, for example, an embedding, manifold coordinates, or another geometric state-space representation. In step 1206, the computing systems update a trajectory buffer to store a time-ordered sequence of latent states and, in some embodiments, associated metadata such as timestamps, context labels, uncertainty measures, or feature descriptors.

In step 1208, the computing systems perform trajectory clustering in the latent state representation to identify groups of trajectory segments that exhibit similarity in state-space position, directionality, and/or local flow behavior. In some embodiments, step 1208 comprises computing one or more clustering features from the trajectory buffer, including, for example, path-length-normalized distances, local velocity statistics, curvature-related measures, and/or metric-related measures derived from the latent state representation. In step 1210, the computing systems detect recurrent visitation patterns associated with one or more clustered trajectory groups, wherein recurrent visitation patterns comprise repeated approaches to, crossings of, or residence within a region of the latent state representation, optionally under varying contexts or over multiple time windows.

In step 1212, the computing systems perform statistical significance testing for one or more candidate attractors indicated by the recurrent visitation patterns. In some embodiments, statistical significance testing comprises computing one or more test statistics that compare observed recurrence, residence time, contraction, or stability measures against one or more baselines, null models, bootstrapped samples, or randomized trajectory surrogates, and accepting a candidate attractor when one or more significance criteria are satisfied. In step 1214, the computing systems estimate a basin of attraction for an accepted candidate attractor using empirical data, wherein basin estimation comprises inferring a boundary or region of influence based on observed inflow trajectories, convergence rates, transition likelihoods, and/or empirical capture probabilities computed from the trajectory buffer.

In step 1216, the computing systems integrate an accepted candidate attractor with an existing attractor set maintained by an attractor registry. In some embodiments, integrating comprises associating the candidate attractor with a unique identifier, storing attractor descriptors (including an attractor type, attractor center, stability statistics, and basin parameters), and determining whether the candidate attractor corresponds to an existing attractor. In some embodiments, step 1216 includes merging the candidate attractor with an existing attractor when a similarity criterion is satisfied, and otherwise creating a new attractor entry in the attractor registry. In step 1218, the computing systems learn and/or update a proximity function used to compute attractor-proximity scores, wherein the proximity function maps a latent state and/or trajectory segment to a proximity value relative to one or more attractors. In some embodiments, learning and/or updating the proximity function comprises optimizing parameters of a distance metric, kernel, learned scoring model, or decision function using empirical trajectory data and attractor labels derived from the attractor registry.

In decision point 1220, the computing systems validate one or more attractors and/or one or more proximity function updates against prediction accuracy. In some embodiments, step 1220 comprises generating one or more manifold-flow-based predictions, trajectory forecasts, or state-transition predictions using the latent state representation and the attractor registry, and evaluating prediction accuracy using one or more error metrics computed over held-out portions of the experience stream or over subsequent operational data. In some embodiments, when a candidate attractor or proximity function update does not improve, maintain, or satisfy a prediction accuracy criterion, the candidate attractor is rejected, revised, or down-weighted, and/or the proximity function update is rolled back or regularized.

In step 1222, the computing systems perform dynamic attractor lifecycle management for the attractor registry. In some embodiments, lifecycle management comprises creation of new attractors based on accepted candidates, merging of redundant attractors based on overlap in basins or similarity in descriptors, and deletion or deactivation of attractors based on one or more criteria including insufficient recurrence, loss of stability, reduced empirical support, drift-induced obsolescence, or degraded predictive contribution. In step 1224, the computing systems compute attractor-proximity scores for at least one latent state and/or at least one trajectory segment using the learned and/or updated proximity function and the dynamically managed attractor registry. In step 1226, the computing systems store one or more outputs including updated attractor registry data, basin parameters, proximity function parameters, and, in some embodiments, predictions derived from estimated manifold flow and attractor-proximity scoring.

In this manner, method 1200 demonstrates how the computing systems can discover emergent cognitive patterns not known a priori from operational experience flow, and can update attractor structure, proximity scoring, and prediction validation over time, thereby enhancing adaptive capabilities in embodiments in which geometry, flow, and related state-space properties evolve during operation.

### Exemplary Computing Environment

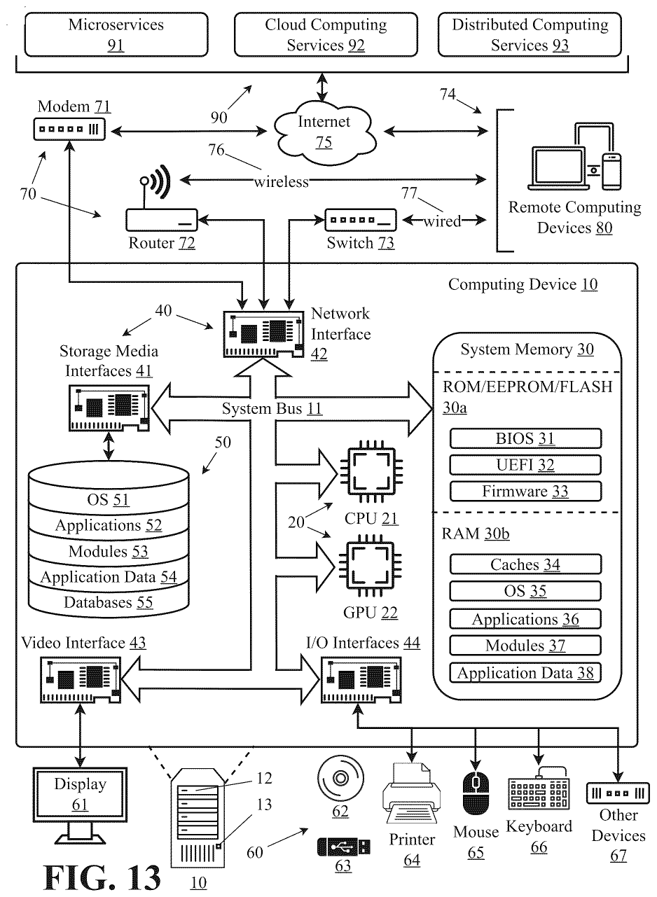

FIG. 13 illustrates an exemplary computing environment on which an embodiment described herein may be implemented, in full or in part. This exemplary computing environment describes computer-related components and processes supporting enabling disclosure of computer-implemented embodiments. Inclusion in this exemplary computing environment of well-known processes and computer components, if any, is not a suggestion or admission that any embodiment is no more than an aggregation of such processes or components. Rather, implementation of an embodiment using processes and components described in this exemplary computing environment will involve programming or configuration of such processes and components resulting in a machine specially programmed or configured for such implementation. The exemplary computing environment described herein is only one example of such an environment and other configurations of the components and processes are possible, including other relationships between and among components, and/or absence of some processes or components described. Further, the exemplary computing environment described herein is not intended to suggest any limitation as to the scope of use or functionality of any embodiment implemented, in whole or in part, on components or processes described herein.

The exemplary computing environment described herein comprises a computing device 10 (further comprising a system bus 11, one or more processors 20, a system memory 30, one or more interfaces 40, one or more non-volatile data storage devices 50), external peripherals and accessories 60, external communication devices 70, remote computing devices 80, and cloud-based services 90.

System bus 11 couples the various system components, coordinating operation of and data transmission between those various system components. System bus 11 represents one or more of any type or combination of types of wired or wireless bus structures including, but not limited to, memory busses or memory controllers, point-to-point connections, switching fabrics, peripheral busses, accelerated graphics ports, and local busses using any of a variety of bus architectures. By way of example, such architectures include, but are not limited to, Industry Standard Architecture (ISA) busses, Micro Channel Architecture (MCA) busses, Enhanced ISA (EISA) busses, Video Electronics Standards Association (VESA) local busses, a Peripheral Component Interconnects (PCI) busses also known as a Mezzanine busses, or any selection of, or combination of, such busses. Depending on the specific physical implementation, one or more of the processors 20, system memory 30 and other components of the computing device 10 can be physically co-located or integrated into a single physical component, such as on a single chip. In such a case, some or all of system bus 11 can be electrical pathways within a single chip structure.

Computing device may further comprise externally-accessible data input and storage devices 12 such as compact disc read-only memory (CD-ROM) drives, digital versatile discs (DVD), or other optical disc storage for reading and/or writing optical discs 62; magnetic cassettes, magnetic tape, magnetic disk storage, or other magnetic storage devices; or any other medium which can be used to store the desired content and which can be accessed by the computing device 10. Computing device may further comprise externally-accessible data ports or connections 13 such as serial ports, parallel ports, universal serial bus (USB) ports, and infrared ports and/or transmitter/receivers. Computing device may further comprise hardware for wireless communication with external devices such as IEEE 1394 (“Firewire”) interfaces, IEEE 802.11 wireless interfaces, BLUETOOTH® wireless interfaces, and so forth. Such ports and interfaces may be used to connect any number of external peripherals and accessories 60 such as visual displays, monitors, and touch-sensitive screens 61, USB solid state memory data storage drives (commonly known as “flash drives” or “thumb drives”) 63, printers 64, pointers and manipulators such as mice 65, keyboards 66, and other devices 67 such as joysticks and gaming pads, touchpads, additional displays and monitors, and external hard drives (whether solid state or disc-based), microphones, speakers, cameras, and optical scanners.

Processors 20 are logic circuitry capable of receiving programming instructions and processing (or executing) those instructions to perform computer operations such as retrieving data, storing data, and performing mathematical calculations. Processors 20 are not limited by the materials from which they are formed or the processing mechanisms employed therein, but are typically comprised of semiconductor materials into which many transistors are formed together into logic gates on a chip (i.e., an integrated circuit or IC). The term processor includes any device capable of receiving and processing instructions including, but not limited to, processors operating on the basis of quantum computing, optical computing, mechanical computing (e.g., using nanotechnology entities to transfer data), and so forth. Depending on configuration, computing device 10 may comprise more than one processor. For example, computing device 10 may comprise one or more central processing units (CPUs) 21, each of which itself has multiple processors or multiple processing cores, each capable of independently or semi-independently processing programming instructions based on technologies like complex instruction set computer (CISC) or reduced instruction set computer (RISC). Further, computing device 10 may comprise one or more specialized processors such as a graphics processing unit (GPU) 22 configured to accelerate processing of computer graphics and images via a large array of specialized processing cores arranged in parallel. Further computing device 10 may be comprised of one or more specialized processes such as Intelligent Processing Units, field-programmable gate arrays or application-specific integrated circuits for specific tasks or types of tasks. The term processor may further include: neural processing units (NPUs) or neural computing units optimized for machine learning and artificial intelligence workloads using specialized architectures and data paths; tensor processing units (TPUs) designed to efficiently perform matrix multiplication and convolution operations used heavily in neural networks and deep learning applications; application-specific integrated circuits (ASICs) implementing custom logic for domain-specific tasks; application-specific instruction set processors (ASIPs) with instruction sets tailored for particular applications; field-programmable gate arrays (FPGAs) providing reconfigurable logic fabric that can be customized for specific processing tasks; processors operating on emerging computing paradigms such as quantum computing, optical computing, mechanical computing (e.g., using nanotechnology entities to transfer data), and so forth. Depending on configuration, computing device 10 may comprise one or more of any of the above types of processors in order to efficiently handle a variety of general purpose and specialized computing tasks. The specific processor configuration may be selected based on performance, power, cost, or other design constraints relevant to the intended application of computing device 10.

System memory 30 is processor-accessible data storage in the form of volatile and/or nonvolatile memory. System memory 30 may be either or both of two types: non-volatile memory and volatile memory. Non-volatile memory 30a is not erased when power to the memory is removed, and includes memory types such as read only memory (ROM), electronically-erasable programmable memory (EEPROM), and rewritable solid state memory (commonly known as “flash memory”). Non-volatile memory 30a is typically used for long-term storage of a basic input/output system (BIOS) 31, containing the basic instructions, typically loaded during computer startup, for transfer of information between components within computing device, or a unified extensible firmware interface (UEFI), which is a modern replacement for BIOS that supports larger hard drives, faster boot times, more security features, and provides native support for graphics and mouse cursors. Non-volatile memory 30a may also be used to store firmware comprising a complete operating system 35 and applications 36 for operating computer-controlled devices. The firmware approach is often used for purpose-specific computer-controlled devices such as appliances and Internet-of-Things (IoT) devices where processing power and data storage space is limited. Volatile memory 30b is erased when power to the memory is removed and is typically used for short-term storage of data for processing. Volatile memory 30b includes memory types such as random-access memory (RAM), and is normally the primary operating memory into which the operating system 35, applications 36, program modules 37, and application data 38 are loaded for execution by processors 20. Volatile memory 30b is generally faster than non-volatile memory 30a due to its electrical characteristics and is directly accessible to processors 20 for processing of instructions and data storage and retrieval. Volatile memory 30b may comprise one or more smaller cache memories which operate at a higher clock speed and are typically placed on the same IC as the processors to improve performance.

There are several types of computer memory, each with its own characteristics and use cases. System memory 30 may be configured in one or more of the several types described herein, including high bandwidth memory (HBM) and advanced packaging technologies like chip-on-wafer-on-substrate (CoWoS). Static random access memory (SRAM) provides fast, low-latency memory used for cache memory in processors, but is more expensive and consumes more power compared to dynamic random access memory (DRAM). SRAM retains data as long as power is supplied. DRAM is the main memory in most computer systems and is slower than SRAM but cheaper and more dense. DRAM requires periodic refresh to retain data. NAND flash is a type of non-volatile memory used for storage in solid state drives (SSDs) and mobile devices and provides high density and lower cost per bit compared to DRAM with the trade-off of slower write speeds and limited write endurance. HBM is an emerging memory technology that provides high bandwidth and low power consumption which stacks multiple DRAM dies vertically, connected by through-silicon vias (TSVs). HBM offers much higher bandwidth (up to 1 TB/s) compared to traditional DRAM and may be used in high-performance graphics cards, AI accelerators, and edge computing devices. Advanced packaging and CoWoS are technologies that enable the integration of multiple chips or dies into a single package. CoWoS is a 2.5D packaging technology that interconnects multiple dies side-by-side on a silicon interposer and allows for higher bandwidth, lower latency, and reduced power consumption compared to traditional PCB-based packaging. This technology enables the integration of heterogeneous dies (e.g., CPU, GPU, HBM) in a single package and may be used in high-performance computing, AI accelerators, and edge computing devices.

Interfaces 40 may include, but are not limited to, storage media interfaces 41, network interfaces 42, display interfaces 43, and input/output interfaces 44. Storage media interface 41 provides the necessary hardware interface for loading data from non-volatile data storage devices 50 into system memory 30 and storage data from system memory 30 to non-volatile data storage device 50. Network interface 42 provides the necessary hardware interface for computing device 10 to communicate with remote computing devices 80 and cloud-based services 90 via one or more external communication devices 70. Display interface 43 allows for connection of displays 61, monitors, touchscreens, and other visual input/output devices. Display interface 43 may include a graphics card for processing graphics-intensive calculations and for handling demanding display requirements. Typically, a graphics card includes a graphics processing unit (GPU) and video RAM (VRAM) to accelerate display of graphics. In some high-performance computing systems, multiple GPUs may be connected using NVLink bridges, which provide high-bandwidth, low-latency interconnects between GPUs. NVLink bridges enable faster data transfer between GPUs, allowing for more efficient parallel processing and improved performance in applications such as machine learning, scientific simulations, and graphics rendering. One or more input/output (I/O) interfaces 44 provide the necessary support for communications between computing device 10 and any external peripherals and accessories 60. For wireless communications, the necessary radio-frequency hardware and firmware may be connected to I/O interface 44 or may be integrated into I/O interface 44.

Non-volatile data storage devices 50 are typically used for long-term storage of data. Data on non-volatile data storage devices 50 is not erased when power to the non-volatile data storage devices 50 is removed. Non-volatile data storage devices 50 may be implemented using any technology for non-volatile storage of content including, but not limited to, CD-ROM drives, digital versatile discs (DVD), or other optical disc storage; magnetic cassettes, magnetic tape, magnetic disc storage, or other magnetic storage devices; solid state memory technologies such as EEPROM or flash memory; or other memory technology or any other medium which can be used to store data without requiring power to retain the data after it is written. Non-volatile data storage devices 50 may be non-removable from computing device 10 as in the case of internal hard drives, removable from computing device 10 as in the case of external USB hard drives, or a combination thereof, but computing device will typically comprise one or more internal, non-removable hard drives using either magnetic disc or solid state memory technology. Non-volatile data storage devices 50 may store any type of data including, but not limited to, an operating system 51 for providing low-level and mid-level functionality of computing device 10, applications 52 for providing high-level functionality of computing device 10, program modules 53 such as containerized programs or applications, or other modular content or modular programming, application data 54, and databases 55 such as relational databases, non-relational databases, object oriented databases, NoSQL databases, vector databases, key-value databases, document oriented data stores, and graph databases.

Applications (also known as computer software or software applications) are sets of programming instructions designed to perform specific tasks or provide specific functionality on a computer or other computing devices. Applications are typically written in high-level programming languages such as C, C++, Scala, Erlang, GoLang, Java, Scala, Rust, and Python, which are then either interpreted at runtime or compiled into low-level, binary, processor-executable instructions operable on processors 20. Applications may be containerized so that they can be run on any computer hardware running any known operating system. Containerization of computer software is a method of packaging and deploying applications along with their operating system dependencies into self-contained, isolated units known as containers. Containers provide a lightweight and consistent runtime environment that allows applications to run reliably across different computing environments, such as development, testing, and production systems facilitated by specifications such as containerd.

The memories and non-volatile data storage devices described herein do not include communication media. Communication media are means of transmission of information such as modulated electromagnetic waves or modulated data signals configured to transmit, not store, information. By way of example, and not limitation, communication media includes wired communications such as sound signals transmitted to a speaker via a speaker wire, and wireless communications such as acoustic waves, radio frequency (RF) transmissions, infrared emissions, and other wireless media.

External communication devices 70 are devices that facilitate communications between computing device and either remote computing devices 80, or cloud-based services 90, or both. External communication devices 70 include, but are not limited to, data modems 71 which facilitate data transmission between computing device and the Internet 75 via a common carrier such as a telephone company or internet service provider (ISP), routers 72 which facilitate data transmission between computing device and other devices, and switches 73 which provide direct data communications between devices on a network or optical transmitters (e.g., lasers). Here, modem 71 is shown connecting computing device 10 to both remote computing devices 80 and cloud-based services 90 via the Internet 75. While modem 71, router 72, and switch 73 are shown here as being connected to network interface 42, many different network configurations using external communication devices 70 are possible. Using external communication devices 70, networks may be configured as local area networks (LANs) for a single location, building, or campus, wide area networks (WANs) comprising data networks that extend over a larger geographical area, and virtual private networks (VPNs) which can be of any size but connect computers via encrypted communications over public networks such as the Internet 75. As just one exemplary network configuration, network interface 42 may be connected to switch 73 which is connected to router 72 which is connected to modem 71 which provides access for computing device 10 to the Internet 75. Further, any combination of wired 77 or wireless 76 communications between and among computing device 10, external communication devices 70, remote computing devices 80, and cloud-based services 90 may be used. Remote computing devices 80, for example, may communicate with computing device through a variety of communication channels 74 such as through switch 73 via a wired 77 connection, through router 72 via a wireless connection 76, or through modem 71 via the Internet 75. Furthermore, while not shown here, other hardware that is specifically designed for servers or networking functions may be employed. For example, secure socket layer (SSL) acceleration cards can be used to offload SSL encryption computations, and transmission control protocol/internet protocol (TCP/IP) offload hardware and/or packet classifiers on network interfaces 42 may be installed and used at server devices or intermediate networking equipment (e.g., for deep packet inspection).

In a networked environment, certain components of computing device 10 may be fully or partially implemented on remote computing devices 80 or cloud-based services 90. Data stored in non-volatile data storage device 50 may be received from, shared with, duplicated on, or offloaded to a non-volatile data storage device on one or more remote computing devices 80 or in a cloud computing service 92. Processing by processors 20 may be received from, shared with, duplicated on, or offloaded to processors of one or more remote computing devices 80 or in a distributed computing service 93. By way of example, data may reside on a cloud computing service 92, but may be usable or otherwise accessible for use by computing device 10. Also, certain processing subtasks may be sent to a microservice 91 for processing with the result being transmitted to computing device 10 for incorporation into a larger processing task. Also, while components and processes of the exemplary computing environment are illustrated herein as discrete units (e.g., OS 51 being stored on non-volatile data storage device 51 and loaded into system memory 35 for use) such processes and components may reside or be processed at various times in different components of computing device 10, remote computing devices 80, and/or cloud-based services 90.

In an implementation, the disclosed systems and methods may utilize, at least in part, containerization techniques to execute one or more processes and/or steps disclosed herein. Containerization is a lightweight and efficient virtualization technique that allows you to package and run applications and their dependencies in isolated environments called containers. One of the most popular containerization platforms is containerd, which is widely used in software development and deployment. Containerization, particularly with open-source technologies like Docker and container orchestration systems like Kubernetes, is a common approach for deploying and managing applications. Containers are created from images, which are lightweight, standalone, and executable packages that include application code, libraries, dependencies, and runtime. Images are often built from a Dockerfile or similar, which contains instructions for assembling the image. Dockerfiles are configuration files that specify how to build a Docker image. Systems like Kubernetes also support containerd or CRI-O. They include commands for installing dependencies, copying files, setting environment variables, and defining runtime configurations. Docker images are stored in repositories, which can be public or private. Docker Hub is an exemplary public registry, and organizations often set up private registries for security and version control using tools such as Hub, JFrog Artifactory and Bintray, Gitlab, Github Packages or Container registries. Containers can communicate with each other and the external world through networking. Docker provides a bridge network by default, but can be used with custom networks. Containers within the same network can communicate using container names or IP addresses.

Remote computing devices 80 are any computing devices not part of computing device 10. Remote computing devices 80 include, but are not limited to, personal computers, server computers, thin clients, thick clients, personal digital assistants (PDAs), mobile telephones, watches, tablet computers, laptop computers, multiprocessor systems, microprocessor based systems, set-top boxes, programmable consumer electronics, video game machines, game consoles, portable or handheld gaming units, network terminals, desktop personal computers (PCs), minicomputers, mainframe computers, network nodes, virtual reality or augmented reality devices and wearables, and distributed or multi-processing computing environments. While remote computing devices 80 are shown for clarity as being separate from cloud-based services 90, cloud-based services 90 are implemented on collections of networked remote computing devices 80.

Cloud-based services 90 are Internet-accessible services implemented on collections of networked remote computing devices 80. Cloud-based services are typically accessed via application programming interfaces (APIs) which are software interfaces which provide access to computing services within the cloud-based service via API calls, which are pre-defined protocols for requesting a computing service and receiving the results of that computing service. While cloud-based services may comprise any type of computer processing or storage, three common categories of cloud-based services 90 are serverless logic apps, microservices 91, cloud computing services 92, and distributed computing services 93.

Microservices 91 are collections of small, loosely coupled, and independently deployable computing services. Each microservice represents a specific computing functionality and runs as a separate process or container. Microservices promote the decomposition of complex applications into smaller, manageable services that can be developed, deployed, and scaled independently. These services communicate with each other through well-defined application programming interfaces (APIs), typically using lightweight protocols like HTTP, protobuffers, gRPC or message queues such as Kafka. Microservices 91 can be combined to perform more complex or distributed processing tasks. In an embodiment, Kubernetes clusters with containerd resources is used for operational packaging of system.

Cloud computing services 92 are delivery of computing resources and services over the Internet 75 from a remote location. Cloud computing services 92 provide additional computer hardware and storage on as-needed or subscription basis. Cloud computing services 92 can provide large amounts of scalable data storage, access to sophisticated software and powerful server-based processing, or entire computing infrastructures and platforms. For example, cloud computing services can provide virtualized computing resources such as virtual machines, storage, and networks, platforms for developing, running, and managing applications without the complexity of infrastructure management, and complete software applications over public or private networks or the Internet on a subscription or alternative licensing basis, or consumption or ad-hoc marketplace basis, or combination thereof.

Distributed computing services 93 provide large-scale processing using multiple interconnected computers or nodes to solve computational problems or perform tasks collectively. In distributed computing, the processing and storage capabilities of multiple machines are leveraged to work together as a unified system. Distributed computing services are designed to address problems that cannot be efficiently solved by a single computer or that require large-scale computational power or support for highly dynamic compute, transport or storage resource variance over time requiring scaling up and down of constituent system resources. These services enable parallel processing, fault tolerance, and scalability by distributing tasks across multiple nodes.

Although described above as a physical device, computing device 10 can be a virtual computing device, in which case the functionality of the physical components herein described, such as processors 20, system memory 30, network interfaces 40, NVLink or other GPU-to-GPU high bandwidth communications links and other like components can be provided by computer-executable instructions. Such computer-executable instructions can execute on a single physical computing device, or can be distributed across multiple physical computing devices, including being distributed across multiple physical computing devices in a dynamic manner such that the specific, physical computing devices hosting such computer-executable instructions can dynamically change over time depending upon need and availability. In the situation where computing device 10 is a virtualized device, the underlying physical computing devices hosting such a virtualized computing device can, themselves, comprise physical components analogous to those described above, and operating in a like manner. Furthermore, virtual computing devices can be utilized in multiple layers with one virtual computing device executing within the construct of another virtual computing device. Thus, computing device 10 may be either a physical computing device or a virtualized computing device within which computer-executable instructions can be executed in a manner consistent with their execution by a physical computing device. Similarly, terms referring to physical components of the computing device, as utilized herein, mean either those physical components or virtualizations thereof performing the same or equivalent functions.

The skilled person will be aware of a range of possible modifications of the various aspects described above. Accordingly, the present invention is defined by the claims and their equivalents.

What is claimed is:

1. A system for geometric cognitive processing, the system comprising:
a cognitive manifold representing a space of cognitive states;
an attractor identification component configured to determine a plurality of attractors within the cognitive manifold, wherein each attractor comprises a subset of the cognitive manifold toward which cognitive states evolve;
a proximity scoring component configured to compute, for a cognitive state in the cognitive manifold, a proximity score for each of the plurality of attractors, wherein each proximity score quantifies a relationship between the cognitive state and a corresponding attractor;
a flow prediction component configured to generate a predicted cognitive flow based on the cognitive state and the proximity scores, wherein the predicted cognitive flow is computed as a weighted combination of attractor-influenced flow components, and wherein each attractor-influenced flow component is weighted by its corresponding proximity score; and
a geometry evolution component configured to modify at least one of: a metric structure of the cognitive manifold, parameters of one or more attractors, or basin boundaries of the attractors, based on observed cognitive trajectories.

2. The system of claim 1, wherein the attractor identification component is configured to determine attractors using at least one of:
fixed-point detection identifying states where a state evolution operator leaves the state unchanged;
limit cycle detection identifying periodic orbits with finite period;
potential minimum detection identifying local minima of a potential function;
recurrent set analysis identifying regions with high trajectory return frequency; or
spectral analysis identifying dominant eigenmodes of a dynamical operator.

3. The system of claim 1, wherein the proximity scoring component computes proximity scores using at least one of:
a distance-based metric that decreases with increasing distance between the cognitive state and the attractor;
a potential-based metric based on exponential decay of an attractor-specific potential function;
a dynamical convergence rate measuring instantaneous approach velocity toward the attractor; or
a probabilistic metric representing likelihood of eventual convergence to the attractor.

4. The system of claim 1, wherein the flow prediction component generates the predicted cognitive flow using at least one of:
a linear predictor that adds a scaled flow vector to the current state;
a geodesic extrapolator that follows curved paths on the manifold; or
a stochastic transition kernel defining transition probabilities between states.

5. The system of claim 1, wherein the geometry evolution component modifies the metric structure based on at least one of:
trajectory density through regions of the manifold;
attractor occupancy statistics;
accumulated prediction errors; or
curvature flow adjustments.

6. The system of claim 1, further comprising:
a multi-manifold coordinator configured to manage a plurality of cognitive manifolds; and
projection operators configured to transfer information between manifolds, wherein attractor proximity scores in one manifold influence flow predictions in another manifold through the projection operators.

7. The system of claim 1, further comprising a planning component configured to:
construct an attractor graph where nodes represent attractors and edges represent feasible transitions between attractor basins; and
determine cognitive trajectories as paths through the attractor graph based on optimization criteria.

8. The system of claim 1, wherein the flow prediction component incorporates a residual flow term representing influences not captured by the identified attractors, wherein the predicted flow combines weighted attractor-aligned flow components with the residual flow term.

9. The system of claim 1, wherein the attractors comprise at least two of:
point attractors representing fixed cognitive states;
limit cycle attractors exhibiting periodic dynamics;
strange attractors possessing fractal structure and sensitive dependence on initial conditions;
manifold attractors having extended dimensionality;
metastable attractors characterized by temporary stability; or
hierarchical attractors containing nested sub-attractor structures.

10. A method for geometric cognitive processing, the method comprising the steps of:
mapping a cognitive state to a point within a cognitive manifold representing a space of cognitive states;
identifying a plurality of attractors within the cognitive manifold, wherein each attractor comprises a subset of the cognitive manifold toward which cognitive states evolve;
computing, for the cognitive state, a proximity score for each of the plurality of attractors, wherein each proximity score quantifies a relationship between the cognitive state and a corresponding attractor;
generating a predicted cognitive flow based on the cognitive state and the proximity scores, wherein the predicted cognitive flow is computed as a weighted combination of attractor-influenced flow components, and wherein each attractor-influenced flow component is weighted by its corresponding proximity score; and
modifying at least one of: a metric structure of the cognitive manifold, parameters of one or more attractors, or basin boundaries of the attractors, based on observed cognitive trajectories.

11. The method of claim 10, wherein identifying the plurality of attractors comprises at least one of:
detecting fixed points where a state evolution operator leaves states unchanged;
detecting limit cycles exhibiting periodic orbits with finite period;
detecting local minima of a potential function;
identifying recurrent sets with high trajectory return frequency; or
identifying dominant eigenmodes of a dynamical operator.

12. The method of claim 10, wherein computing the proximity scores comprises at least one of:
applying a distance-based metric that decreases with increasing distance between the cognitive state and the attractor;
applying a potential-based metric based on exponential decay of an attractor-specific potential function;
computing a dynamical convergence rate measuring instantaneous approach velocity toward the attractor; or
computing a probabilistic metric representing likelihood of eventual convergence to the attractor.

13. The method of claim 10, wherein generating the predicted cognitive flow comprises at least one of:
applying a linear predictor that adds a scaled flow vector to the current state;
applying a geodesic extrapolator that follows curved paths on the manifold; or
applying a stochastic transition kernel defining transition probabilities between states.

14. The method of claim 10, wherein modifying the metric structure comprises adjusting the metric based on at least one of:
trajectory density through regions of the manifold;
attractor occupancy statistics;
accumulated prediction errors; or
curvature flow adjustments.

15. The method of claim 10, further comprising the steps of:
managing a plurality of cognitive manifolds; and
transferring information between manifolds using projection operators, wherein attractor proximity scores computed in one manifold influence flow predictions generated in another manifold through the projection operators.

16. The method of claim 10, further comprising the steps of:
constructing an attractor graph where nodes represent attractors and edges represent feasible transitions between attractor basins; and
determining cognitive trajectories as paths through the attractor graph based on optimization criteria.

17. The method of claim 10, wherein generating the predicted cognitive flow comprises:
combining weighted attractor-aligned flow components with a residual flow term representing influences not captured by the identified attractors.

18. The method of claim 10, wherein the identified attractors comprise at least two of:
point attractors representing fixed cognitive states;
limit cycle attractors exhibiting periodic dynamics;
strange attractors possessing fractal structure and sensitive dependence on initial conditions;
manifold attractors having extended dimensionality;
metastable attractors characterized by temporary stability; or
hierarchical attractors containing nested sub-attractor structures.
